(19) United States
(12) Patent Application Publication
(10) Pub. No.: US 2012/0185373 A1
(43) Pub. Date: Jul. 19, 2012

(54) REGISTRY OF U3 IDENTIFIERS

(75) Inventor: Allan D. Grody, New York, NY (US)

(73) Assignee: Financial Intergroup Holdings Ltd., New York, NY (US)

(21) Appl. No.: 13/359,367

(22) Filed: Jan. 26, 2012

Related U.S. Application Data
(63) Continuation-in-part of application No. 13/241,475, filed on Sep. 23, 2011.
Application No. 13/241,475 is a continuation of application No. 12/927,597, filed on Nov. 18, 2010, now Pat. No. 8,055,575.
Application No. 12/927,597 is a continuation-in-part of application No. 11/544,570, filed on Oct. 10, 2006, now abandoned.
(60) Provisional application No. 60/726,984, filed on Oct. 14, 2005.
(60) Provisional application No. 61/566,872, filed on Dec. 5, 2011.

(51) Int. Cl. G06Q 40/04

(52) U.S. Cl. 705/37

(57) ABSTRACT

An identifier for an entity is generated by receiving, at a participant computer, a prefix from a regulatory entity; receiving, at the participant computer, a suffix from a market participant; and appending, by the participant computer, the prefix to the suffix to generate the identifier. The identifier may be sent from the participant computer to a name server computer that is part of a publicly accessible network of computers

### CROSS-REFERENCE TO RELATED APPLICATIONS

This application is a continuation-in-part of U.S. patent application Ser. No. 13/241,475, filed Sep. 23, 2011, which is a continuation of U.S. patent application Ser. No. 12/927,597, filed Nov. 18, 2010, which is a continuation-in-part of U.S. patent application Ser. No. 11/544,570, filed Oct. 10, 2006, having common inventors herewith, which in turn claims priority from U.S. provisional patent application Ser. No. 60/726,984, filed Oct. 14, 2005. This application also claims priority from U.S. provisional patent application Ser. No. 61/566,872, filed Dec. 5, 2011. Each of the 12/927,597; 11/544,570; 60/726,984 and 61/566,872 applications is hereby incorporated by reference in its entirety.

### BACKGROUND OF THE INVENTION

The US's Dodd-Frank legislation enables a new entity, a branch of the Treasury, the Office of Financial Research (OFR) to carry out research on systemic risk. In its first initiative the OFR has called for an industry-government partnership to create a global Legal Entity Identification (LEI) system for identifying those entities engaged in the financial industry's supply chain along with their associated hierarchies of entity ownership. In similar fashion, the Securities and Exchange Commission (SEC) and the Commodities Futures Trading Commission (CFTC) are requesting the LEI also accommodate these agencies unique counterparty (traded partners) identity needs as well as to utilize the same system to identify OTC derivative products and other financial instrument and contracts (see FIG. 26 for the multiple codes used for a single companies securities).

They noted that maintaining internal identifier databases and reconciling entity identification with counterparties is expensive for large firms and disproportionately so for small firms. The absence of unique, unambiguous and universal (U3) legal entities has led to individual firm's need for a layer of mapping software and middle-ware to compensate for this fundamental missing piece of the infrastructure of the industry found (see FIG. 27 for the current infrastructure). The consequences are enormous—huge additional cost and a process one can only describe as mapping hell. Estimates are that upwards of a billion dollars is spent by each of the large financial institutions annually on duplicating data management functions.

All who looked into the basement of Lehman, all the regulators, the forensic accountants, the bankruptcy lawyers, the creditors and the counterparties observed a huge swamp of risk created from the lack of common identification standards and no way of measuring what they (see FIG. 28 for an illustration of the issues found at Lehman Brothers in the identification of businesses and products)

Faulty data creates huge operational risk as transactions cannot be processed in any reasonably complete automated manner. This failure is compensated for by requiring human interaction and reconciliation procedures across all the business silos that comprise a global financial institution and in all the data providers input processing centers with thousands of analysts interpreting unstructured documents into data. The faulty interaction of human and automated process with data causes risk.

It became obvious to regulators that by creating a common identification standard, streamlining processes and automating their interactions, operational risk can be minimized and data aggregation for both single enterprise and multiple cross enterprise risk analysis can be accommodated. A global “golden copy” of both the identifiers and associated reference data distributed to all financial market participants would eliminate duplicate data acquisition costs and data storage needs and eliminate faulty reference data.

The OFR's solicitation of interest issued in late 2010 anticipated rule making by Jul. 15, 2011. During this period the OFR, SEC and CFTC reached out to global leaders, practitioners and standards setters to provide the guidance and deliver on the consensus they sought from the industry. Furthermore, while their perch as rule makers is US-centric, they have decidedly taken a global perspective through embracing the implementation as one to be carried out in the context of the global financial industry and amongst all sovereign financial regulators.

In observing the problem as a global one, the US regulators reached beyond their own domestic jurisdiction in seeking a global standard. They recognized that while regulators have operated in their own local markets or sovereign jurisdictions, financial institutions operate across all these government's boundaries. Capital and contract markets operate globally and know no prescribed sovereign boundaries.

The regulators recognized that the issue is both an industry and a regulatory issue. They saw that a common set of reference identifiers for participants and products could yield significant efficiencies in both the public and private sectors as financial firms could eliminate the use of multiple proprietary reference systems and move to a single, widely accepted system.

They understood that the complete automation of back-office activities, that elusive mantra the industry calls Straight-Through-Processing (STP), remains elusive, in part because of the lack of universal identifiers. They understand that real-time trading-through-to-payment, which is desired to eliminate systemic settlement risk, and aggregating valued position and cash flow data which is necessary for systemic risk analysis can only be accomplished when a unique, unambiguous and universal identification system is available for identifying financial participants and their traded products.

There is no global identification system for legal entity identifiers (LEIs), nor is there for financial products or changes affecting both (financial events). The US Treasury's OFR had requested and received a total of 33 separate responses.

Recurring themes include the need for a data utility to be operated on a not for profit, cost recovery basis in order to ensure the industry is not burdened with high costs. Many also suggest the global legal entity identifier contain only basic reference data items such as name and address data, but little in the way of hierarchical or relational data. This is to ensure that the new Treasury agency is not overwhelmed at the start of the initiative and that the identifiers can be used for multiple purposes. Many of the US centric suggestions will likely be improved upon by international regulators. Finally, the benefits of a federated versus a centralized approach to the maintenance of this data are bound to cause debate for some time to come.

Thus, there is a need for improved identification techniques for entities and transactions.

### SUMMARY OF THE INVENTION

In accordance with an aspect of this invention, there is provided a method of generating an identifier for an entity, comprising receiving, at a participant computer, a prefix from a regulatory entity; receiving, at the participant computer, a suffix from a market participant; and appending, by the participant computer, the prefix to the suffix to generate the identifier.

In some instances, the identifier is sent from the participant computer to a name server computer that is part of a publicly accessible network of computers

It is not intended that the invention be summarized here in its entirety. Rather, further features, aspects and advantages of the invention are set forth in or are apparent from the following description and drawings.

### BRIEF DESCRIPTION OF THE DRAWINGS

FIG. 1 is a block diagram showing a prior art hardware and communication configuration;

FIG. 2 is a flowchart showing prior art pre-trading activity;

FIG. 3 is a flowchart showing prior art trade day activity with proprietary trading;

FIG. 4 is a flowchart showing prior art settlement day activity;

FIG. 5 is a flowchart showing a prior art clearing error;

FIG. 6 is a flowchart showing a prior art settlement error;

FIGS. 7A and 7B are a flowchart showing prior art trade day activity with customer trading;

FIG. 8 is a flowchart showing prior art settlement day activity when a trading firm does not hold the securities that it sold;

FIG. 9 is a flowchart showing another prior art clearing error;

FIG. 10 is a flowchart showing a problem with prior art intra-firm data aggregation;

FIG. 11 is a block diagram showing another prior art hardware and communication configuration;

FIG. 12 is a flowchart showing a problem with prior art inter-firm data aggregation;

FIG. 13 is a diagram referred to in explaining financial transaction data;

FIG. 14 is a block diagram showing the logical functions of a Central Counterparty for Data Management (CCDM);

FIG. 15 is a block diagram showing a hardware and communication configuration for a first embodiment of a CCDM;

FIG. 16 is a flowchart showing data processing in a first embodiment of CCDM;

FIG. 17 is a flowchart showing query processing in a CCDM;

FIGS. 18A-18D are diagrams showing data organization in a CCDM;

FIG. 19 is a block diagram showing a hardware and communication configuration for a second embodiment of a CCDM;

FIG. 20 is a flowchart showing data processing in the embodiment of FIG. 19;

FIG. 21 is a flowchart showing pre-trading activity with a CCDM;

FIG. 22 is a flowchart showing intra-firm data aggregation;

FIG. 23 is a block diagram showing another logical configuration with a CCDM;

FIG. 24 is diagram of a screen display for claiming error reimbursement;

FIG. 25 is a graph referred to in explaining a risk management technique;

FIG. 26 is a chart showing multiple related identifiers;

FIG. 27 is a diagram showing multiple sources of non-unique reference data;

FIG. 28 is a chart showing associated entities;

FIG. 29 is a diagram showing an embodiment of the U3 identification system;

FIG. 30 is a diagram showing assignment of the identification code in its two part assignment and registration;

FIG. 31 is a diagram showing the U3 method extended for use with identification of products, events and transactions;

FIG. 32 is a diagram showing an overview of financial intermediaries and financial market participants operating through the U3 Id System to interact with the LEI Registry and the Central Counterparty for Data Management;

FIG. 33 is a chart showing examples of methods of certification;

FIG. 34 is a chart for a use case in which a company wants to create new LEIs/UCIs (UCI—CFTC's Unique Counterparty Identifier) for two operating divisions;

FIG. 35 is a chart for a use case in which a company wants to register an LEI's/UCI's core regulatory data attributes;

FIG. 36 is a chart for a use case in which a company wants to register an LEI's/UCI's extended attributes;

FIG. 37 is a chart for a use case in which a company wants to obtain reference data regarding an LEI observed in a financial document;

FIG. 38 is a chart for a use case in which a data provider assists in enhancing a financial institution's legacy data with LEIs, in the context of a regulatory request for information;

FIG. 39 is a chart for a use case in which an exchange wants to create new FIIs (Financial Instrument Identifiers)/UPIs (CFTC's Unique Product Identifier) for two new derivative products;

FIG. 40 is a chart for a use case in which an exchange wants to register an FII/UPI for use in financial markets;

FIG. 41 is a chart for a use case in which a company announces the spinoff of new securities using the Financial Event Identifier (FEI);

FIG. 42 is a chart for a use case in which the UPI is contained in the OTC derivatives product registry; and

FIG. 43 is a chart for a use case in which the LEI is incorporated into the LEI utility.

### DETAILED DESCRIPTION

The present invention is a central counterparty for data management (CCDM) that receives data relating to financial transactions, associates the data with metadata to generate reference data, and provides the reference data in “push” and “pull” ways. The “push” techniques for providing the data include distributing on a data feed, sending the data to parties known to be relevant to the transaction, and sending the data to parties who have a standing query that is satisfied by the data. The “pull” techniques for providing the data include responding to queries received from a variety of parties.

The metadata may be received from the source of the data or added by the CCDM. The metadata may be stored explicitly, such as by an identification field, or implicitly, such as in a particular pre-defined field of a database.

Another important function of the CCDM is to generate unique, unambiguous and universal identifiers, each referred to as a “U3id”, to associate the U3id identifiers with reference data, and to distribute the U3id identifiers to public, commercial and government entities.

Before describing the CCDM, some instances of prior art data errors will now be discussed.

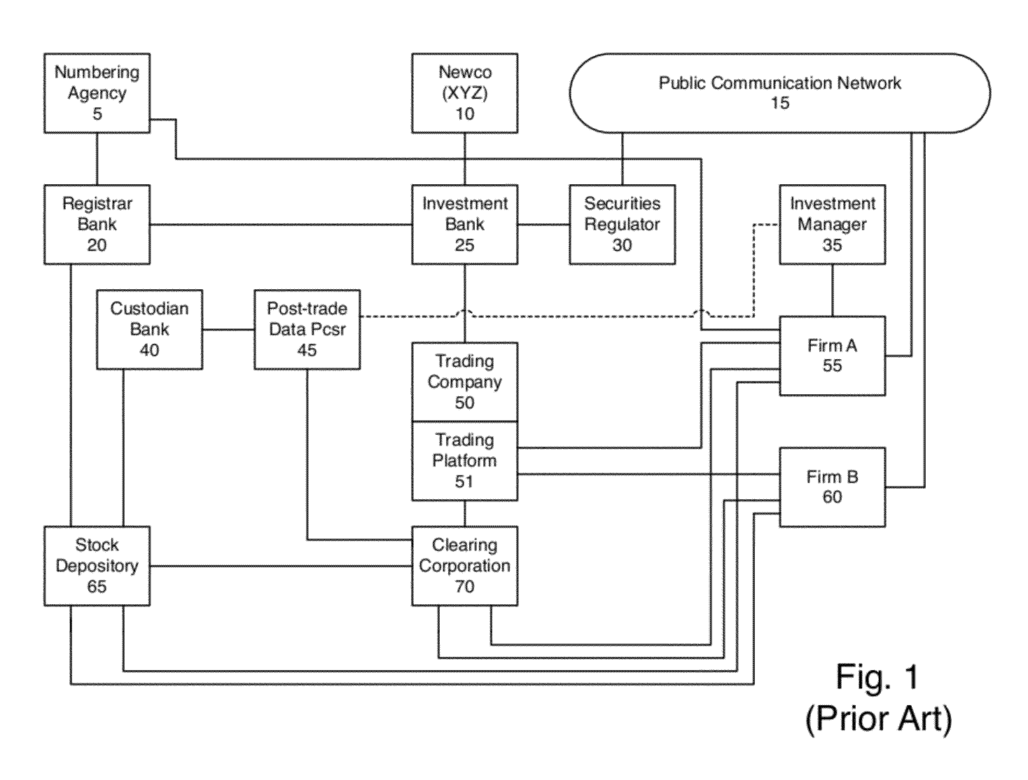

FIG. 1 is a block diagram showing a prior art hardware and communication configuration. The elements of FIG. 1 are each general purpose computers having sufficient memory, storage and communications capability to function as described, and may have a human interface such as a client terminal that may include a processor. The communications capability may be a direct communication line, or a virtual private network using a public data network, or data packets sent securely over a public data network. The communication lines may be wire line or wireless, or a combination thereof, such as a wireless connection at one end coupled to a wire line transmission facility that terminates in a wire line or wireless local connection.

FIG. 1 includes numbering agency 5, Newco 10, public data communication network 15, registrar bank 20, investment bank 25, securities regulator 30, investment manager 35, custodian bank 40, financial industry post-trade data processor 45, trading company 50, trading platform 51, trading firm 55 (also referred to as Firm A), trading firm 60 (also referred to as Firm B), stock depository 65 and clearing corporation 70.

Numbering agency 5 provides an identifying number for a security. Standard & Poor's is an instance of numbering agency 5. A CUSIP is an instance of an identifying number.

The acronym CUSIP historically refers to the Committee on Uniform Security Identification Procedures and is a 9-character alphanumeric code that identifies any North American security for the purposes of facilitating clearing and settlement of trades. The CUSIP distribution system is owned by the American Bankers Association, under its status as a National Numbering Agency, such status given by the International Standards Organization (ISO), and is operated by Standard & Poor's. The CUSIP Service Bureau acts as the National Numbering Association (NNA) for North America, and the CUSIP serves as the National Securities Identification Number for products issued from both the United States and Canada. The first six characters are known as the base (or CUSIP-6), and uniquely identify the issuer. Issuer codes are assigned alphabetically from a series that includes deliberate built-in “gaps” for future expansion. The 7th and 8th digit identify the exact issue. The 9th digit is an automatically generated checksum (some clearing bodies ignore or truncate the last digit). To calculate the check digit every second digit is multiplied by two. Letters are converted to numbers based on their ordinal position in the alphabet. The last three characters of the issuer code can be letters, in order to provide more room for expansion.

Newco 10 is an instance of a company that issues securities for public trading.

Public data communication network 15 is a packet switched communication network incorporating routers, trunk lines, access lines and so on. The Internet is an instance of network 15.

Registrar bank 20 provides share registry services for issuers of publicly traded securities such as Newco 10. Generally, share registry services include keeping track of how many shares the company has issued, who owns the shares, ensuring that the total shares at stock depository 65 equal the total shares issued by Newco 10, and serving as the transfer agent for owners of Newco shares—keeping books and records on their behalf.

Investment bank 25 represents a company that issues securities, and takes care of the administrative details of issuing the securities and also sells (places) the securities on behalf of the company. Typically, investment bank 25 creates a draft Offering Memorandum in compliance with securities offering laws, called a “red herring”, and distributes the red herring to prospective share purchasers, possibly via other investment banks, and often in conjunction with an in-person presentation of the company to prospective purchasers, called a “road show”. Based on response to the red herring, investment bank 25 determines the price for the securities, and then files the actual Offering Memorandum with the initial price to enable the start of public trading.

Securities regulator 30 is a government entity tasked with monitoring and regulating the financial industry.

Investment manager 35 is an individual or firm that manages an investment fund on behalf of the fund owner such as an individual or a group of individuals, a mutual fund, a pension fund, deciding when to buy and sell securities, and often deciding which securities to buy and sell, which trading platform to use, and which trading firm to use.

Custodian bank 40 provides services such as to:
hold in safekeeping assets/securities such as stocks, bonds, commodities such as precious metals and currency (cash), domestic and foreign
arrange settlement of any purchases and sales and deliveries in/out of such securities and currency
collect information on and income from such assets (dividends in the case of stocks/equities and coupons (interest payments) in the case of bonds) and administer related tax withholding documents and foreign tax reclamation
administer voluntary and involuntary corporate actions on securities held such as stock dividends, splits, business combinations (mergers), tender offers, bond calls, etc.
provide information on the securities and their issuers such as annual general meetings and related proxies
maintain currency/cash bank accounts, effect deposits and withdrawals and manage other cash transactions
perform foreign exchange transactions
often perform additional services for particular clients such as mutual funds; examples include fund accounting, administration, legal, compliance and tax support services
provide regular and special reporting on any or all their activities to their clients or authorized third parties such as MAIC Trust Account services for mergers & acquisitions payments.

Financial industry post-trade data processor 45 provides, to investment manager 35, custodian bank 40, trading firms 55 and 60, and stock depository 65, automated trade life cycle events, including notice of execution, allocation, confirmation/affirmation, settlement notification, enrichment of trades with standing settlement instructions, operational analytics and counterparty risk management between trade counterparties. Omgeo is an instance of financial industry post-trade data processor 45.

Trading company 50 is a marketplace for securities trading, such as NYSE Euronext. The actual trading occurs on trading platform 51 operated by trading company 50. NYSE Equities, NYSE Arca Equities, Euronext Equities and ArcaEdge are instances of trading platform 51.

Trading firms 55 and 60 are members of trading company 50, and provide order entry, execution, and post-trade services to their customers, and may also have proprietary accounts that they trade on their own behalf.

Stock depository 65 provides clearing and settlement efficiencies by immobilizing securities and making “book-entry” changes to ownership of the securities. Stock depository 65 serves as the transfer agent for the financial industry, keeping books on behalf of trading firms. Depository Trust Corporation (DTC) is an instance of stock depository 65.

Clearing corporation 70 provides clearing, settlement, risk management, central counterparty services and a guarantee of completion for certain transactions for virtually all broker-to-broker trades involving equities, nets trades and payments among its participants, reducing the value of securities and payments that need to be exchanged each day. Clearing corporation 70 generally clears and settles trades on a T+3 basis. National Securities Clearing Corporation (NSCC) is an instance of clearing corporation 70. DTC provides securities movements for NSCC's net settlements. DTC and NSCC are owned by DTCC.

On trade date (T), the clearance and settlement cycle begins. Trade details are electronically transmitted to clearing corporation 70 for processing. For equity transactions, while 99.9% are sent as “locked-in” trades, which means that the marketplace has already compared them at the time of execution, confirming all details, includes share security, quantity and price, the potential for errors introduced after this “lock-in” is still significant. Additional processes described as clearance and settlement must follow to actually distribute securities to new owners from previous ones, and make payment between these same parties and/or their agents. Clearing corporation 70 sends to participants automated reports showing trade details for transactions that have entered clearance and settlement processing.

Clearing corporation 70 guarantees settlement for cleared trades. The guarantee generally begins at midnight between T+1 and T+2. At this point, clearing corporation 70 steps into the middle of a trade via a legal process called novation, and assumes the role of central counterparty, taking on the buyer's credit risk and the seller's delivery risk. This guarantee eliminates uncertainty for market participants and inspires public confidence.

Two days after trade date (T+2), clearing corporation 70 issues summaries of all compared trades, including information on the net positions of each security due or owed for settlement.

Three days after trade date (T+3) is settlement day, when securities are delivered to buyers and money is paid to sellers. Trading firms instruct their settling banks to send or receive funds through the Federal Reserve System to/from depository corporation 65 as the agent for clearing corporation 70. Securities generally do not change hands physically.

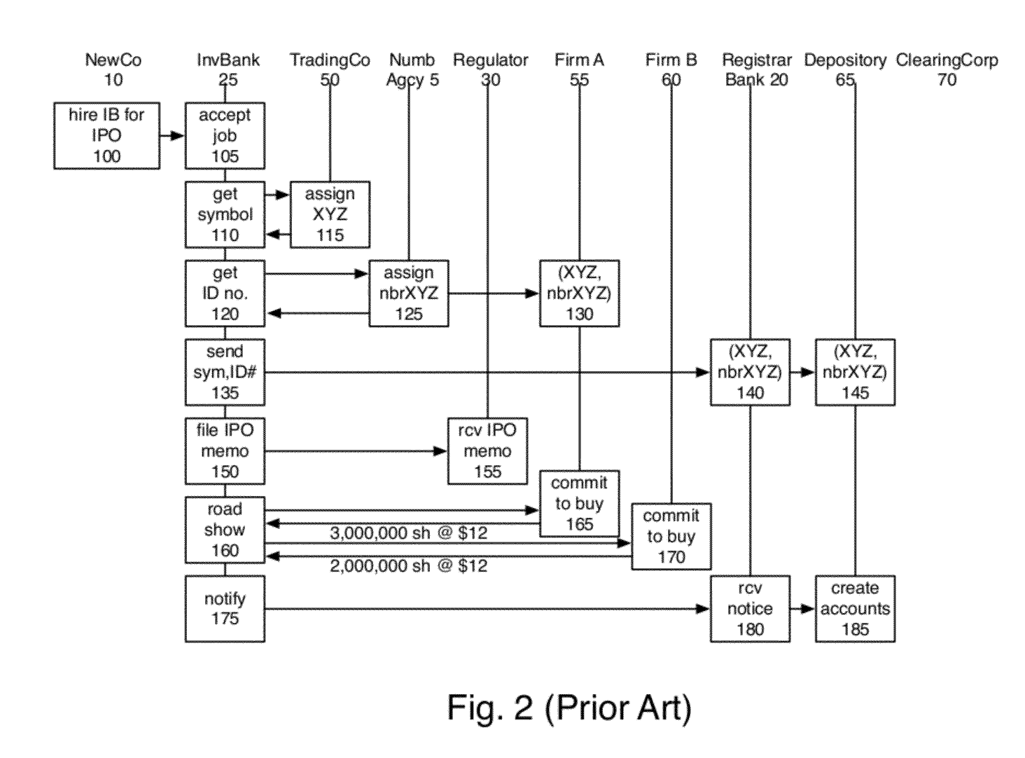

FIG. 2 is a flowchart showing prior art pre-trading activity.

At step 100, Newco 10 hires investment bank 25 to serve as its representative for an initial public offering of shares in Newco 10.

At step 105, investment bank 25 accepts the task from Newco 10.

At step 110, investment bank 26 requests a symbol for Newco 10 from trading company 50, to be used to designate shares of Newco 10 on trading platform 51.

At step 115, trading company 50 assigns the symbol “XYZ” to Newco 10.

At step 120, investment bank 25 requests a symbol identifier from numbering agency 5.

At step 125, numbering agency 5 assigns “nbrXYZ” as the symbol identifier, and sends this to all parties that are subscribers to the “new identifier” update service of numbering agency 5.

At step 130, firm 55, a subscriber to the “new identifier” update service of numbering agency 5, receives the information associating Newco 10, XYZ and nbrXYZ.

At step 135, investment bank 25 sends the newly obtained symbol and symbol identifier to registrar bank 20.

At step 140, registrar bank 20 receives the newly obtained symbol and symbol identifier, and forwards this information to depository 65.

At step 145, depository 65 receives the newly obtained symbol and symbol identifier.

At step 150, investment bank 25 files its draft Offering Memorandum (red herring) with regulator 30.

At step 160, investment bank 25 presents the new security to potential buyers at various meetings (road show), assesses interest, and advises that the initial offering price will be $12 per share. Firm 55 gets the identifier via an automated feed from numbering agency 5. Firm 60 sees the identifier in the red herring, and manually enters the identifier into its system.

At step 165, firm 55 commits to buy 3,000,000 shares at the initial price. Typically, firm 55 combines orders for its own proprietary trading account with customer orders to arrive at its total commitment.

At step 170, firm 60 commits to buy 2,000,000 shares at the initial price.

At step 175, investment bank 25 notifies registrar bank 20 that, when trading commences, firm 55 will own 3,000,000 shares and firm 60 will own 2,000,000 shares.

At step 180, registrar bank 20 receives and records the information, then passes it on to depository 65.

At step 185, depository 65 receives the notice of the initial owners of the shares.

On the actual initial public offering date (not shown), as soon as trading starts, firms 55 and 60 are recognized as the share owners. Assuming there are no other buyers, no sale activity occurs, and the total share offering was 10,000,000 shares, at the end of the day, each of registrar bank 20 and depository 65 have recorded share ownership as follows:

XYZ, nbrXYZ, NewCo 10
total 10,000,000 shares

| | |
|---|---|
| NewCo. | 105,000,000 shares |
| Firm 55 | 3,000,000 shares |
| Firm 60 | 2,000,000 shares |

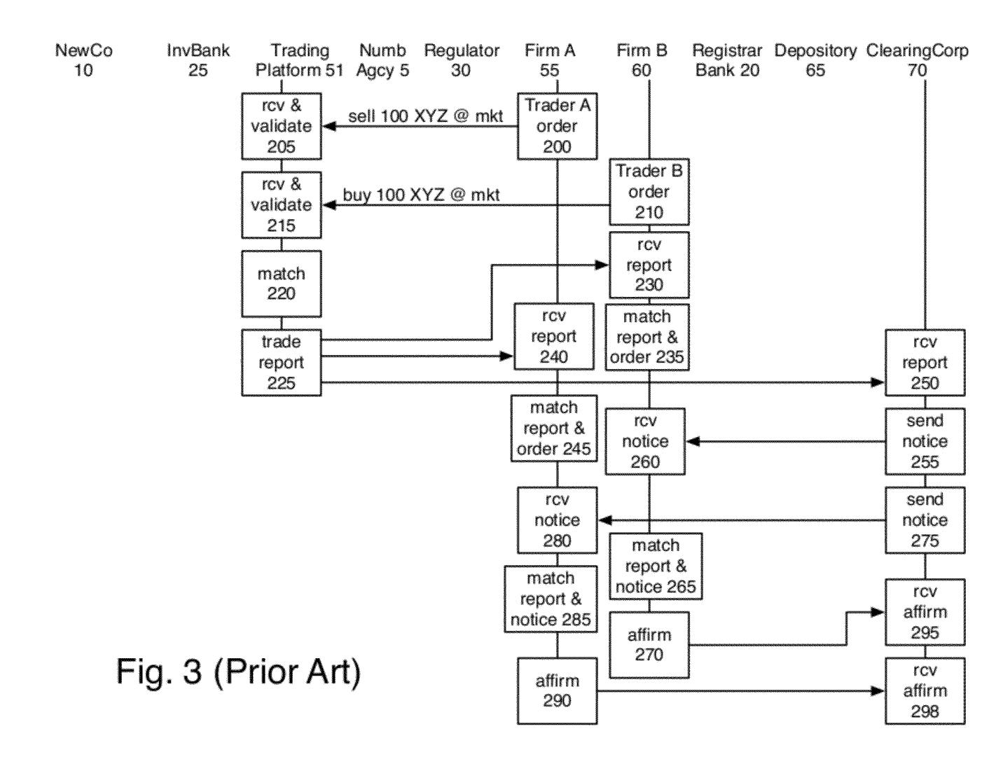

FIG. 3 is a flowchart showing prior art trade day activity with proprietary trading.

Let it be assumed that, some time after the initial public offering, firm 55 decides to sell 100 shares of XYZ at the market price for its own account, and firm 60 decides to buy 100 shares of XYZ for its own account.

At step 200, trader A at firm 55 creates a sell order for 100 shares of XYZ at the market price, and sends it to trading platform 51.

At step 205, trading platform 51 receives the sell order, validates its terms, and stores the sell order in its trading book, that is, its database of orders waited to be executed.

At step 210, trader B at firm 60 creates a buy order for 100 shares of XYZ at the market price, and sends it to trading platform 51.

At step 215, trading platform 51 receives the buy order, validates its terms, and searches for any possible matches prior to storing the order in its trading book.

At step 220, trading platform 51 finds the sell order from trader A and matches it with the buy order from trader B, thereby creating an executed trade.

At step 225, trading platform 51 sends trade reports, also known as execution reports, to the parties involved in the trade and to clearing corporation 70. The trade report to trader A is as follows:
SOLD 100 shares XYZ at $21.12 to Firm 60
   The trade report to trader B is as follows:
BOT 100 shares XYZ at $21.12 from Firm 55
   The trade report to clearing corporation 70 is as follows:
nbrXYZ 100 shares at $21.12 Firm 60 to Firm 55
   Additionally (not shown), trading platform 51 reports the trade as a market data update to its market data distribution system (not shown), which disseminates the trade information to the public.

At step 230, firm 60 receives its execution report.

At step 235, firm 60 matches the execution report with the order to buy 100 shares from trader B.

At step 240, firm 55 receives its execution report.

At step 245, firm 55 matches the execution report with the order to sell 100 shares from trader A.

At step 250, clearing corporation 70 receives the trade report.

At step 255, clearing corporation 70 sends a settlement notice to firm 60.

At step 260, firm 60 receives the settlement notice from clearing corporation 70.

At step 265, firm 60 matches the settlement notice with the execution report that it bought 100 shares of XYZ.

At step 270, firm 60 sends an affirm notice to clearing corporation 70, accepting the settled trade.

At step 275, clearing corporation 70 sends a settlement notice to firm 55.

At step 280, firm 55 receives the settlement notice from clearing corporation 70.

At step 285, firm 55 matches the settlement notice with the execution report that it sold 100 shares of XYZ.

At step 290, firm 55 sends an affirm notice to clearing corporation 70, accepting the settled trade.

At step 295, clearing corporation 70 receives the affirm from firm 60.

At step 298, clearing corporation 70 receives the affirm from firm 55. The trade is now fully confirmed. Clearing corporation 70 novates itself into the trade, creating a first legal obligation to buy 100 shares of XYZ from firm 55, and a second legal obligation to sell 100 shares of XYZ to firm 60, and guarantees to each of firms 55 and 60 that its respective obligation will settle on T+3. Then, clearing corporation 70 aggregates all activity for XYZ for firm 55 to create a net position for that day's activity, and aggregates all activity for firm 60 to create a net position for that day's activity. For this example, we assume that the only trade that occurred during the day was the sale of 100 shares of XYZ. Clearance is now complete.

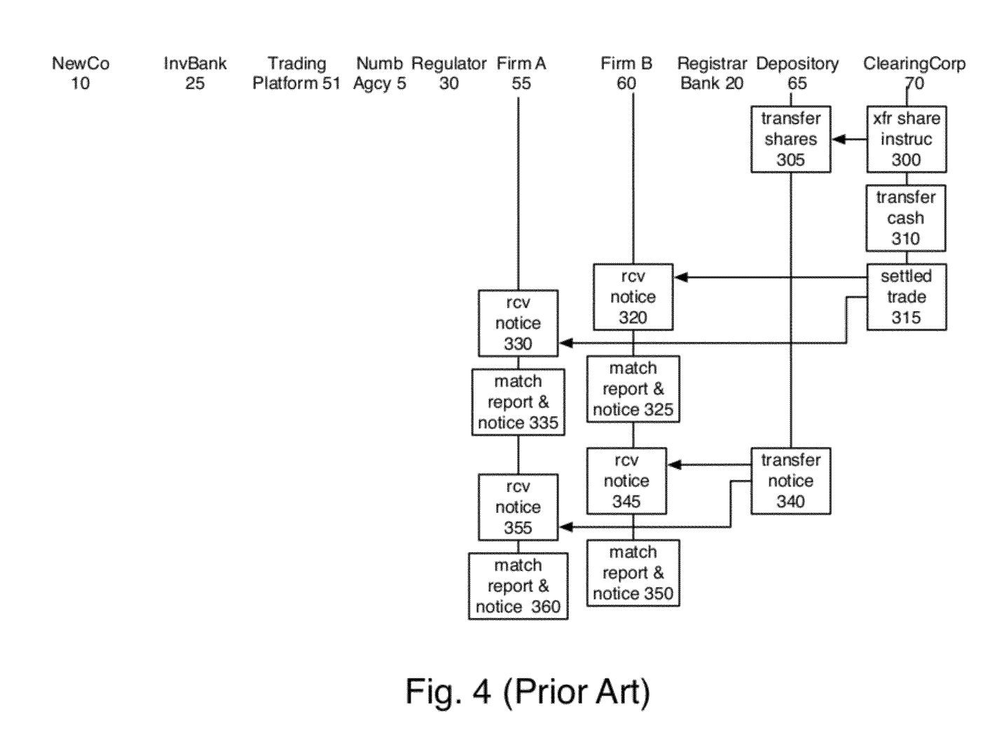

FIG. 4 is a flowchart showing prior art settlement day activity.

At step 300, clearing corporation 70 sends share transfer instructions to depository 65, to transfer 100 shares of XYZ from the account of firm 55 to firm 60.

At step 305, depository 65 transfers the shares. Depository 65 has recorded share ownership as follows, assuming that only this one trade of 100 shares of XYZ occurred since the security was issued.

XYZ, nbrXYZ, NewCo 10
total 10,000,000 shares

| | |
|---|---|
| NewCo. 10 | 5,000,000 shares |
| Firm 55 | 2,999,900 shares |
| Firm 60 | 2,000,100 shares |

At step 310, clearing corporation 70 transfers cash in its internal cash accounts from the account for firm 60 to the account for firm 55. In some embodiments, instead of using internal cash accounts, clearing corporation 70 sends instructions to the banks associated with firms 55 and 60, or, if firms 55 and 60 can interact directly with the federal funds transfer system, then to them.

At step 315, clearing corporation 70 sends a notice that the trade has settled to each of firms 55 and 60.

At step 320, firm 60 receives the notice of settled trade.

At step 325, firm 60 matches the settlement notice to its execution report.

At step 330, firm 55 receives notice of the settled trade.

At step 335, firm 55 matches the settlement notice to its execution report.

At step 340, depository 65 sends a share transfer notice to each of firms 55 and 60.

At step 345, firm 60 receives the share transfer notice.

At step 350, firm 60 matches the share transfer notice with the execution report, and concludes that the trade is fully and properly settled.

At step 355, firm 55 receives the share transfer notice.

At step 360, firm 55 matches the share transfer notice with the execution report, and concludes that the trade is fully and properly settled.

Two instances of errors that occur in the prior art will now be discussed.

It will be seen that due to the frequent matching of information regarding the progress of the trade, the errors are discovered, and are likely to be corrected. However, there is still a large cost for the manual processing required for errors. Furthermore, if the manual processing does not finish by T+3, the firm will have to borrow cash or stock to ensure settlement, which is costly and then may have to be reversed when error processing concludes.

It will be appreciated that other trading data errors also occur with similar consequences: the cost for manual error processing, and additional costs if the manual error processing does not complete by T+3.

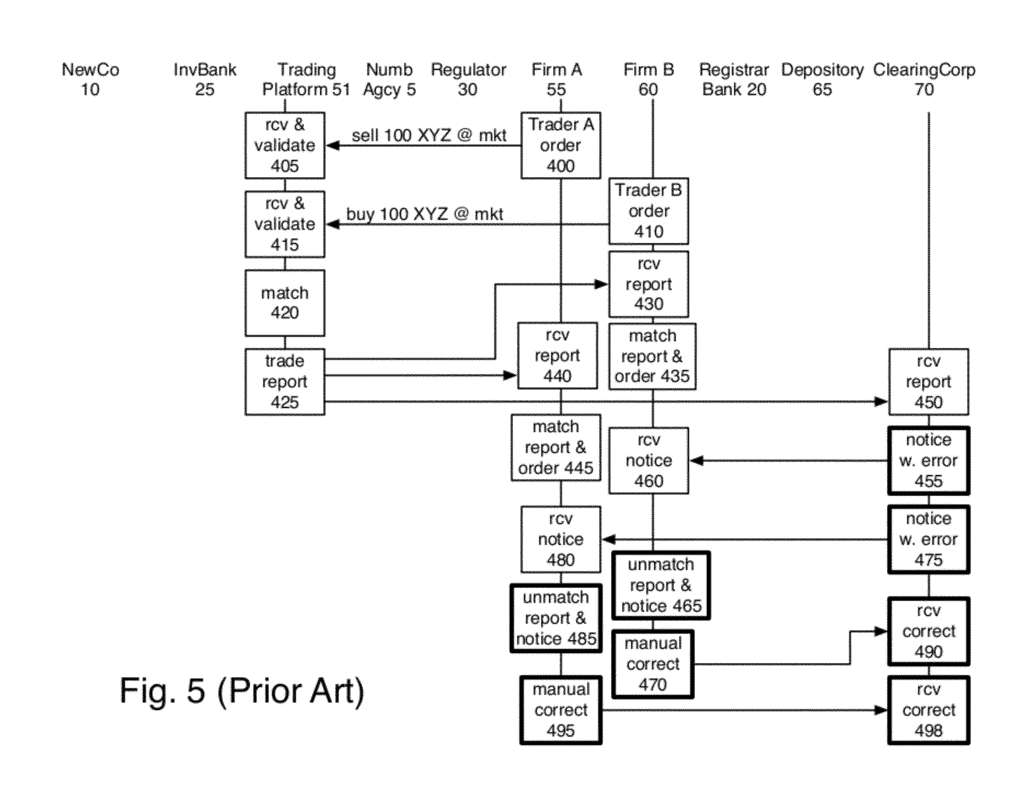

FIG. 5 is a flowchart showing a prior art clearing error.

FIG. 5 is similar to FIG. 3, and for brevity, only differences will be discussed. In this case, the error is that clearing corporation 70 has stored the wrong company name for the identifier. That is, instead of correctly associating (nbrXYZ, Newco 10), clearing corporation 70 has mistakenly stored (nbrXYZ, Gemco) and has correctly stored that the symbol for Gemco is JMO.

Steps 400-450 of FIG. 5 correspond to steps 200-250 of FIG. 3.

At step 455, clearing corporation 70 sends a settlement notice to firm 60, showing that firm 60 bought 100 shares of Gemco symbol JMO.

At step 460, firm 60 receives the settlement notice from clearing corporation 70.

At step 465, firm 60 tries to match the settlement notice that it bought 100 shares of JMO with the execution report that it bought 100 shares of XYZ, but since they do not match, the settlement notice remains unmatched and is flagged in an automatically produced error report. A clerk at firm 60, or an automated error handling system at firm 60, suspects that the settlement notice should match the execution report, perhaps because the identifier nbrXYZ is on both the notice and report, or perhaps because the same share quantity is on both the notice and report, or perhaps because the same execution time is on both the notice and report. Generally, a clerk at firm 60 will call a clerk at clearing corporation 70 and hopefully notice that clearing corporation 70 has the wrong company name for the identifier nbrXYZ.

At step 470, firm 60 sends a correction notice to clearing corporation 70.

At step 475, clearing corporation 70 sends a settlement notice to firm 55, showing that firm 55 sold 100 shares of Gemco symbol JMO.

At step 480, firm 55 receives the settlement notice from clearing corporation 70.

At step 485, firm 55 is unable to match the settlement notice that it sold 100 shares of JMO with the execution report that it sold 100 shares of XYZ. Similar processing occurs in firm 55 as occurred in firm 60 at step 465.

At step 495, firm 55 sends a correction notice to clearing corporation 70.

At step 490, clearing corporation 70 receives the correction notice from firm 60.

At step 498, clearing corporation 70 receives the correction notice from firm 55. A clerk at clearing corporation 70 decides that the trade has been cleared, and ensures that the error in the database is corrected.

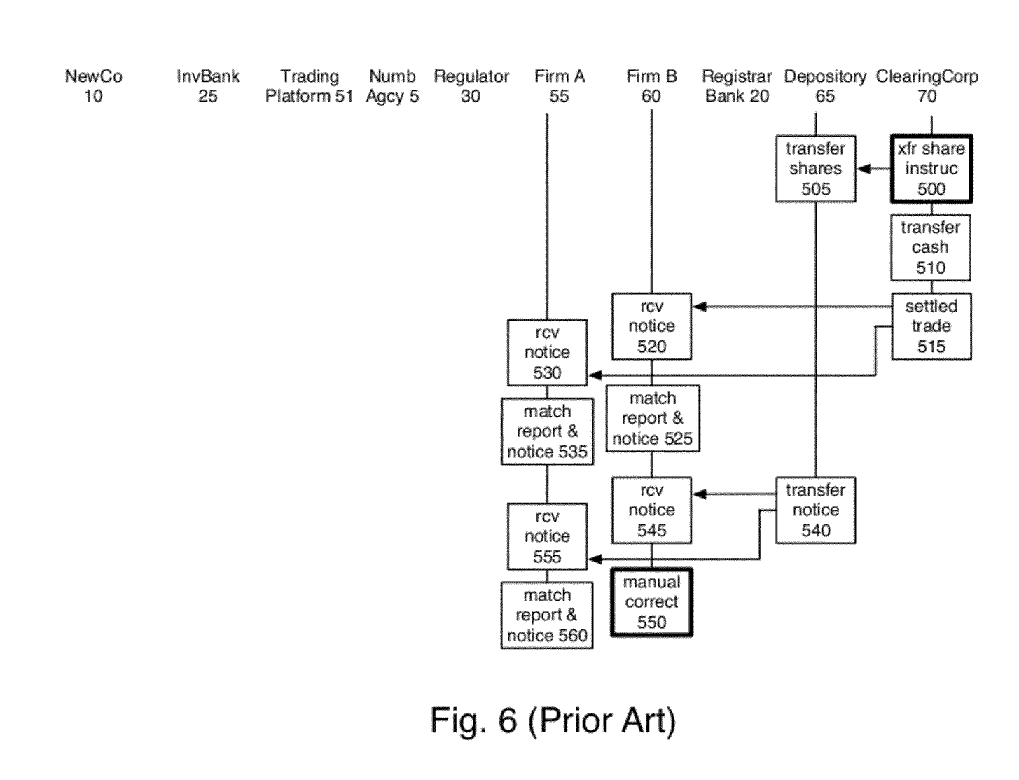

FIG. 6 is a flowchart showing a prior art settlement error.

FIG. 6 is similar to FIG. 4, and for brevity, only differences will be discussed. In this case, assume that Newco 10 declared a stock dividend of one share per outstanding share, that is, the dividend will double the number of outstanding shares. Also assume that T+3 is the ex-dividend date. Firms 55 and 60 correctly understand that they should double the number of shares for the XYZ trade, from 100 shares to 200 shares. Assume, however, that clearing corporation 70 has made a mistake, such as by having received the incorrect date from a vendor in an automated manner or by having the incorrect date improperly recorded by a clerk from a manual process, and thinks that the ex-dividend date is T+4, not T+3.

In general, a financial enterprise may need to access sources of corporate event information globally from: stock exchanges; central depositories; commercial data vendors; issuer prospectuses; and press releases and newspapers. This is a massive amount of information that needs to be collated, validated, captured in codes and then put into a structured syntax that can be processed by a software application. For example, there are nearly 100 different types of corporate actions, and different laws dictate how each company must report this information. As business laws across different countries are not harmonized, the rights of shareholders pursuant to an event are not the same across different markets, thus making the communication of corporate events hard to standardize globally. Additionally, this information is required for adjustments to indexes, futures, options and derivative products that have securities underlying these instruments. Also, notification of these events, culled from these numerous sources, gets passed through a long chain from issuer and registrar, and on through sub-custodians, global custodians, the Depository Trust Company & Clearing Corp. (DTCC) here in the US, other (foreign) central depositories, vendors, broker/dealers, and investment managers.

Corporate event information arrives at an entity in varied formats from different data vendors, is sometimes confusing to understand, and at other times is incorrect when a particular data vendor made a mistake in converting manual data, such as press releases, to digital data. Because of this each entity typically obtains information from multiple but different data vendors and compares the obtained information to discover discrepancies, thereby preventing reliance on incorrect information. These discrepancies then have to be followed up on, usually through manual intervention back to the originating source, and repaired.

At step 500, clearing corporation 70 sends share transfer instructions to depository 65, to transfer 100 shares of XYZ from the account of firm 55 to firm 60. Because of the dividend, this is an error; clearing corporation 70 should have instructed depository 65 to transfer 200 shares of XYZ.

Steps 505-545 and 560 of FIG. 6 correspond to steps 305-345 and 360 of FIG. 4.

At step 550, firm 60 cannot match the share transfer notice for 100 shares with the execution report, as updated to reflect that it bought 200 shares. Accordingly, the share transfer notice is put on an automatically generated error report. Probably, the execution report also appears on an automatically generated error report, as being unmatched. A clerk at firm 60 hopefully realizes that the discrepancy in the number of shares is due to XYZ's dividend, and calls depository 65 and clearing corporation 70 to correct the error. Until the error is corrected, the clerk in firm 60 notifies trader B that the trade has not cleared, and trader B cannot trade the missing shares of XYZ, which could be highly disadvantageous in a fast moving market.

An example of trading on behalf of an institutional client will now be discussed.

Let it be assumed that Firm C (not shown) operates mutual fund AA, BB and CC, and has engaged investment manager 35 to trade for its mutual funds.

Firm C uses custodian bank 40 as custodian for its mutual funds. Custodian bank 40 outsources some of its data processing functions to financial industry post-trade data processor 45.

Investment manager uses firm 55 for its trades; during set-up of the trading account for investment manager 35, firm 55 was instructed as to the relationships of the parties.

Some time after the initial public offering of XYZ, investment manager 35 decides to sell 500 shares of XYZ for mutual fund AA, sell 200 shares of XYZ for mutual fund BB, and sell 500 shares of XYZ for mutual fund CC, that is, to sell a total of 1000 shares of XYZ.

Coincidentally, at the same time, trader B of firm 60 decides to buy 1000 shares of XYZ for the proprietary trading account of firm 60.

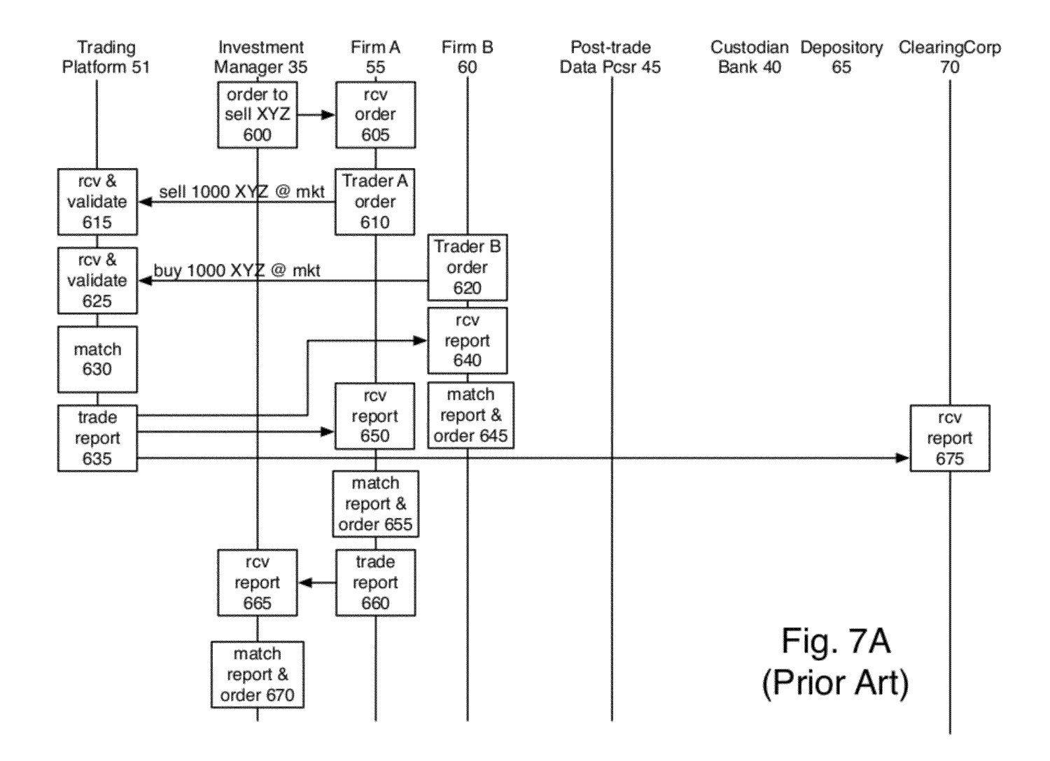

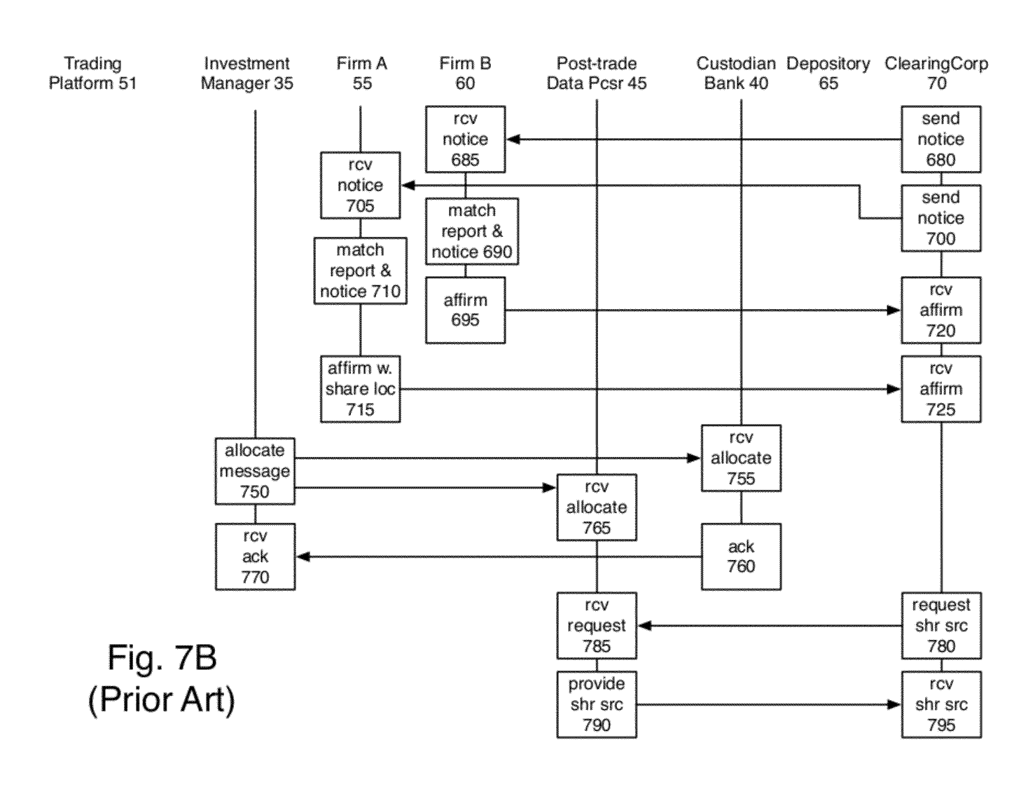

FIGS. 7A and 7B are a flowchart showing prior art trade day activity for this case of a sell side institutional trader and a buy side proprietary trader. FIGS. 7A and 7B are similar to FIG. 3, and for brevity, only differences will be discussed.

At step 600, investment manager 35 sends an order to sell 1000 shares of XYZ at the market price to firm 55.

At step 605, firm 55 receives the sell order from investment manager 35.

Steps 610-655 of FIG. 7A correspond to steps 210-245 of FIG. 3

At step 660, firm 55 sends a trader report to investment manager 35.

At step 665, investment manager 35 receives the trade report.

At step 670, investment manager 35 matches the trade report against its sell order.

Steps 675-710 of FIGS. 7A and 7B correspond to steps 250-285 of FIG. 3.

At step 715, firm 55 sends an affirm notice to clearing corporation 70, accepting the settled trade, and instructing clearing corporation 70 that financial industry post-trade data processor 45 will provide the account locations to be debited by depository 65.

At step 720, clearing corporation 70 receives the affirm from firm 60.

At step 725, clearing corporation 70 receives the affirm from firm 55, including the instruction to look to financial industry post-trade data processor 45 for share locations.

At step 750, which ideally occurs on T, but could occur as late as the morning of T+3, investment manager 35 sends an allocate message to custodian bank 40 and financial industry post-trade data processor 45, explaining how to allocate its 1000 share trade among mutual funds AA, BB and CC. While larger investment managers have fully computerized systems, smaller investment managers—such as single person firms—still use manual techniques for sending messages such as sending a handwritten fax.

At step 755, custodian bank 40 receives the allocate message, and at step 760, acknowledges receipt of the allocate message to investment manager 35.

At step 765, financial industry post-trade data processor 45 receives the allocate message from investment manager 35.

At step 770, investment manager 35 receives the acknowledgement from custodian bank 40.

In some embodiments, investment manager 35 communicates only with financial industry post-trade data processor 45, which in turn, provides daily position update reports to custodian bank 40.

At step 780, clearing corporation 70 sends a share source request to financial industry post-trade data processor 45.

At step 785, financial industry post-trade data processor 45 receives the share source request, and at step 790, provides the share source, that is, the account for firm C, to clearing corporation 70.

At step 795, clearing corporation 70 receives the share source instructions. The trade is now fully confirmed.

If investment manager 35 was slow about providing its allocate message, then although step 780, the request for share source from clearing corporation 70, occurred on T, financial industry post-trade data processor 45 would be unable to provide the share source at step 790 until as late as the morning of T+3.

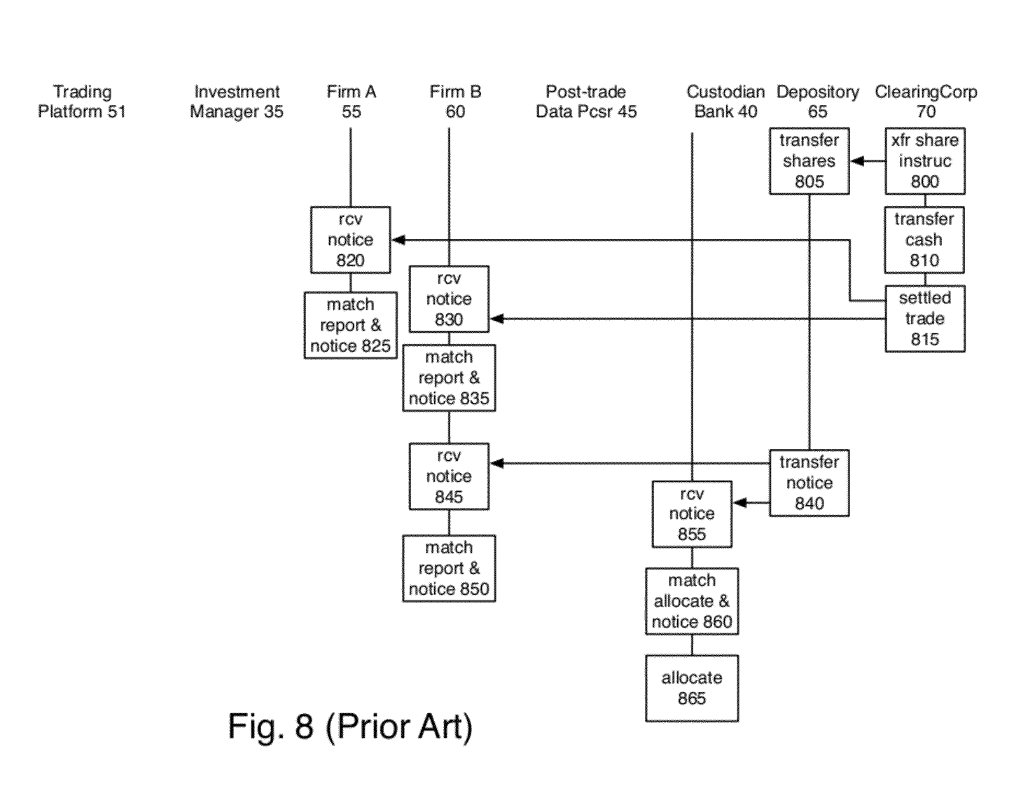

FIG. 8 is a flowchart showing prior art settlement day activity for this case.

FIG. 8 is similar to FIG. 4, and for brevity, only differences will be discussed.

At step 800, clearing corporation 70 sends share transfer instructions to depository 65, to transfer 1000 shares of XYZ from the account of firm C to firm 60.

Steps 805-835 of FIG. 8 correspond to steps 305-335 of FIG. 4.

At step 840, depository 65 sends a share transfer notice to each of financial industry post-trade data processor 45 and firm 60.

Steps 845-850 of FIG. 8 correspond to steps 345-350 of FIG. 4.

At step 855, financial industry post-trade data processor 45 receives the share transfer notice.

At step 860, financial industry post-trade data processor 45 matches the share transfer notice with the allocation message, and concludes that the trade is fully and properly settled.

At step 865, financial industry post-trade data processor 45 updates its records for firm C to allocate the cleared shares to mutual funds AA, BB and CC, in accordance with the allocate message from investment manager 35.

Another instance of an error that occur in the prior art will now be discussed.

As in the proprietary account trading examples discussed above, it will be seen that due to the frequent matching of information regarding the progress of the trade, the errors are discovered, and are likely to be corrected. However, there is still a large cost for the manual processing required for errors. Furthermore, if the manual processing does not finish by T+3, a firm trading on behalf of a customer will have to borrow cash or stock to ensure settlement, which is costly and then may have to be reversed when error processing concludes.

It will be appreciated that other trading data errors also occur with similar consequences: the cost for manual error processing, and additional costs if the manual error processing does not complete by T+3. Furthermore, the delay in entering into a trade and then waiting three days or more for the finality of settlement and payment has inherent and systemic risk built into the entire end-to-end process. Significant risk of default is associated with a firm or client involved in the transaction declaring bankruptcy during the transactions life cycle. Also cash flows from other markets that are surrogates for stocks, such as options or futures have shorter trade-to-settlement/payment life cycles; even certain markets such as government securities markets settle in real-time, while available earlier cannot be offset from stock markets cash flows until three days forward. This causes significant overnight borrowing to synchronize these cash flows with the potential of bank defaults.

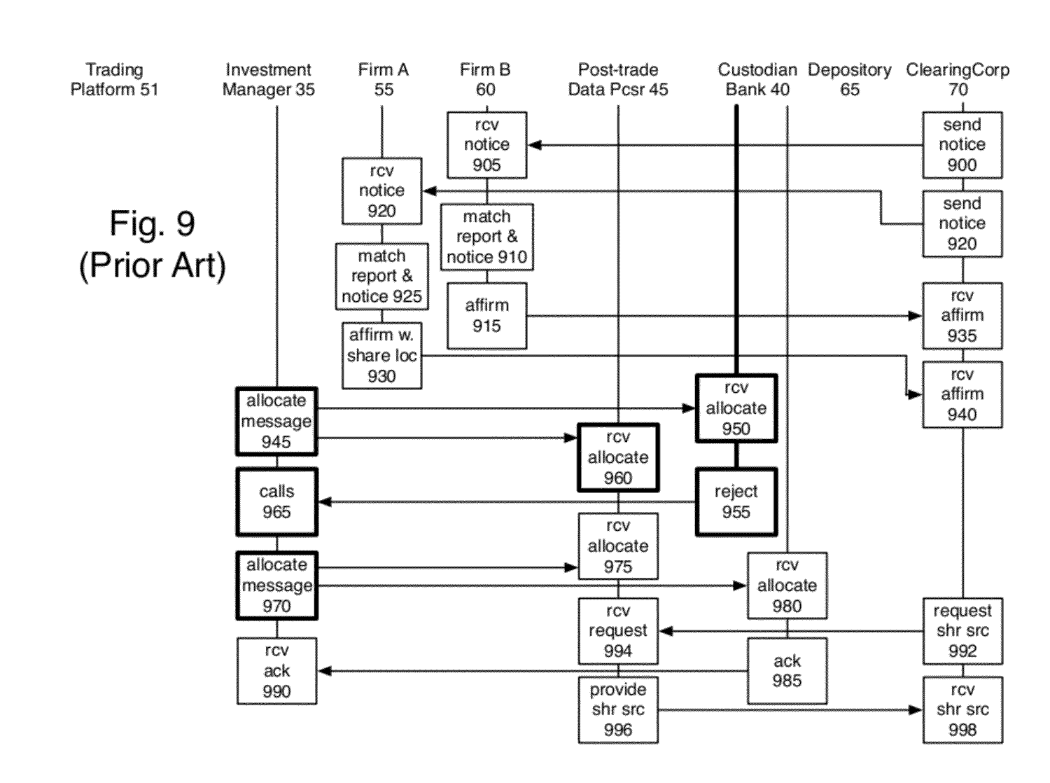

FIG. 9 is a flowchart showing another prior art clearing error.

FIG. 9 is similar to FIG. 7B, and for brevity, only differences will be discussed.

In this case, the error is that investment manager 35 has the wrong custodian bank associated with mutual funds AA, BB and CC. This can easily occur if firm C changes its custodian bank from another bank to custodian bank 40, but forgot to tell its outside investment manager 35. Or, firm C could send a notice of change of custodian bank to investment manager 35 who could not get around to updating its records.

Steps 900-940 of FIG. 9 correspond to steps 680-725 of FIG. 7B.

At step 945, which ideally occurs on T, but could occur as late as the morning of T+3, investment manager 35 sends an allocate message to another custodian bank (not shown in FIG. 1), namely, the old custodian bank, and to financial industry post-trade data processor 45, explaining how to allocate its 1000 share trade among mutual funds AA, BB and CC.

At step 950, the other custodian bank receives the allocate message, and at step 955, sends a reject message back to investment manager 35.

Step 960 of FIG. 9 corresponds to step 765 of FIG. 7B.

At step 965, investment manager 35 receives the reject from the other custodian bank. Investment manager 35 now has to figure out why the reject occurred. For small investment managers, this could take a few days, as they may not have dedicated clerical staff, that is, the investment manager may do his or her own error handling, and if the investment manager is on vacation while the error occurs, they will not get around to dealing with the error in the normal trade processing cycle. In this case, let it be assumed that investment manager 35 promptly calls firm C, to confirm the identity of the custodian bank, and learns that the custodian bank has changed to custodian bank 40.

At step 970, investment manager sends a corrected allocate message to custodian bank 40 and to financial industry post-trade data processor 45.

At step 975, financial industry post-trade data processor 45 receives the corrected allocate message.

At step 980, custodian bank 40 receives the allocate message and at step 985, sends an acknowledgement message to investment manager 35.

At step 990, investment manager 35 receives the acknowledgement from custodian bank 40.

Steps 992-998 of FIG. 9 correspond to steps 780-795 of FIG. 7B.

The above three cases of prior art errors illustrate how the errors were noticed and corrected.

Other prior art error can occur that are not even noticed, and therefore do not get corrected. Actions depending on the uncorrected data will thus be based on erroneous information, and so the actions taken may be wrong.

Two examples of unnoticed and uncorrected errors will now be discussed. The first relates to intra-firm data aggregation that is used for risk management. The second relates to data aggregation used for regulatory awareness of the financial industry.

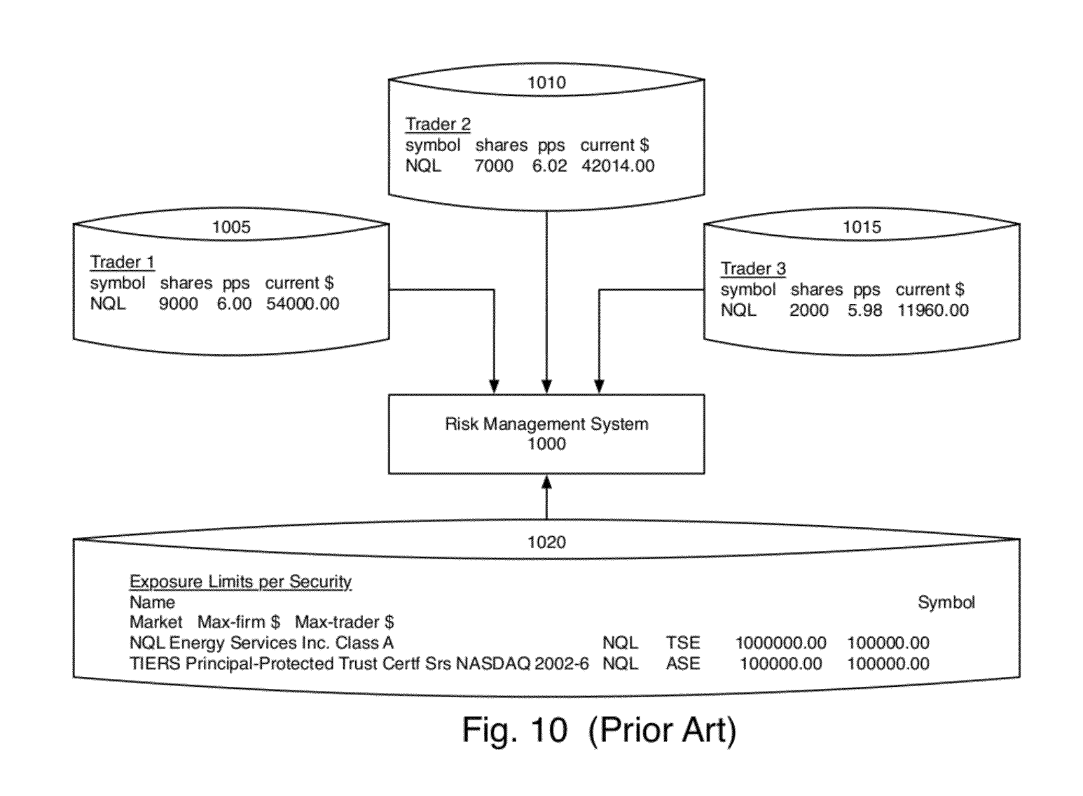

FIG. 10 is a flowchart showing a problem with prior art intra-firm data aggregation.

In this case, let it be assumed that a firm trading for its own account, such as a hedge fund, has a risk management system with two position limits for security, indicating how big a position can be taken by an individual trader in the security, and how much overall exposure the firm will tolerate for the security.

As sometimes occurs, different trading marketplaces assign the same symbol to different securities, since there is no overall coordination of symbol assignment. For instance, the symbol NQL on the Toronto Stock Exchange trading platform corresponds to the security NQL Energy Services Inc. Class A stock, while the symbol NQL on the American Stock Exchange trading platform (owned by NYSE Euronext) corresponds to TIERS Principal-Protected Trust Certificate Series NASDAQ 2002-6 security.

The firm has risk management system 1000 with database 1020 showing the two position limits for each security, and has correctly represented that NQL corresponds to two different securities, and has different position limits for overall firm exposure for these two securities.

The trades of traders 1, 2 and 3 are in databases 1005, 1010 and 1015, respectively. These traders each have one position in NQL, but have not specified which NQL their position is for.

In this example, the positions of traders 1, 2 and 3 are consistent with the individual trader position limits for both NQL, so no alarms are triggered.

If risk management system 1000 is programmed to aggregate unspecified NQL positions as NQL:TSE, then no alarms will be triggered, as the sum of the positions of traders 1, 2, 3 is less than the overall firm limit for NQL:TSE.

However, if traders 1, 2 and 3 each have positions in NQL:ASE, then the firm's overall exposure has been exceeded, and an alarm should be triggered in risk management system 1000. But, no alarm occurs. Accordingly, the firm's management believes their risk is properly contained, whereas in reality, their risk is more than they want. However, no one in the entire firm is aware of the problem, and all systems appear to be operating properly and all traders believe their exposure is as desired by the firm's management.

This is an illustration of the existence of an intra-firm problem that exists, but is not recognized.

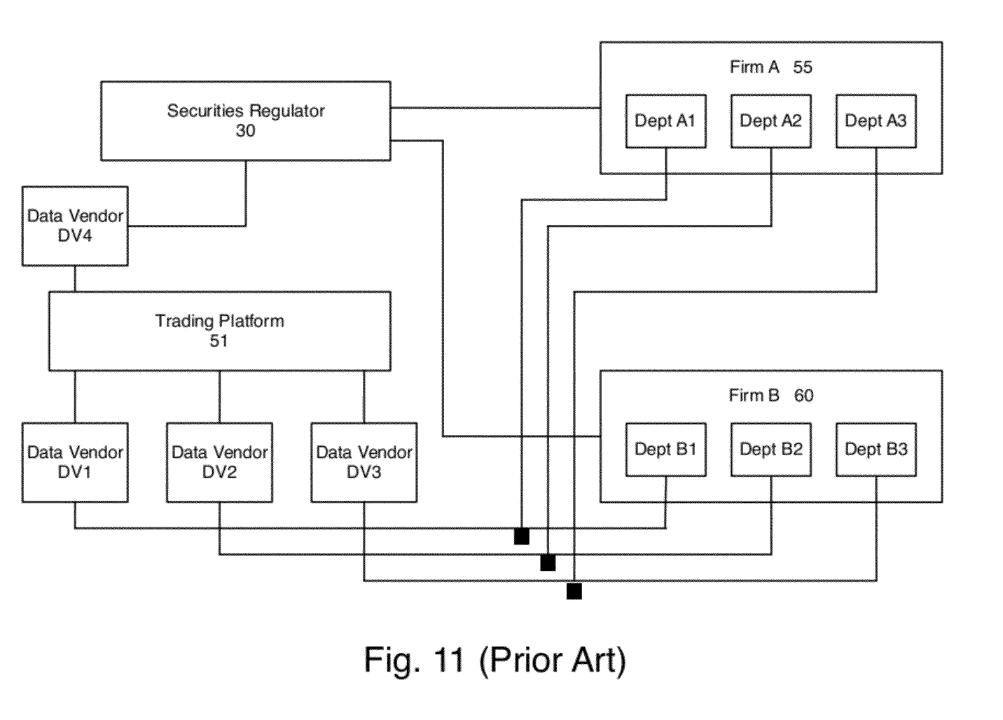

FIG. 11 is a block diagram showing another prior art hardware and communication configuration.

Trading platform 51 supplies its market data to data vendors DV1, DV2, DV3 and DV4.

Firm 55 has departments A1, A2 and A3 that are respectively supplied with data from data vendors DV1, DV2 and DV3. For example, department A1 might be a proprietary trading securities group and appreciates the stock charting features in the data feed from data vendor DV1; department A2 might be retail trading, and gets only “bare bones” market data from data vendor DV2; while department A3 might be another proprietary trading group focused on derivatives that uses the underlying security market data from data vendor DV3 along with its derivative market data.

Firm 60 has departments B1, B2 and B3 that are respectively supplied with data from data vendors DV1, DV2 and DV3.

Securities regulator 30 requires daily position reports from firms 55 and 60, and then uses market data from data vendor DV4 to convert the positions to cash exposures, which are compared against the reserve capital for the firm, to understand its leverage.

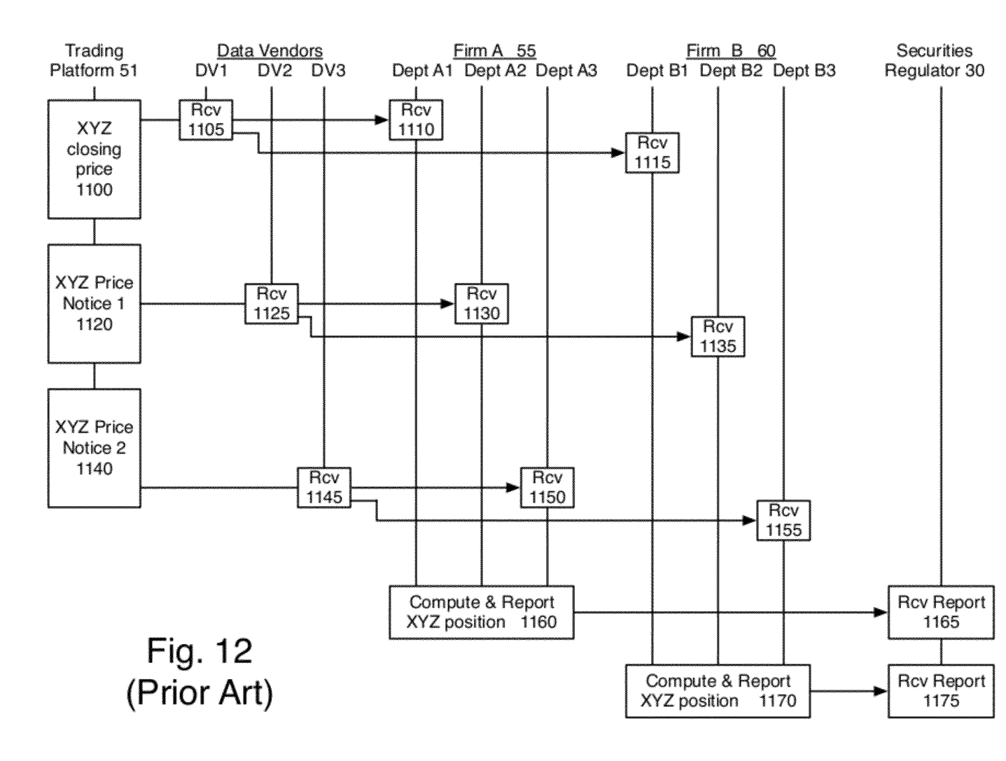

FIG. 12 is a flowchart showing a problem with prior art inter-firm data aggregation.

Each trading platform reports a “closing price” for its daily trading. The closing price is usually the same as the price at which the last trade occurred. However, each trading platform can define its closing price according to its own rules, for example, as the average of the price at which the last three trades of the day occurred.

The closing price is also referred to as a “last sale price” or a “valuation price”. The closing price is very important, as most investors perform daily mark-to-market valuations of their investments using the closing price for their securities.

There are hundreds of trading platforms in the world, nearly 80 trading platforms are in the United States. Various data vendors receive the closing prices from some or all of the trading platforms, and in turn, generate and distribute, at the end of each trading day, a closing price data feed. However, the various data vendors do not always report the same closing price for a particular security at a particular trading platform, for myriad reasons, including (a) the vendor has installed a new software interface that does not properly handle closing prices, (b) the vendor failed to get a price adjustment notice from a trading platform, (c) the vendor's internal cut-off time for assembling data for its closing price data feed was earlier than the time that the trading platform issued an adjusted closing price and so the vendor will report the adjustment on the next day, and so on.

At step 1100, trading platform 51 reports a closing price for XYZ on a particular day.

Then due to corrections made at trading platform 51, at step 1120, trading platform 51 reports a first corrected closing price as part of its market data information.

Due to further corrections made at trading platform 51, at step 1140, trading platform 51 reports a second corrected closing price as part of its market data information.

For instance, Notice 1 averaged the last three prices of the day, given that the last price was of a disputed trade price far from the previous last trade. The last price was left standing but averaged in and recalculated in a new valuation price. Notice 2 changed the valuation price a second time as it was usual for floor governors to review immediate closing price judgments, this time removing the disputed last trade, thus leaving the previous trade as the last trade and defining it as the valuation price.

At step 1105, data vendor DV1 receives the original valuation price, and distributes it to departments A1 of firm 55 and B1 of firm 60.

At step 1125, data vendor DV2 receives the notice 1 price, and distributes it to departments A2 of firm 55 and B2 of firm 60.

At step 1145, data vendor DV3 receives the notice 2 valuation price, and distributes it to departments A3 of firm 55 and B3 of firm 60.

Here, the error is that the data vendors did not all pick up all of the corrections. Accordingly, their closing prices differ.

At steps 1110, 1130 and 1150, departments A1, A2 and A3 receive the respectively different closing prices. At step 1160, firm 55 computes its overall XYZ position and reports it to regulator 30. At step 1165, regulator 30 receives the position report from firm 55.

At steps 1115, 1135 and 1155, departments B1, B2 and B3 receive the respectively different closing prices. At step 1170, firm 60 computes its overall XYZ position and reports it to regulator 30. At step 1175, regulator 30 receives the position report from firm 55.

In a further step (not shown), regulator 30 uses the data from data vendor DV4 to calculate overall positions based on the reports from firms 55 and 60. At best, the closing price from DV4 matches one of the closing prices from one of the vendors DV1, DV2, DV3, and is the correct (notice 2) price. However, data vendor DV4 could also have the wrong price.

Of concern is that regulator 30 does not know that the data from the various firms are internally incommensurate, and further does not suspect that its selected data vendor DV4 may compound errors.

This is an illustration of the existence of an inter-firm problem that exists, but is not recognized.

The CCDM will now be described.

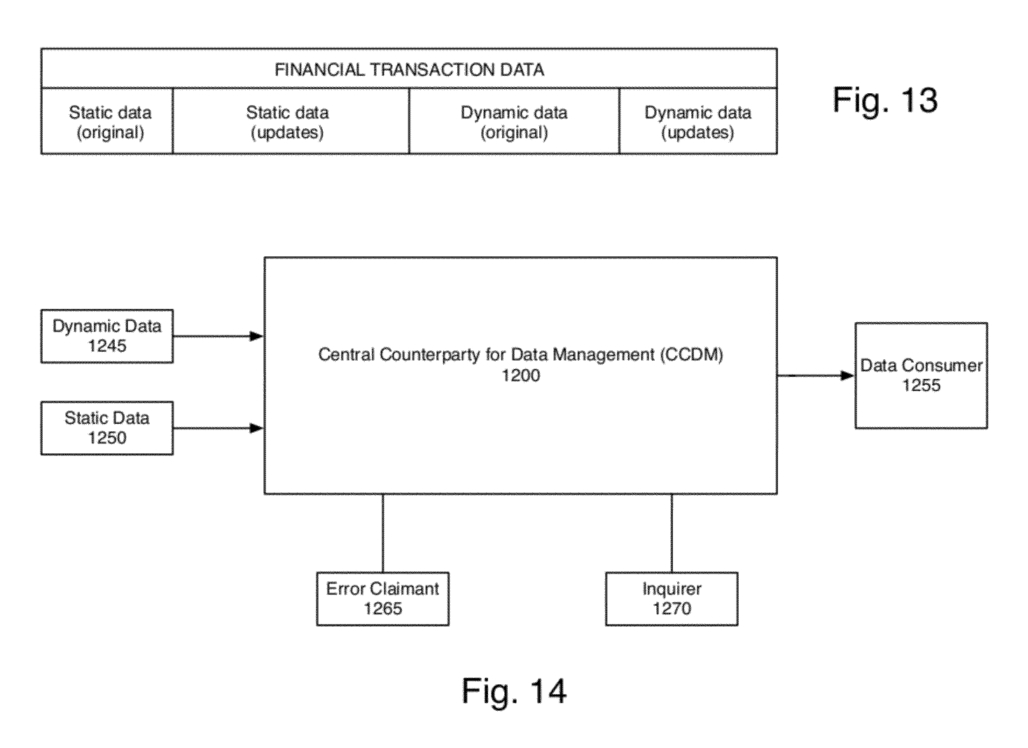

FIG. 13 shows an organization of financial transaction data. Broadly, transaction data can be grouped into static data representing something that rarely or never changes, and dynamic data representing a transaction. Each of these groups can be further grouped into the original data item, and updates to the data item. All of this data is sometimes referred to as “reference data”. All of this data is eligible for inclusion in the CCDM.

A financial transaction becomes associated with additional reference data as it moves through its life cycle. For instance, a trader may decide to “buy 100 XYZ at 21.54”, then the trader's order entry system associates “XYZ” with “Newco common stock”, and associates “21.54” with “US dollars”. Here, the full name of the security is an instance of reference data, and the currency is another instance of reference data. The order entry system then selects trading platform TP1 because of an order flow rebate arrangement that the trading firm has negotiated with that trading platform, and associates “sent to trading platform TP1” with the order. At trading platform TP1, the buy order is matched with a sell order, and the trading platform associates “trade date/time” information, “sale price” information and “counterparty” information with the transaction. Additional reference data may be appended to the transaction during clearance and settlement.

Financial transactions, which increasingly are exclusively information based, are represented as a series of data elements that collectively represent their unique unalterable attributes, referred to as static data; their occasional adjustments, as in corporate events or changes of corporate ownership; and their variable transaction components such as traded date, quantity and price. The unalterable characteristics and occasional adjustments, collectively termed reference data, uniquely identifies the product (security number and market), its unique structure (financial attributes), its manufacturer (counterparty, dealer or exchange), its delivery point (delivery or settlement instructions), its valuation price (closing or settlement price), its currency, and its expected delivery time.

So called high-frequency traders locate their computers physically near to the computers of trading platforms, to minimize transmission delays. The trading platforms typically charge extra for the so-called low latency data provided to the co-located computers of the traders. The low latency data is not well suited for the CCDM. However, the trading platforms provide the same data at normal latency, and the normal latency version of the trading data is well suited for the CCDM.

Reference data uniquely identifies a financial product (security number, symbol, market, etc.), its unique type, terms and conditions (asset class, maturity date, conversion rate, etc.), its manufacturer or supply chain participant (counterparty, reference entity, dealer, institution, exchange, etc.), its delivery point (delivery, settlement instructions and location), its delivery or inventory price (closing or settlement price) and its currency. Analogous to specifications for manufactured products, reference data also defines the products' changing specifications (periodic or event driven corporate actions) and seasonal incentives or promotions (dividends, capital distributions and interest payments)

Conventionally, reference data is attached incrementally at various stages in the life cycle of a financial transaction, either by the selection or input of such information by a human being, by looking up information on a computer file, if it is being entered for the first time, or through computerized access to previously prepared directories and/or financial transactions as when one had previously bought a stock and then prepares to sell it. Reference data occurs beginning in pre-trade assembly through to final settlement and payment.

The closing price is an example of reference data.

The current practice of acquiring, cleansing and storing reference data is to disassemble by manual means the elemental details present in a prospectus, offering memorandum, financial event announcement, incorporation or business organizational documents, ISDA master agreement, and other such paper documents. For example for a financial event announcement i.e. a tender offer, a merger, a dividend announcement, in this instance sent as a press release or transmitted as text as shown in Table 1, the text must be parsed manually and placed in formatted context for input to a computer.

TABLE 1
Unstructured Corporate Event Notification

OPT:01:”ELECTRONIC DATA SYSTEM CORPORATION”
UPDTEXT:6432511::#:0099: “SMK INFORMATION SERVICES”
EXTENDED THE OFFER TO PURCHASE SHARES OF ELEC-
TRONIC DATA COMMON STOCK FROM HOLDERS OF 99
OR FEWER SHARES HELD AS OF RECORD DATE SEP.
20, 2002, UNTIL SEP. 18, 2003, TERMS: HOLDERS WILL
RECEIVE CASH AT A RATE TO BE DETERMINED AT THE
CLOSE OF BUSINESS ON THE DATE OF TRANSFER, LESS A
PROCESSING FEE OF $1.50 PER SHARE: THE OFFER WILL
EXPIRE ON JUL. 18, 2003 (05:00 PM EDT). THERE IS NO PRO-
TECT PERIOD OR WITHDRAWAL PRIVILEGE AVAILABLE.
NOTE: HOLDERS MAY PURCHASE ADDITIONAL SHARES
TO REACH 100 AT A DEPOSIT PRICE TO BE DETERMINED,
PLUS A $1.50 PER SHARE PROCESSING FEE. THE OFFER IS
NOT REGISTERED WITH THE SEC. A MAXIMUM NUMBER
OF 10,000 SHARES PER WEEK WILL BE ACCEPTED ON A
FIRST COME, FIRST SERVE BASIS

This process is performed by a myriad of commercial data vendors as well as directly by financial institutions. In many instances multiple interpretations of what is assumed to be the same data is created. These multiple sources are bought by financial institutions from these vendors, often in proprietary formats and inconsistent identification, and matched within a financial institution to determine discrepancies in order to create a golden copy. Because there are multiple identifiers for the same security or business an extensive mapping exercise is required within each financial institution or through commercial mapping services to conform a single representation of the elements of each security or business, or financial event relating to either.

Reference prices for some non-exchange traded instruments are aggregated and distributed by their dealer associations, others have no central mechanism for aggregation and are either left to individual firms “calling around” to get dealers' prices, or left to entrepreneurs to build an aggregation and distribution service. Still other financial instruments, which either trade infrequently, or are not expected to trade at all, are priced through formula. Municipal bonds and over-the-counter derivatives are examples, requiring such reference data as credit ratings, historical prices, calendar data, etc., as inputs to these calculations.

Conventionally, reference data can be accessed via each business's processing application so as to incorporate the required reference data according to the specific business rules for the transaction to be represented as a stock trade, bond trade, futures trade, swap, credit derivative, etc. Sometimes the business application accesses its own data base of reference data, each financial institution usually having multiples of reference data bases. Sometimes there is a central store of reference data within the organization, sometimes an external store as when such information is outsourced.

The problem, simply stated is that each financial institution, each separate business unit within a financial institutions and/or each supply chain intermediary has independently sourced, stored and applied reference data to their own copy(s) of their individual or master inventory and counterparty data bases. When this is applied to the variable components of a financial transaction (i.e. transaction specific data such as quantity and transaction price), and an attempt made to match, identically, the details sent by the counterparties and supply chain participants in order to accept and pay for the transaction, significant failures in matching occurs as explained above.

Conventionally, various parties attempted to collect and/or rationalize the reference data after it was in use.

In contrast, CCDM 1200 is either the source of reference data, or receives the reference data immediately after its creation. In other words, prior art solutions for reference data employed a back-end approach, whereas CCDM 1200 employs a front-end approach.

In some embodiments, CCDM 1200 reformats data received from external parties into an internal storage format in which the data is associated with metadata. The reformatting process is sometimes referred to as “normalizing” the data. Metadata is informational data about content data, that is, informational data indicating what the content data means.

Extensible markup language (XML) schemes are well-known for financial data, including: Extensible Business Reporting Language (XBRL), Extensible Financial Reporting Markup Language (XFRML), Financial Information Exchange Markup Language (FIXML), Financial Products (Derivatives) Markup Language (fpML), Fixed Income Markup Language (FinXML), Investment Research Markup Language (IRML), Mortgage Bankers Association of America (MISMO XML), Market Data Definition Language (MDDL), Open Financial Exchange (OFX), Mortgage Industry Architecture (MIXA), Society for Worldwide International Financial Transactions Markup Language (SWIFTML).

A typical XML message format is shown in Table 2.

TABLE 2

```
<Counterparty>
  <Type>Institution</Type.
  <Name>”ABC Financial”</Name>
  <Identificationnumber>999-99-9999</Identificationnumber>
  <Addressline1>1313 Quincy Avenue</Addressline1>
  <Cityormunicipality>Boston</Cityormunicipality>
  <Stateorprovince>MA</Stateorprovince>
  <Ziporpostalcode>12345</Ziporpostalcode>
</Counterparty>
```

Examples of markup language terms are: <Name> and </Name>.

Many schemes exist for describing financial data. For example, the date “Sep. 20, 2001” is represented in different schemes as follows:
FIX syntax 75=20010920
FIXML syntax <TradeDate>20010920</TradeDate>

SWIFT 15022 syntax 98A::TRAD//20010920 FIG. 14 is a block diagram showing the logical operation of CCDM 1200.

CCDM 1200 operates as a utility for the financial industry.

CCDM 1200 comprises at least one general purpose computer, including memory, storage, data transmission, displays and other peripherals so as to operate as described herein. The equipment used for CCDM 1200 is conventional and various forms and configurations thereof are well-known to those of ordinary skill in the art.

CCDM 1200 is adapted to receive financial transaction data, store it, possibly reformat it, and retransmit it as part of its data feed. Generally, CCDM 1200 is concerned with commoditized data, rather than the proprietary high value analytic data sold by various data vendors. Dynamic data source 1245 and static data source 1250 each provide data to CCDM 120. In turn, CCDM 1200 provides dynamic and/or static data feed(s) to data consumers 1255. Note that sources of one type of data may be consumers of another type of data.

Fix Protocol Ltd created the Financial Information Exchange (FIX) protocol to standardize the communication of pre-trade and trade information. Since 1995 it has allowed counterparties and supply chain participants in capital market transactions to communicate electronically such information as indications of trading interest, placement of orders, receipt of executions, and the allocation and confirmation of trades for delivery and payment.

In some embodiments, CCDM 1200 generates its data feeds with incorporated metadata, such as a markup language.

Historically, data feeds have used the position of information to indicate its meaning; this opens the door to errors. It is better practice to associate metadata with the data, greatly reducing the chance of errors.

CCDM 1200 is further adapted to receive inquiries and respond thereto. Inquiries are either standing inquiries or one-time inquiries. A standing inquiry persists until it is cancelled and usually results in multiple responses over time from CCDM 1200. A one-time inquiry results in one response from CCDM 1200. Inquirer 1270 submits an inquiry to CCDM 1200, and CCDM 1200 responds thereto.

CCDM 1200 is also adapted to receive requests for error reimbursement for errors relating to the data distributed by CCDM 1200. As described below, the error activity is used in an internal risk management process to adjust the reserve capital for CCDM 1200. Error claimant 1265 submits an error reimbursement request, and CCDM 1200 responds thereto.

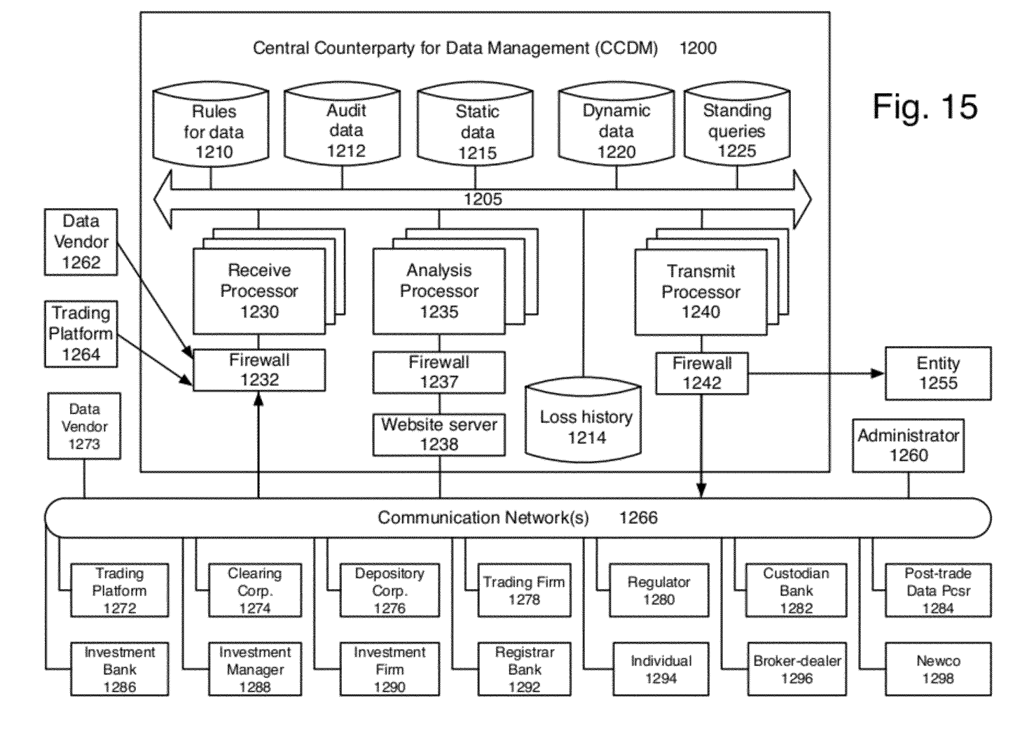

FIG. 15 is a block diagram showing a hardware and communication configuration for CCDM 1200.

CCDM 1200 includes high speed data bus 1205 enabling its internal modules to communicate with each other at high speed. In some cases, CCDM 1200 has computers located in different cities, and high speed data bus 1205 may be configured to bridge between the computers located in different cities.

CCDM 1200 includes rules data 1210, audit data 1212, loss history data 1214, static data 1215, dynamic data 1220 and standing queries 1225. The data maintained by CCDM 1200 is sometimes referred to as its data pool. The data for CCDM 1200 is discussed further below.

Loss history data 1214 includes problems for which CCDM 1200 provided error reimbursement, and problems for which CCDM 1200 did not provide error reimbursement. Loss history data 1214 includes the occurrence, frequency, reason and resolution of mismatched pre-trade and post-trade financial transactions.

Vendor Data Pools are of special interest as they can be a source of inconsistent and incorrect information as the information may be obtained from multiple sources, each different from the other. Such errors can occur for valuation prices, in financial event data, and in business entities and their legal hierarchies. This can lead to different valuations for the same financial instrument, different payments for an asset that has accrued a dividend, and in different reporting aggregations of a business' credit limit or risk exposure by using erroneous legal entity identities or associations.

CCDM 1200 acquires inconsistent, perhaps incorrect reference data from such Vendor Data Pools, from governments and regulators, from financial institutions (i.e. exchanges, clearing houses, settlement facilities, securities depositories, electronic dealers, electronic trading networks, national numbering associations, accredited trade associations, etc.) and from regulated electronic distributors of reference and market data such as Securities Information Providers (US) and Multilateral Trading Facilities (EC), and using its data rules 1210, eliminates or reduces the inconsistency in the data prior to storing it in its own data pool.

In particular, CCDM 1200 automatically associates metadata with data received from data vendors. The metadata enables disparate data to be understood as disparate, and further enables commensurate data to be understood as commensurate. For instance, a price could appear different from different data vendors, but once currency conversion is considered, the price becomes commensurate across data vendors.

CCDM 1200 automatically stores the reference data matched with a U3id, reducing opportunities for error. For instance, CCDM 1200 generates a U3id for each corporate action, and maintains, in dynamic data 1220, a history of corporate actions that can be indexed using their U3id.

CCDM 1200 matches reference data contained within pre-trade configured financial transactions received from broker-dealers, asset managers and custodians to the aggregated plurality of reference data stored on data storage devices. The matching comprises constructing an index from the U3id reference data contained within the pre-trade configured financial transactions, and accessing the previously stored reference data, and matching the retrieved reference data to the reference data contained within the pre-trade configured financial transactions.

Where the U3id data does not match no retrieval will be available and CCDM 1200 stores an indicator that no match has occurred. Where no match has occurred, the computer processing modules will attempt to match each component of the plurality of reference data stored on the computer storage devices, based upon a predetermined sequence of the individual reference data elements contained in the pre-trade configured financial transactions (i.e. financial instrument ID, Symbol, market, et al)

Where matches do occur a tag number will be calculated and logged within the CCDM Data Pool, and the validated, matched pre-trade configured transactions with all requested and validated reference data will be routed to the originator of the transaction.

CCDM 1200 distributes a notice of mismatched pre-trade configured financial transactions back to broker-dealers, asset managers, custodians and others, in accordance with rules provided by such entities.

CCDM 1200 enables broker-dealers, asset managers, custodians and others to communicate with computer storage devices a sub set of reference data now contained within post-trade financial transactions

Message profiles (standing queries) are created by broker-dealers, asset managers, custodians, and other users and commercial redistributors of reference data, for determining general or specific content, as contained within post-trade financial transactions, to be matched to computer storage devices storing a plurality of reference data.

Where U3id matches do occur CCDM 1200 calculates a tag number and logs it, and sends the validated, matched post-trade transaction with all requested and validated reference data to the originator of the transaction.

Where the data does not match no retrieval will be available and CCDM 1200 stores an indicator that no match has occurred. Where no match has occurred, CCDM 1200 attempts to match each component of the plurality of reference data stored on the computer storage devices, based upon a predetermined sequence of the individual reference data elements contained in the post-trade financial transactions i.e. financial instrument ID, client (business entity) ID, supply chain ID (clearing location ID, settlement depot ID), etc.

CCDM 1200 is usually embodied in a multi-processor configuration, where each processor is a general purpose computer configured to perform selected operations. CCDM 1200 includes one or more receive processors 1230, one or more analysis processors 1235 and one or more transmit processors 1240, each configured with suitable memory, storage and communications facilities to operate as described herein.

Receive processor 1230 is adapted to receive data, store the received data, and notify transmit processor 1240 that new data is available to be transmitted. External data is provided to receive processor 1230 via firewall 1232. External data may be provided to firewall 1232 via dedicated communication facilities, as is appropriate for high density data sources such as trading platform 1264 and data vendor 1262, which are instances of dynamic data source 1245 and static data source 1250 shown in FIG. 14. Firewall 1232 may also receive external data from public communications network 1266 such as the Internet, and from virtual private networks operating via public communications network 1266.

Public communications network 1266 includes wire line and wireless communications facilities, supports data transmission in clear text or encrypted form, and includes circuit-switched and packet switched communication channels.

Transmit processor 1240 is adapted to receive notifications from receive processor 1230 that data is available for transmission, and to transmit the data to data consumers 1255. The data may be included in the notification of its availability, may be sent directly from receive processor 1230, or may be retrieved from a database coupled to high speed data bus 1205. Transmission occurs via firewall 1242. Transmission may be via dedicated communication facilities, as is appropriate for a data feed, a high density stream of data, provided to entity 1255 such as a data vendor, a trading platform or a large trading firm. Transmission may alternatively be by public communications network 1266.

Analysis processor 1235 is adapted to receive queries and to respond thereto, generally guided by data rules 1210. Analysis processor 1235 is coupled to firewall 1237 that is in turn coupled to website server 1238 that is coupled to public communications network 1266.

Website server 1238 provides one or more web sites accessible through public communications network 1266. One portion of website server 1238 requires a password and sometimes additional authentication to access its pages. Another portion of website server 1238 responds to public, anonymous inquiries. Generally, website server 1238 has a predefined set of web pages that it serves to visitors, and is capable of dynamically creating web pages as needed during a dialog with visitors. Some web pages provide dynamic data in a streaming format. Website server 1238 operates according to a suitable protocol, such as hypertext transfer protocol.

Although only one instance of each of firewalls 1232, 1237, 1242 is shown, it will be understood that many instances may be provided, as is appropriate for the data volume. Each of firewalls 1232, 1237, 1242 includes at least one communication interface, and at least one processor, and further includes suitable memory and storage for operating as described herein.

The following external entities are shown as coupled to public communication network 1266, and thus are able to communicate with CCDM 1200:
trading platform 1272, corresponding to trading platform 51 of FIG. 1,
data vendor 1273,
clearing corporation 1274, corresponding to clearing corporation 70 of FIG. 1,
depository corporation 1276, corresponding to depository 65 of FIG. 1,
trading firm 1278, corresponding to firms 55 and 60 of FIG. 1,
regulator 1280, corresponding to regulator 30 of FIG. 1,
custodian bank 1282, corresponding to custodian bank 40 of FIG. 1,
financial industry post-trade data processor 1284, corresponding to financial industry post-trade processor 45 of FIG. 1,
investment bank 1286, corresponding to investment bank 25 of FIG. 1,
investment manager 1288, corresponding to investment manager 35 of FIG. 1,
investment firm 1290, such as a hedge fund,
registrar bank 1292, corresponding to registrar bank 20 of FIG. 1,
individual 1294,
broker-dealer 1296, and
Newco 1298, corresponding to Newco 10 of FIG. 1.
   These external entities, as appropriate, are instances of inquirer 1270 and error claimant 1265 of FIG. 14. In some cases, an external entity has sufficient volume to justify dedicated private line connections that are coupled to a suitable firewall of CCDM 1200.

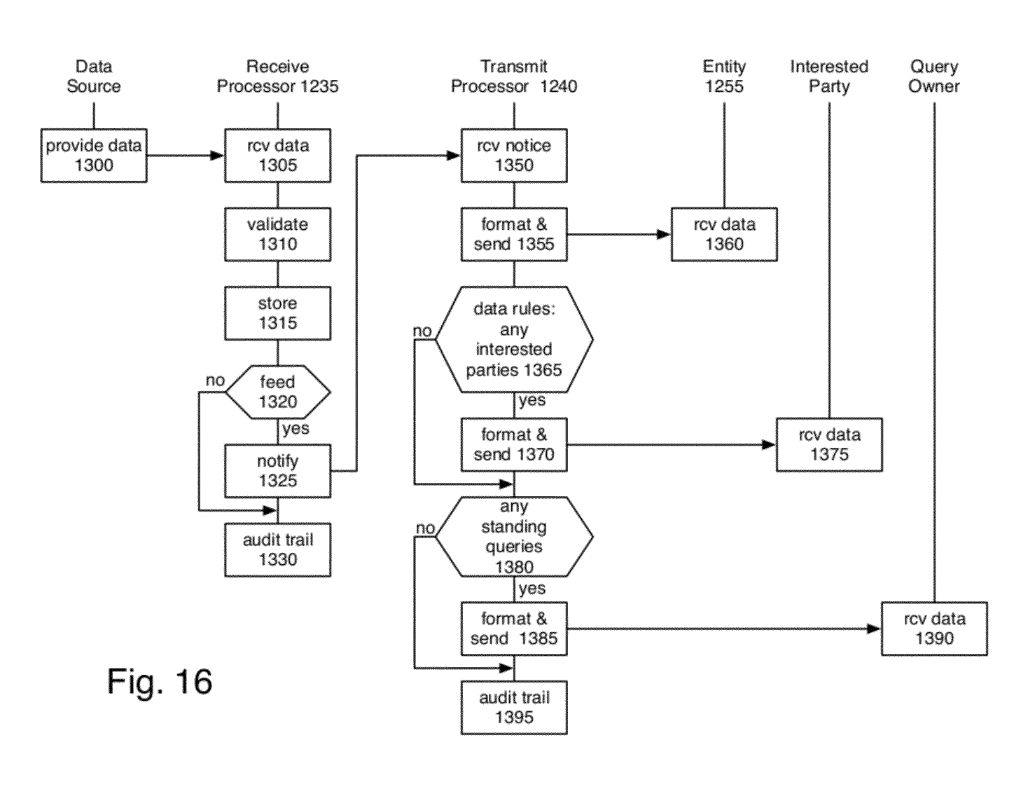

FIG. 16 is a flowchart showing how CCDM 1200 creates its data feeds.

At step 1300, a data source, such as data vendor 1262 or trading platform 1264, provides data to CCDM 1200. An instance of data is a securities trade execution report, including identification of the parties to the trade.

At step 1305, receive processor 1235 receives the data.

At step 1310, receive processor 1235 validates the data, that is, checks that its values are within reasonable bounds, and that the source of the data is authorized to submit this type of data to CCDM 1200. When receive processor 1235 is unable to validate the data, it is stored for later exception reporting and analysis (not shown).

Ideally, the data source provides the data in the internal format used by CCDM 1200, that is, with metadata tags. CCDM 1200 publishes an application programming interface (API) to assist data sources in providing data in the desired format. However, some data sources will simply provide data in their own internal format. Generally, CCDM 1200 uses a filter customized for each external data source that receives such data and automatically reformats it. However, the filter is not able to deal with all externally provided data, and when it cannot properly process the data, it writes an exception report for manual handling of the data.

At step 1315, receive processor 1235 stores the data in one of the data stores coupled to high speed data bus 1205.

At step 1320, receive processor 1235 checks whether this data is of a type suitable for one of the data feeds provided by CCDM 1200. For instance, data from a trading platform is usually intended for a data feed provided by CCDM 1200, whereas data from a data vendor relating to, say, a derivative security associated with a data feed security, is not intended for a data feed provided by CCDM 1200, rather, it is intended to be stored and used in responding to one-time queries. If the data is suitable for a CCDM data feed, processing continues at step 1325, otherwise, processing continues at step 1330.

At step 1325, receive processor 1235 sends a notification message to transmit processor 1240 that data is available for transmission.

At step 1330, receive processor 1235 writes an audit trail record corresponding to the event of receiving data.

At step 1350, transmit processor 1240 receives the notification of new data from receive processor 1235.

At step 1355, transmit processor 1240 format the data for one or more data feeds, and sends the data to entities that have subscribed to the data feed. For instance, one data feed may be for trades from a predefined set of trading platforms, another data feed may be for quotes relating to certain securities, and so on.

At step 1360, the entity subscribing to the data feed receives the just transmitted data.

At step 1365, transmit processor 1240 checks its data rules to see if there are any interested parties, and if so, at step 1370, sends the data to them. For example, it is assumed that a company is interested in all data related to itself. One instance of a standing rule is “send data about Newco to Newco”, which may be overridden by Newco. Another instance of a data rule is “when an investment firm associated with an investment manager changes its custodian bank, send a notice of the change to the investment manager”. A purpose of data rules is to automate a portion of back-office administrative functions.

In some embodiments, a data rule is implemented as a standing query with no expiration date.

At step 1375, the interested party receives the data transmitted to it.

At step 1380, transmit processor 1240 checks whether there are any standing queries. Generally, a standing query is submitted via website server 1238 using a structured interface such as drop-down menus, checking data for reasonable values, and so on. In some cases, standing queries are submitted by administrator 1260. In other cases, analysis processor 1235 generates standing queries according to rules data 1210. If so, at step 1385, transmit processor 1240 formats the new data to be responsive to the standing query and sends it to the query owner.

The standing queries may consist of data arrayed as XML schemas, XML DTD's, SQL queries, Java scripts, and other content and/or computational profiling arrangements, both standard and proprietary.

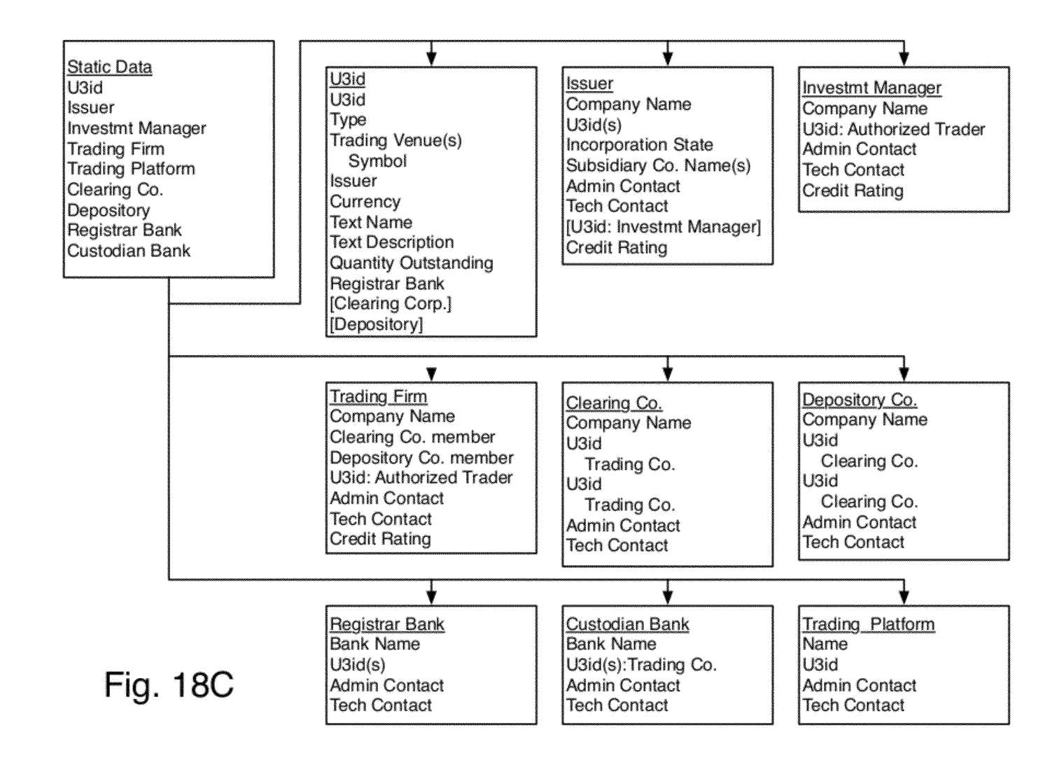

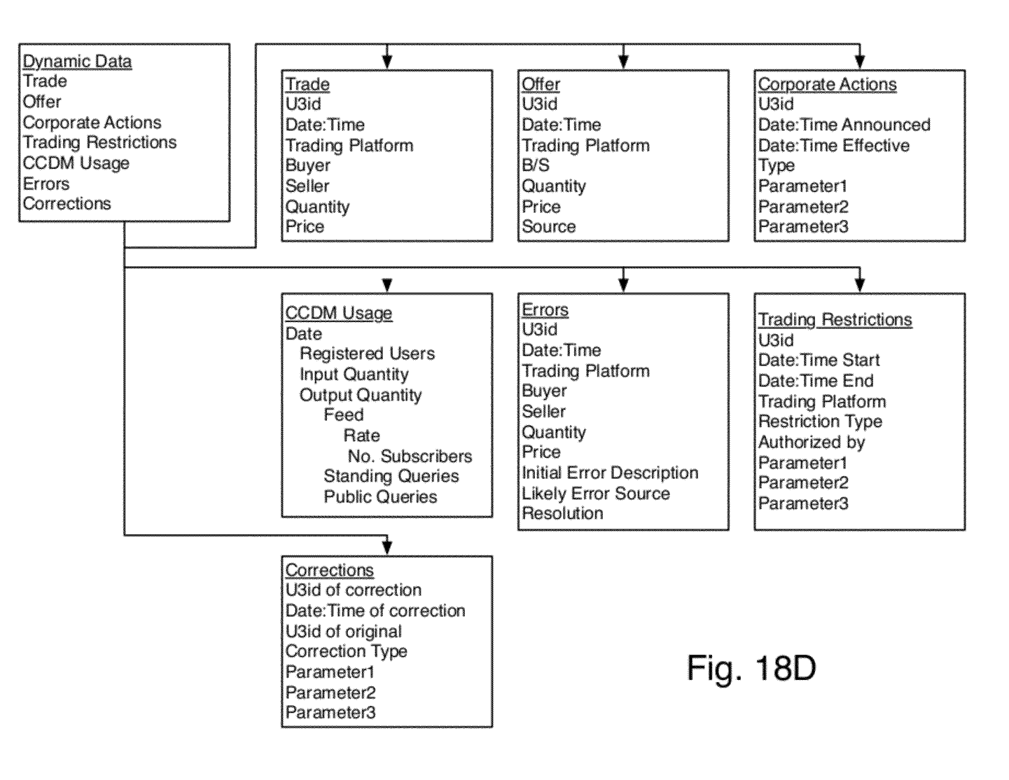

FIG. 18B shows some of the information maintained for each standing query at CCDM 1200. Examples of the “Query Body” are as follows:
all quotes for XYZ common stock
all trades for XYZ common stock at trading platforms TP100, TP200, TP300
all corporate actions for NewCo
hourly, at (:59) minutes after the hour, volume of XYZ common stock at all trading platforms relative to volume of all put options for XYZ common stock at all trading platforms
all trades for all stocks and bonds of NewCo and its subsidiaries at all trading platforms in US, Canada and EU.

The last two queries are difficult to express in conventionally available systems. In particular, conventional data vendors put the responsibility of identifying corporate subsidiaries on inquirers.

As a new trade report is received, transmit processor computes the result (formats it) and distributes it.

At step 1390, the query owner receives the standing data.

At step 1395, transmit processor writes an audit trail record reflecting its transmission(s) of the new data.

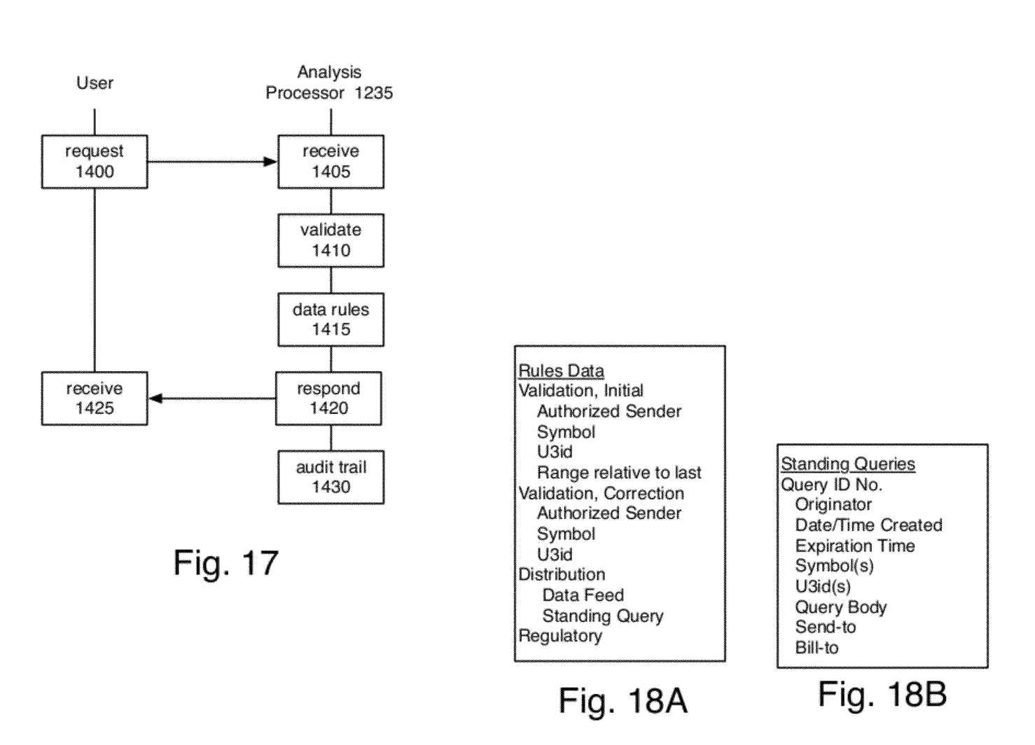

FIG. 17 is a flowchart showing query processing in CCDM 1200.

At step 1400, a user sends a query to CCDM 1200. One instance of a query is a request for trades in a security that occurred in a particular time interval. A further instance of a query is a request for a U3id associated with a security. Another instance of a query is a request for error reimbursement.

In some embodiments, queries are created using web pages at a web site provided by web server 1238 drop-down menus, radio button and so on, ensuring that the query is likely to be in proper form. In other embodiments, queries are created using a query language and submitted via an application programming interface from the querying entity's computer. In other embodiments, queries are provided in a natural language format and CCDM 1200 assists in converting natural language format to the internal format used in standing queries database 1225.

At step 1405, analysis processor 1235 receives the query.

At step 1410, analysis processor 1235 validates the query, including whether the query owner is authorized to inquire about this data, and whether the query syntax and content is correct.

At step 1415, analysis processor 1235 applies data rules 1210 to generate a response to the query. In some cases, analysis processor 1235 refers the query to an administrator at CCDM 1200. For instance, decisions on error reimbursement must be manually approved by a CCDM administrator. Many requests for error reimbursement also require manual intervention by a CCDM administrator, to resolve circumstances contributing to the error. Some requests for error reimbursement can be resolved automatically, such as errors due to a computer malfunction by the CCDM, when the computer malfunction was previously known to the CCDM.

At step 1420, analysis processor 1235 sends the response to the query owner.

At step 1425, the user who provided the query receives a response thereto.

At step 1430, analysis processor 1235 writes an audit trail record reflecting the query and its response.

FIGS. 18A-18D are diagrams showing data organization in a CCDM. The data in FIGS. 18A-18D is only a subset of actual data. Importantly, the unique, unambiguous and universal identifier (U3id) generated by CCDM 1200 is included in most records, enabling data to be cross-referenced and properly aggregated.

FIG. 18D includes corporate actions. Types of corporate actions include share redemptions, rights offering, reorganization, bankruptcy, proxy conversion, periodic payment, merger, acquisition, rights warrants, dividends and so on. The terms “parameter1”, “parameter2”, and so on have different meanings depending on the type of corporate action. In some embodiments, the values for the parameters are associated with metadata describing the type of parameter.

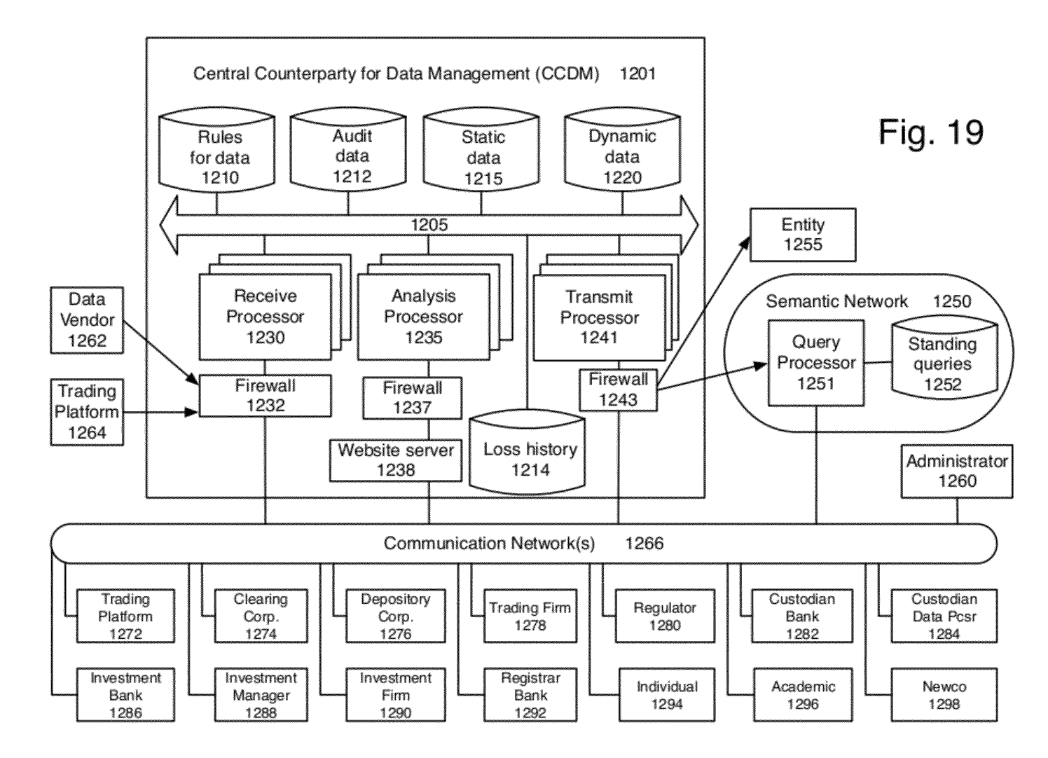

FIG. 19 shows a second embodiment of the central counterparty for data management, CCDM 1201.

FIG. 19 is similar to FIG. 15, and for brevity, only differences will be discussed.

In FIG. 19, semantic network 1250 is provided. Standing queries are stored in standing queries database 1252, which may be a single data storage device or an array of data storage device, in semantic network 1250. Query processor 1251 is a single processor or a plurality of coupled processors, resides in semantic network 1250, and serves to compare data received from transmit processor 1241 with the standing queries, and to provide responses to the query owners. Semantic network 1250 is capable of content routing. Content-based routing is explained in U.S. Patent Publication No. 2002/0150093 (Ott), the disclosure of which is hereby incorporated by reference in its entirety.

CCDM 1201 uses an interactive network software application supported by specialized scalable content routers (query processor 1251) with embedded XML (or other) schemas representing all potential reference data content requests of all assembled financial transactions. Query processor 1251, deployed within semantic network 1250 overlaid on communication network 1266, includes an algorithm that allows for content selection, content routing and load balancing. The router software allows for the network to select the path that a message will follow to its destination through setting of user controlled profiles within the router which interrogating the content of an XML or other schema defined message. The user need only send his/her profile, in this case in the form of a request for a specific reference data set to the nearest router. The routers talk to each other and exchanges aggregated profiles. A message/packet is distributed through the network because each router knows the interest of its neighbor routers and they know their neighbors' profile. The software dynamically adjusts the filtering between any two contiguous nodes in the network thus allowing for dynamic load balancing and scaling. Packets may travel through multiple routers and each router makes a decision on what to do with it. The routers operate within a multicast network. A message will be delivered to multiple users if it matches multiple profiles.

The matching of user defined profiles to the message content is done by the algorithm which operates on the entire schema for the message resident in the specialized router software. It matches an “interest profile” (standing query), that is a subset of the schema, as represented by a user controlling the selection as specified in the same schema as the message. The message that passes the query will be forwarded, otherwise not.

A forwarded message represents a validated string of reference data and this invention will calculate a unique encrypted tag number (in one such embodiment Tag No.=Modulus 10/11 calculation+random number), combining the bit values of reference data content with a random number, and place the resulting number in a tagged field. It will then be logged and carried along with the transaction for audit purposes in validating a warranty request on any failed transactions. Also note, that the network is schema agnostic. If end users agree on a new schema, it can be implemented immediately; nothing needs to be changed inside the network.

The router software separates a message into a header and an optional “payload”. If the message is unstructured, the header contains a content descriptor; if the message is, for example, a structured XML message it can go fully into the header. The distinction between header and payload simply defines what the router uses for its routing decision.

The benefit of this solution is that the heavy lifting of selection of data is done in the network where large bandwidth abounds vs. maintaining user profiles at a centralized server as in FIG. 15. Also by raising the abstraction level of what a network can do, the cost of building and maintaining applications are greatly reduced. Previously a network could only deliver to a specific terminal address. If required to build a data centric solution, multiple layers of middle-ware are required on top of the network. This solution allows data abstraction within the network and routing directly to the application.

Secondly, in an overnight or periodic updating mode, such information as closing (valuation) prices (for example every financial instrument master record is updated) gets stored at the central store of all reference data (the CCDM Data Pool) as well as in the downstream distributed data stores specific to each organization.

Finally, the central store of reference data at the CCDM Data Pool is both dynamically and periodically being updated by various suppliers and creators of the basic information of reference data. For example, a notification is received that on a certain date, Hewlett Packard will acquire Compaq, or that as of a specific date the holders of stock in Company X will now have twice the number of shares due to a 100% stock dividend, or that one dealer went out of business, or that a new futures exchange is starting up, or a new company is assigned a trading symbol and ID number, or that an exchange will be closed on a certain date, etc. Further, internally contained reference data triggers events such as in a financial instruments master record containing information as to a conversion date and conversion rate for a bond, the next reset date for a swap, or the approaching ex-date for a stock dividend. All such changes will be broadcast to also find its way downstream to the distributed data stores. Over time, the separate downstream stores of reference data will be eliminated as more business application are written or modified to access the central store of reference data (the CCDM Data Pool) and the central store of information will be distributed across the network.

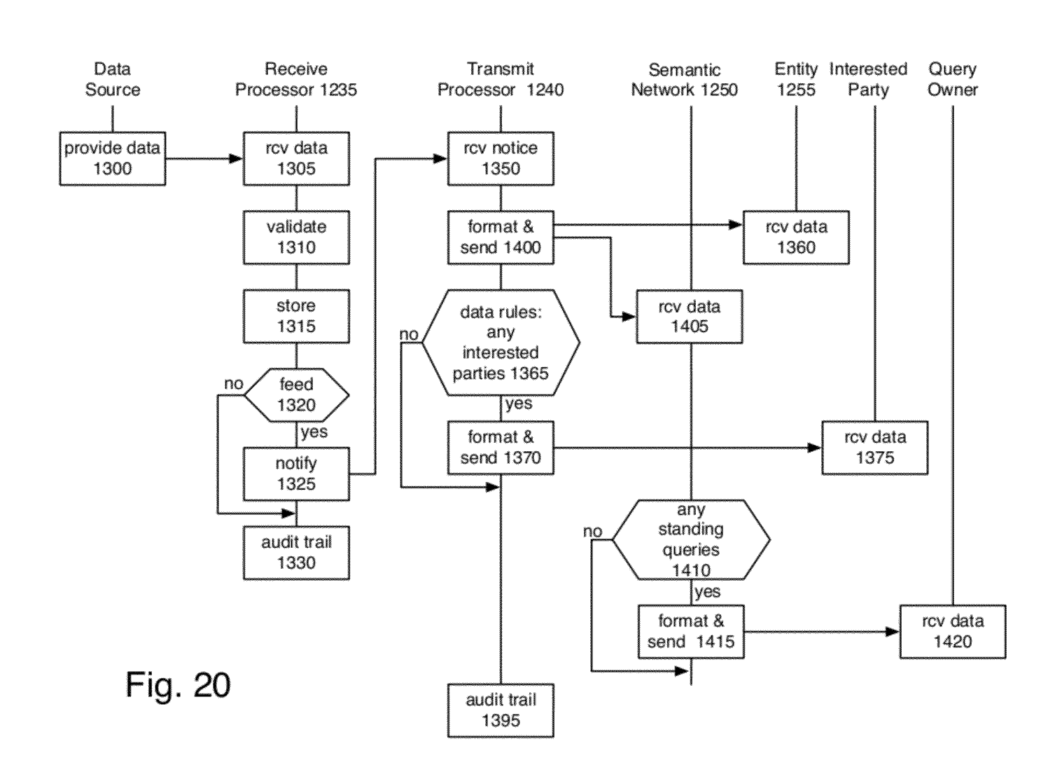

FIG. 20 is a flowchart showing data processing in the embodiment of FIG. 19.

FIG. 20 is similar to FIG. 16, and for brevity, only differences will be discussed.

At step 1400, transmit processor 1240 of CCDM 1201 sends its data feed to semantic network 1250, in addition to entity 1255.

At step 1405, semantic network 1255 receives the data.

At step 1410, semantic network 1250 checks whether there are any standing queries relevant to the data. If so, at step 1415, semantic network 1250 generates a response and sends it to the query owner.

At step 1420, the query owner receives the response from semantic network 1250.

Note that transmit processor does not perform steps 1380-1385, shown in FIG. 16.

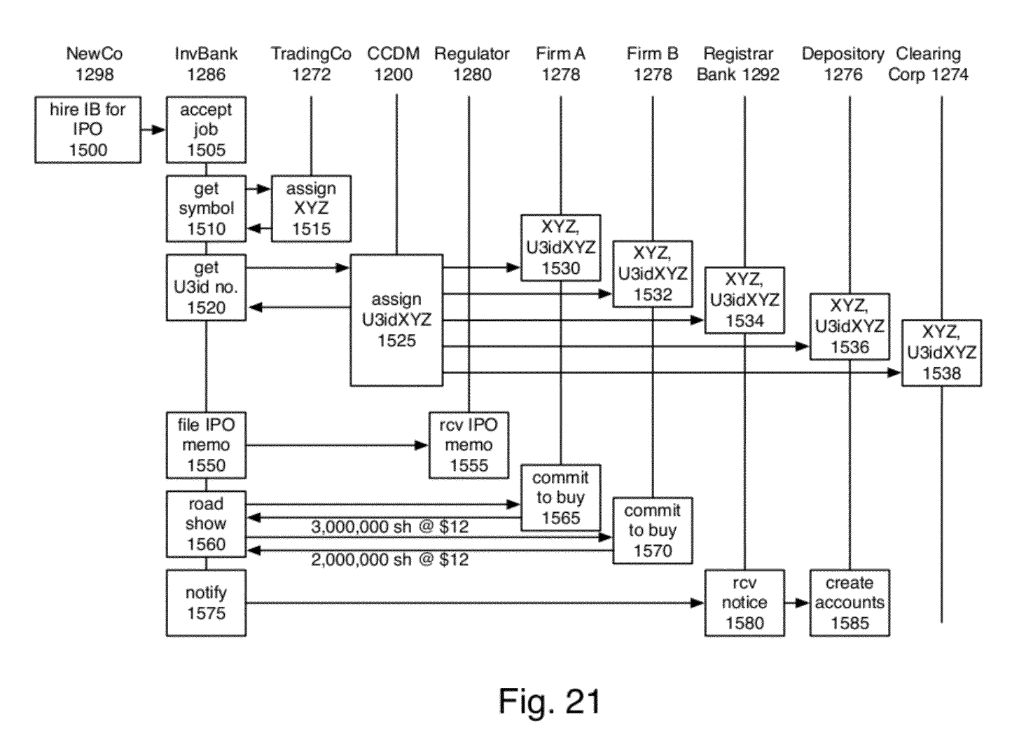

FIG. 21 is a flowchart showing pre-trading activity with CCDM 1200.

A prospectus, offering memorandum, financial event announcement, incorporation or business organizational documents, ISDA master agreement, and other such paper document is conceived and developed at the origins of a business formation, financial transaction and/or financial event. It is embodied in a digital document, compatible with standard computer machine processed formats. It is subsequently transformed by standard mapping software into an extensible markup language (XML) format. This format, in the some embodiments is XBRL. Using a predesigned XBRL taxonomy the data elements are transformed through mapping software from human readable (word processed) data into machine readable content at an elemental level. The data in transformed XBRL format is tagged with meaningful data names and with the first instance of the tag i.e.“<BusinessEntityID>”, “<FinancialEventID>” “<FinancialInstrumentID>”, etc, and then again the second instance of the identical tag, such tag being unique, unambiguous, consistent and universal. The actual Business Entity Identifier, Financial Event Identifier and Financial Instrument Identifier is a number of variable length assigned by the business entity or its designated agent after applying for such identity through a global registry, which is the designated assigner of such identities. Such number, also unique, unambiguous, consistent and universal is placed within the first and second instance of the tag.

The tagged data is transmitted via communication lines to the central storage device of the CCDM 1200 where it is filed in a computer storage medium with other information similarly sourced and communicated. The identity keys are linked to unique, unambiguous and universal descriptions in human readable language for describing the instrument, business entity, and financial event in standardized abbreviated form. It is further linked to a symbol. In similar manner information about supply chain participants, legal business hierarchies of the business entity, and their role in the supply chain is further described in unique, unambiguous and universal manner through other coding conventions that is part of this invention. The identification numbers are used as the storage key by the computer storage device for later retrieval by other component systems and methods of this invention.

Additional information will be maintained in a computer storage device of CCDM 1200 Data Pool connected by a communication device to the CCDM's Registry linked by identity keys and/or symbol. Such information as the full, official description of the financial instrument, its terms and conditions, its trading venue(s) and/or listing markets, it's currencies of trade, its place and currency of settlement and other such data attributes of the financial instrument will be stored as reference data in CCDM 1200 Data Pool. Similar fuller information about business entities and their legal hierarchies, and financial events and their relationship to financial instruments and business entities are also stored in CCDM 1200 Data Pool. Other data pools are maintained by commercial redistributors of reference data and linked to CCDM 1200 Registry in CCDM 1200 Data Pool to synchronize their identifiers so they can maintain all manner of supplemental data, including to be made available to all others who have synchronized their data identifiers to the CCDM 1200 Registry.

The conventional situations discussed above will now be revisited with CCDM 1200 in use.

FIG. 21 is similar to FIG. 2, and for brevity, only differences will be discussed.

At step 1520, investment banker 1286 requests a U3id for a new securities issue, providing the symbol for the new security obtained from trading platform 1272, and the security name, to CCDM 1200.

At step 1525, CCDM 1200 provides the new U3id. Also, CCDM 1200 distributes the new U3id to all parties who have indicated interest in being informed of new U3ids, namely, Firm A, Firm B, Registrar Bank 1292, depository 1276 and clearing corporation 1274. Other parties can query CCDM 1200 to obtain the new U3id, once they are aware of the symbol.

At step 1530, Firm A receives the U3id, symbol and security name.

At step 1532, Firm B receives the U3id, symbol and security name.

At step 1534, registrar bank 1292 receives the U3id, symbol and security name.

At step 1536, depository 1276 receives the U3id, symbol and security name.

At step 1538, clearing corporation 1274 receives the U3id, symbol and security name.

Having CCDM 1200 be the source of U3id, and able to provide it in a variety of ways to a variety of data consumers, eliminates prior art errors due to manual entry, confusion with other securities, and so on.

It will be recalled that FIG. 5 illustrates an error in which clearing corporation 70 has stored the wrong company name for the identifier. The error illustrated in FIG. 5 is highly unlikely to occur when CCDM 1200 is in use, because CCDM 1200 is the sole source of U3id identifiers, and distributes the U3id with the proper company name. Clearing corporation 1274 receives this information automatically, as shown at FIG. 21 step 1538, and so is highly unlikely to err in associating the company name with its U3id.

It will be recalled that FIG. 6 illustrates an error in which clearing corporation 70 has mistakenly determined that the ex-dividend date for XYZ is T+4, whereas the correct dividend date is T+3. When using CCDM 1200, this error is avoided, because the announcement of the dividend date is distributed on a data feed from CCDM 1200 along with computer readable metadata identifying the correct ex-dividend date, as shown in FIG. 16 step 1360, avoiding the manual errors that occur when a clerk tries to convert the conventional notice shown in Table 1 to digital form.

It will be recalled that FIG. 9 illustrates an error in which investment manager 35 has the wrong custodian bank associated with mutual funds AA, BB and CC.

At a minimum, when using CCDM 1200, investment manager 1288 can quickly query CCDM 1200 for the correct custodian bank and send revised notices, without having to call its client.

In an improved scenario, investment manager 1288, as an interested party, automatically receives a notice of a change in custodian bank, as shown in FIG. 16 step 1375. Since CCDM 1200 provides notifications in a uniform manner, it is more likely than investment manager 1288, even if a small entity, will be configured to properly receive and apply such notices.

In a further improved scenario, third parties make software available to investment manager 1288 that automatically records and applies the notices from CCDM 1200, so that investment manager 1288 always sends its allocate message to the current custodian bank, entirely eliminating the error shown in FIG. 9. In the conventional situation, each client of investment manager 1288 can have its own data formats, so it is difficult to automate reception of routine messages. In contrast, using CCDM 1200 as an industry wide utility makes it cost-effective for software providers to offer programs that automatically support investment manager 1288.

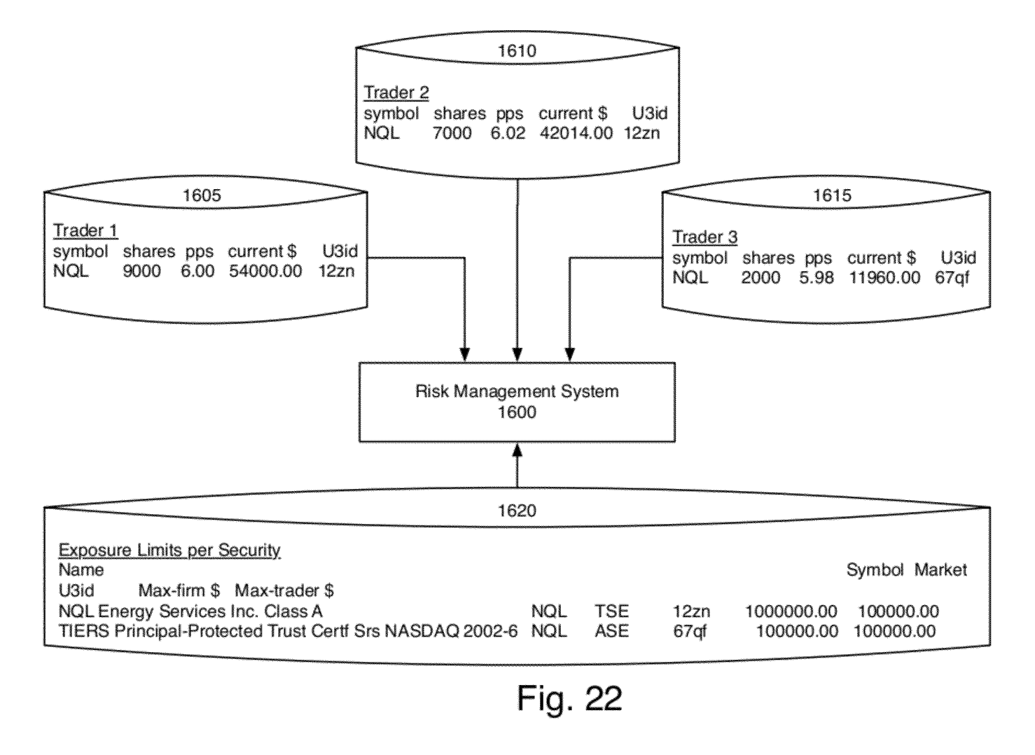

FIG. 22 is a flowchart showing intra-firm data aggregation when CCDM 1200 serves as a pre-trade data source. FIG. 22 corresponds to FIG. 10, and for brevity, only differences will be discussed. In particular, note that in FIG. 22, each record has an additional field for the U3id, which enables risk management system 1600 to properly distinguish which exposure limit applies to each trade for the symbol NQL. Accordingly, risk management system 1600 can properly carry out the intent of its creators, avoiding the prior art error where the firm was unknowingly overexposed, despite each trader being within its per-trader exposure limit.

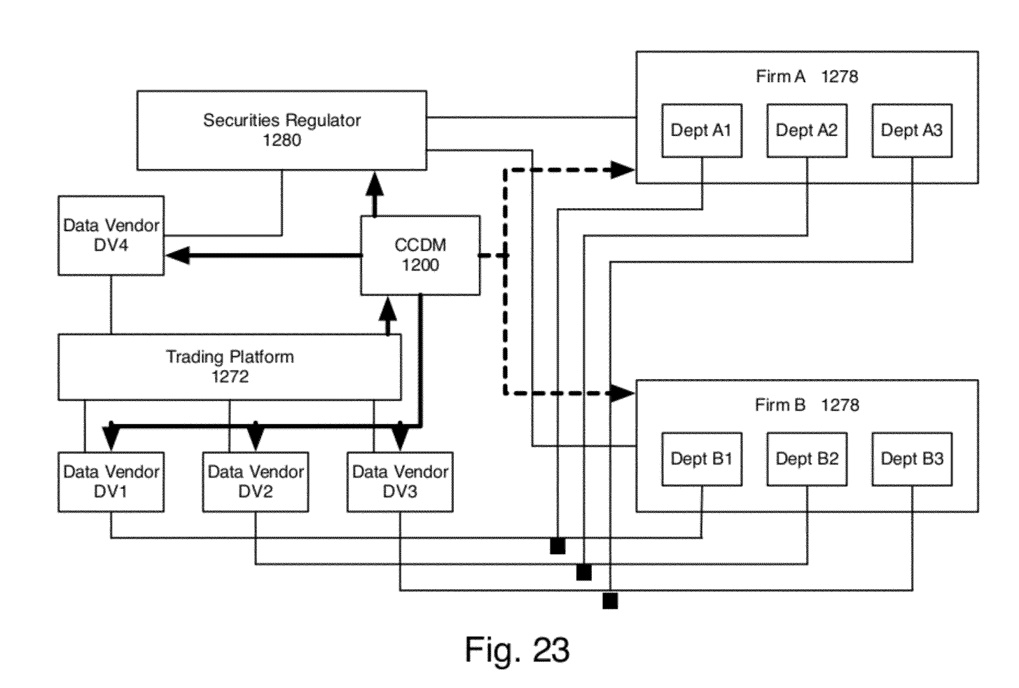

FIG. 23 is a block diagram showing another logical configuration with CCDM 1200. FIG. 23 corresponds to FIG. 11, and for brevity, only differences will be discussed. As shown by the bold lines in FIG. 23, trading platform 1272 supplies its data to CCDM 1200. CCDM 1200 reformats the data from trading platform as needed, and supplies the reformatted data from trading platform 1272 to each of the four data vendors. The data vendors then add their custom analytics and supply data feeds to different departments of Firms A and B, and to securities regulator 1280. As shown by the dotted lines in FIG. 23, Firms A and B may also get trade data directly from CCDM 1200.

It will be recalled that FIG. 12 illustrates a prior art inter-firm data aggregation problem caused by data vendors supplying respectively different closing prices for the same security. This problem is eliminated through use of CCDM 1200. Thus, the data from the various firms are commensurate, enabling securities regulator 1280 to do a better job, as she has a more accurate picture of what is happening.

CCDM 1200 is useful for eliminating or attenuating other data errors that occur in the financial industry, in addition to the errors discussed above.

Determining the correct amount of reserve capital for CCDM 1200 will now be discussed.

CCDM 1200 guarantees to its users that their trades will not fail to match due to problems with data from CCDM 1200. More specifically, if an error does occur based on properly using data from CCDM 1200, CCDM 1200 reimburses the customer for the costs associated with the error. The costs include covering the mismatched trade, or the difference between the actual sale price and the correct sale price.

Matching errors are not expected, just errors that are created through errors, omissions, breaches of security, computer failure, clerical faults, etc. within the CCDM and externally through weather and catastrophic events such as hurricanes, floods, fires, etc. The data errors that occur conventionally, i.e., errors due to improper reference data, failed transactions because a proprietary identifier was created for a security, a valuation was wrong because a closing price was not recorded properly, are eliminated or mitigated by CCDM 1200. However, should errors occur the CCDM must be prepared to support the losses and thus must set aside capital for such improbable eventualities (unexpected losses). A client notifies CCDM 1200 that a transaction failed to be aggregated or matched and that the identifiers used came from CCDM 1200. These identifiers had to have been previously certified as U3 compliant for the CCDM to be involved. An investigation tracks back through audit data 1212.

As a risk mitigating infrastructure utility, CCDM 1200 adheres to international norms of capital for unexpected losses not covered by reserves, insurance, etc. CCDM 1200 determines the capital reserve for losses, also referred to as operational risk capital, using the Advanced Measurement Approach (AMA). CCDM 1200 is not the normal financial institution that the AMA is prescribed for.

Under the basic approach to modeling operational risk, really a collection of many different stochastic techniques, referred to as the loss distribution approach (LDA), banks estimate, for each business line/risk type cell, or group thereof, the likely distribution of operational risk losses over some future horizon (bank regulators require a one year period). The Value-at-Risk (VaR) and resulting capital charge from these calculations is based on a high percentile of the loss distribution (bank regulators require a 99.9% confidence level). This overall loss distribution is typically generated based on assumptions about the likely frequency and severity of operational risk loss events. In particular, LDA's usually involve estimating the shape of the distributions of both the number of loss events and the severity of individual events. These estimates may involve imposing specific distributional assumptions (i.e., a Poisson distribution for the number of loss events and a lognormal distribution for the severity of individual events) or deriving the distributions empirically through techniques such as boot-strapping and Monte Carlo simulation.

An overall capital charge may be based on the simple sum of the operational risk VaR for each business line/risk type combination which implicitly assumes perfect correlation of losses across these cells or by using other aggregation methods that recognize the risk-reducing impact of less-than-full correlation.

Presently, for operational risk there are several LDA methods being developed and no industry standard has yet emerged. Generally, an LDA model is a quantitative methodology for assigning dollar values to expected and unexpected losses.

The output of a typical LDA model consists of (1) The Expected Loss (EL), which is the average loss as calculated from the (cumulative) loss distribution, and (2) The Value at Risk (VaR), which summarizes the worst loss over a target horizon (one year) within a given confidence interval, e.g., 99.9 percent. The statistical accuracy of the VaR number depends on the number of data points and/or simulations. The more simulations or data points (loss history), the more accurate the result will be.

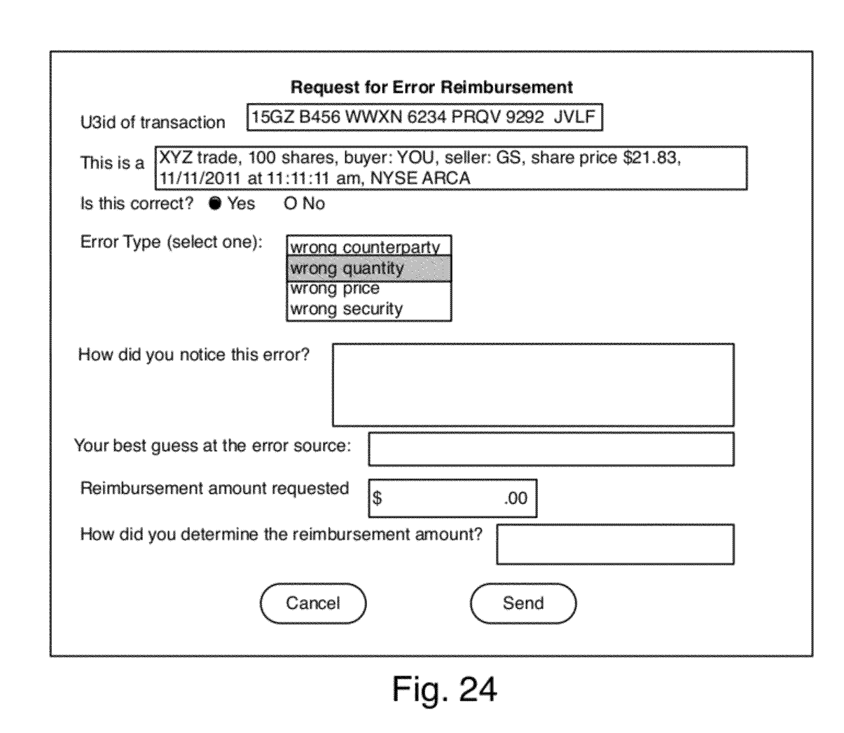

FIG. 24 is diagram of a screen display for claiming error reimbursement.

The error claimant goes to the website provided by website server 1238, signs in to their account using a password and possibly another identifier, such as a biometric or token, then selects “File a Claim for Error Reimbursement” from a menu of things that the claimant is authorized to do.

CCDM 1200 presents the claimant with a screen display for supplying information about their claim. The screen display asks for the U3id associated with the transaction. CCDM 1200 checks whether the claimant has a relationship to this transaction. If the claimant, or the claimant's employer, is not associated with the transaction, then CCDM 1200 will not proceed, so that the claimant will have to call customer service.

If the claimant is authorized to file a claim for this transaction, CCDM 1200 presents the claimant with the known transaction details. CCDM 1200 then provides a drop-down menu so that the claimant can identify the error. The screen display also has fields so that the claimant can explain how the error was noticed, their judgment as to the reason for the error, the amount of the claim, and how the amount was determined.

In some cases, CCDM 1200 knows of a situation that would result in the error, and can automatically confirm that this transaction was affected by the situation, and calculate the expected claim. If the requested claim is less than or equal to the expected claim, CCDM 1200 automatically suggests to an administrator that the reimbursement request be approved.

In other cases, CCDM 1200 is unable to automatically process the request, and provides it to an administrator for manual resolution. The administrator uses audit data 1212, static data 1215 and dynamic data 1220 to research the transaction, and may telephone or email the claimant for more information.

When the reimbursement request is approved, the error is added to loss history data 1214, and CCDM 1200 automatically provides funds to the account of the claimant, either directly or via transferring from the capital account for CCDM 1200 maintained at clearing corporation 1274.

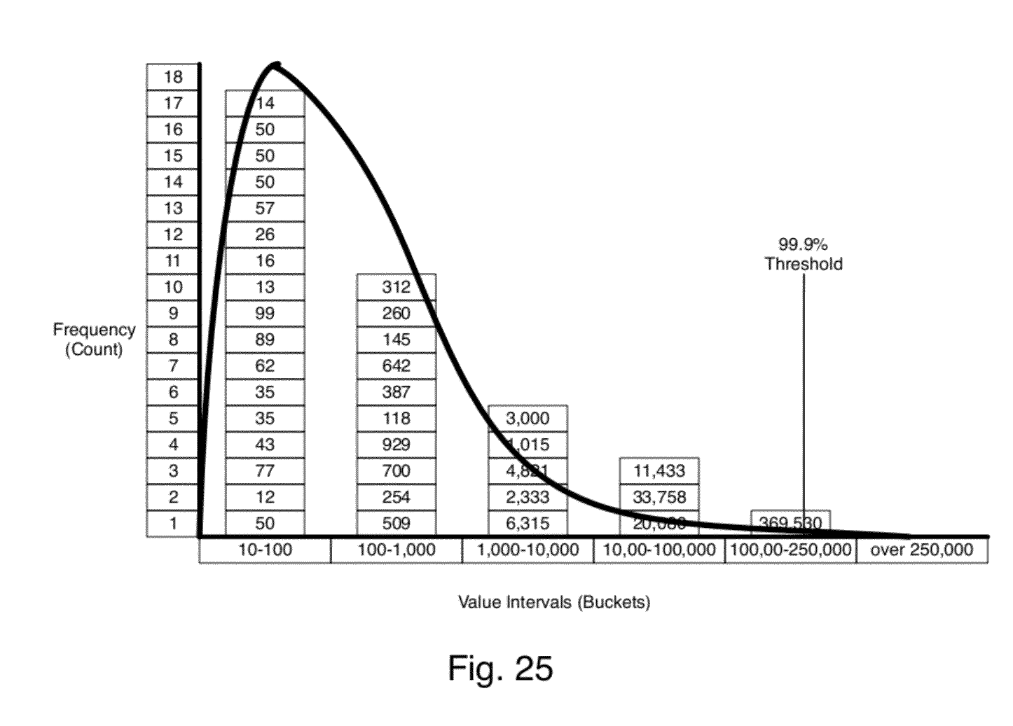

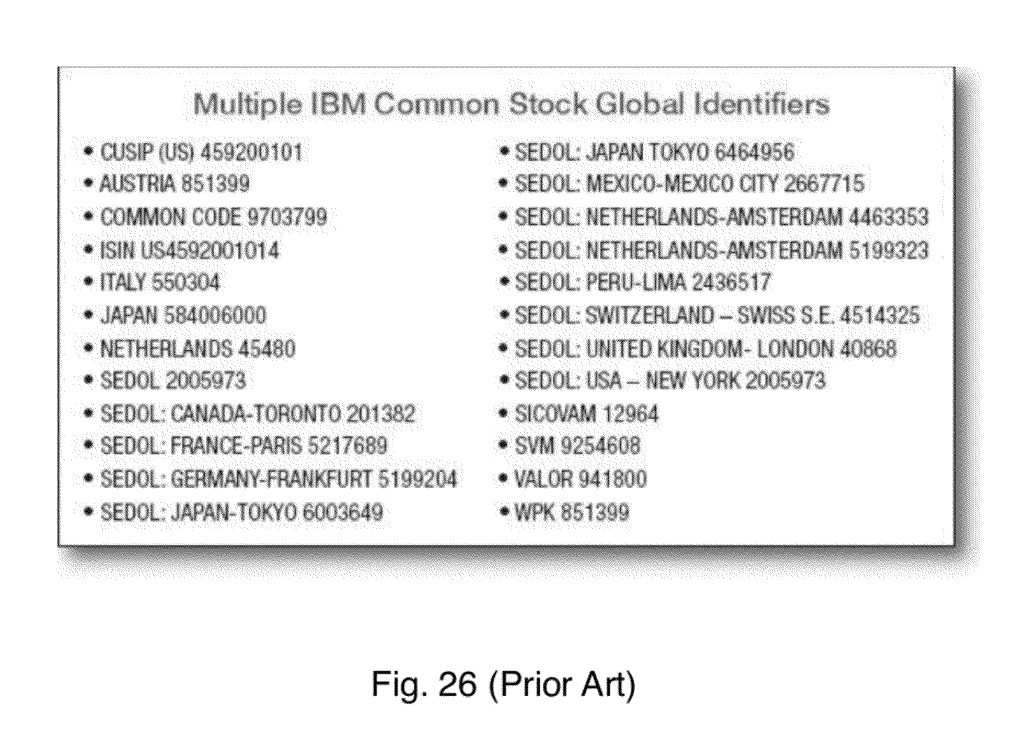

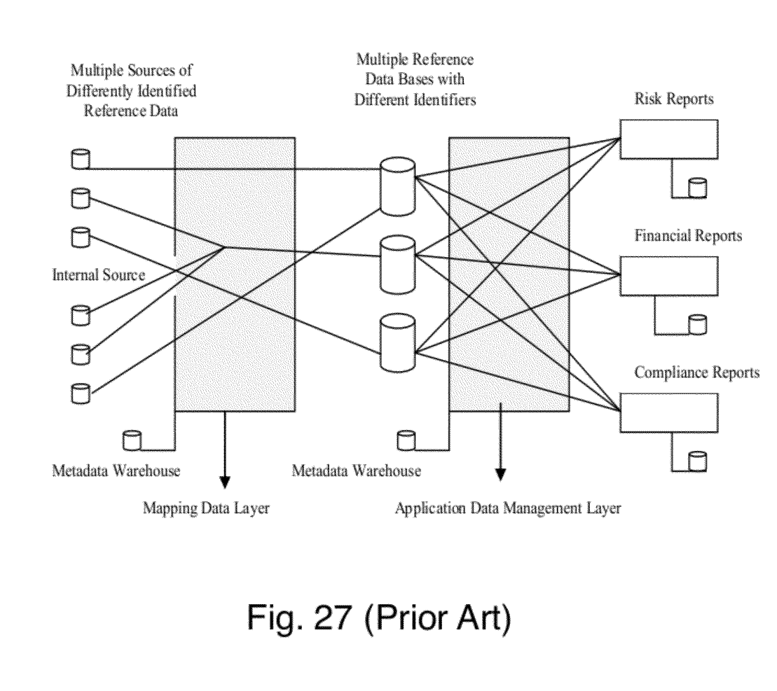

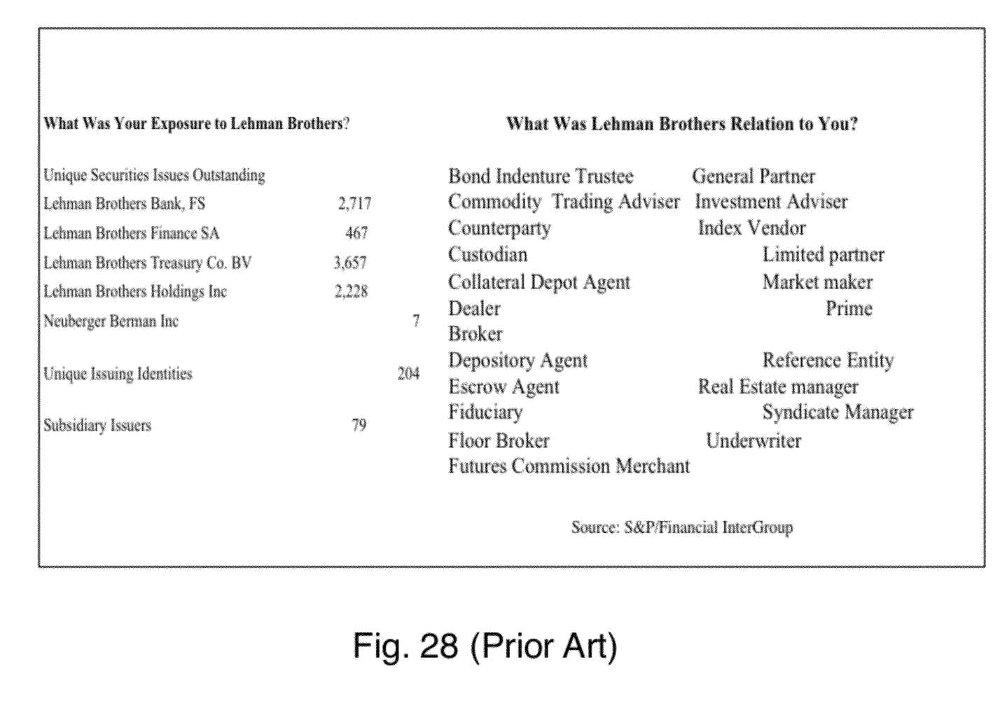

FIG. 25 is a graph referred to in explaining a risk management technique.

At a predetermined interval, generally determined by regulatory reporting requirements, such as monthly, CCDM 1200 executes a program for determining the proper amount of funds for its capital account. The program operates as follows.
1. Sort the reimbursed losses, by amount, into one of a predetermined number of loss amount intervals, also referred to as buckets.
2. The reimbursed loss increases by one the number of entries in the bucket. The amount of the loss increases the cumulative amount in the bucket.
3. Obtain manually provided loss information from the Risk Management Department for CCDM 1200, and process as in steps 1 and 2.
4. When all transactions are complete, prepare a histogram.
5. Arrange the buckets so that the largest number of occurrences, usually the smallest number of loss values, is placed at the leftmost side of the histogram, then proceed along the x-axis until the bucket with the smallest number of occurrences is placed at the rightmost side of the histogram. The result is shown in FIG. 25.
6. Fit a Gaussian curve to the histogram. FIG. 25 shows a fitted curve in a heavy line.
7. At a predetermined point on the fitted curve, typically the point that defines where 99.9% of the area of the curve is included, determine the cumulative value of the losses.
8. Subtract the amount in the capital account from the amount determined at step 6, the result is additional required risk capital.
   At step 3, the manually provided loss information is obtained from data bases available commercially or by consortium membership in such data bases, one example being the ORX consortium. These data bases contain public and privately reported losses that are part of the requirement under bank regulation for valuing a single firm's capital, not only from its own loss history but from the history of losses from the industry at large.

Along with reserves for expected losses, and the cost of insurance for such items as errors and omissions, fires and thefts, wind and flood damage, computer and utilities failure, terrorist and privacy breaches, and other catastrophic events the economic capital of the CCDM will be calculated for covering 99.9% of the overall losses, Expected (EL) and Unexpected (UL).

The initial assumption about the CCDMs Capital at Risk calculation will be based exclusively on assessing capital for Operational Risk. This initial assessment, recognizing no loss history is yet available, will be computed at an industry accepted standard of 12% of equivalent Financial Market Utility overall capital, such utilities having credit and market risk in addition to operational risk, the singular risk that the CCDM incurs. Thus for a $2 billion capital requirement overall for an equivalent operation incurring all three risk categories, the single operational risk capital for the CCDM initially is to be computed at $240 million.

FIG. 25 shows, on its abscissa (x-axis), six buckets. The bucket value and number of losses in each bucket is shown in Table 3.

TABLE 3

| Bucket value | Number of items |
|---|---|
| $10,000-100,000 | 17 |
| $100,000-1,000,000 | 10 |
| $1,000,000-10,000,000 | 5 |
| $10,000,000-100,000,000 | 3 |
| $100,000,000-250,000,000 | 1 |
| over $250,000,000 | 0 |

In some embodiments, at step 7, use the total area under the curve divided by the total area of the curve, and then multiple the resulting fraction by the total value of losses accumulated as displayed and summed from the histograms.

In other embodiments, other techniques are used, as described in U.S. patent application Ser. No. 12/081,619, filed Apr. 18, 2008, having a common inventor herewith, the disclosure of which is hereby incorporated by reference.

Long overdue, a global identification system for financial market participants and the products they trade in, as proposed by US regulators, has now been elevated to the status of global regulation in that the G20's Financial Stability Board has taken on the promotion of its adoption by other regulators. The plan is to start with the common identification of legal entities (LEI's) engaged as financial market participants in the OTC derivatives markets and their associated hierarchies of ownership and, similarly, to identify OTC derivative products.

Requirements for data standards had been initially presented to satisfy US governments' need to protect its financial industry from another financial crisis. The inability to observe the risk of Lehman Brother's bankruptcy was the immediate catalyst for US legislators to demand a common identification system for creditors, counterparties and other trade participants in the financial supply chain. They had come to appreciate that multiple identifiers for the industry's financial market participants and products are inhibiting the aggregation of information both within financial institutions and certainly across financial institutions. Further, US regulators had the foresight to suggest that it may well benefit all governments to observe risk in their own financial sectors by accommodating such a common identification system globally.

This paradigm shift in thinking has been accompanied by our suggesting through this invention that arriving at a solution will require: 1. understanding global identification for the financial industry in context of managing a supply chain; 2. including issuers and other non-financial participants and their auditors as key financial supply chain constituents and stakeholders; 3. considering solutions beyond those proposed by regulators and from outside the financial industry in contrast to those now recommended by financial industry members in support of their trade associations and standards bodies; and 4. following the lead of global standardization techniques well established in financial statement reporting and on the Internet.

In this later regard, and most importantly, as corporate issuers and other financial market participants are the manufacturers' of financial products, they are situated at the origins of a financial transaction's life cycle. This is particularly relevant as this constituent group creates the reference data found in prospectuses, offering memorandum, articles of incorporation, trust agreements, master derivatives agreements, collateral agreements and public announcements of corporate events. That information, largely defined in legal terms today is, in the main, manually transformed by data vendors into the data attributes necessary to make this information operational. This was at the time the same for financial statement reporting, although the vocabulary of generally accepted accounting principles was the operative medium until the language of the internet, the eXtensible Markup Language (XML) and its variant for business reporting (XBRL) was introduced.

The XML and XBRL tagging language, and another variant FpML (Financial Product Markup Language used for Swaps and OTC Derivatives) accompany data in its distribution through electronic communication systems and in computer storage devices. Computer programs are programmed to look for specific tags in order to find specific information contained within those tags making automated access to granular information possible. This invention develops common data tags for the LEI that are to be used in XBRL and FpML templates to be assigned at the origin of the work flow and then transmitted by communications medium into a computer storage device.

XBRL is now used by most of the world's regulators and many exchanges, transforming reports of the statement of financial condition into computer searchable data. These same regulators and the key financial personnel at submitting entities who accepted XBRL for financial statement reporting should also be asked to have a role in the LEI, especially as the basics of this information is already reported in annual reports.

The LEI is to be a unique, unambiguous and universal identification system for assigning, describing and identifying financial market participants and facilitating its distribution and use in automated systems. The LEI system and its initial extensions to OTC derivative products, should be built around a “number” that is globally unique. It also should have four other components to make it operational: 1. An association of parent-child relations in the hierarchies of ownership of market participants; 2. the reference data or data attributes that are critical to inform a computer program how to transform a unique identity into operational values; 3. the data tags that allow a computer program to search and find the product or counterparty and its associated data attributes to perform its operations on; and 4. A storage and data distribution system to provide access to the characters of the identification code and its associated reference data in automated form.

In industries and businesses outside finance, Walmart, Federal Express and Amazon are examples of leading transformational companies that have streamlined their own businesses and drove their respective industries toward its equivalent of Straight-Thru-Processing. Demanding that everyone who does business with these giants of industry get a unique number for its products, it then facilitates the automation process through the reading of the ubiquitous bar code. Neither of these firms could exist in its current form at such scale without the unique identifying numbers imbedded in bar codes. The financial industry's equivalent, the XBRL data tagging language, is beginning this same transformation in the financial services sector. This had been going on in pilot mode for some time and is now mandated to be used in financial statement filings to the SEC. Nearly 75% of global regulators now require automated financial reports of accounts in XBRL format.

The LEI should become as foundational and have as profound an effect on financial trade as the creation of the unique numbering system imbedded in the bar code had on commercial trade. The phenomenon of the Internet's order-to-ship-to-deliver process, the economic scale of Amazon and Federal Express and Walmart, and the ubiquitous smart phone scans at airline counters and checkout counters were all enabled by simple unique computer readable numbering conventions manifest in such technology as a bar code, an internet address, the global positioning satellite coordinate system and the global mobile phone network's calling scheme.

In the retail industry, and in 25 other industries, companies already are realizing the benefits of Straight-Thru-Processing while having to pull packages and pallets around with the data. Just-in-time delivery; scanning at checkout; automated inventory replenishment; even automating the sales-to-manufacturing process are a consequence of first getting a universal numbering system in place. Placing the manufacturer's identity, universal product codes and unique delivery location in a bar code made the streamlining of commercial and retail trade possible.

XML and its variant, the XBRL data tagging language is beginning this same transformation in the financial services industry; starting with financial statements and then proceeding on to the mother-load of reference data contained in offering memorandum, articles of incorporation; prospectuses; even corporate event announcements. Now, while it becomes easier to find information by computer means, whether it is the scanner positioned over a bar code, or a computer program looking for a particular standardized data tag—if the information it finds is not consistent or standardized we have not accomplished the mission.

When we do not have standards we lack transparency, have no audit trail and lack the ability to aggregate information efficiently. When we have standards regulators can see that which they are mandated to oversee; we can aggregate information within and across financial enterprises; we can trace orders through to their trade execution, payment and settlement; and we have the potential, finally, to achieve the long sought after vision of global Straight-Through-Processing. We have known about this problem for nearly three decades. Many standards bodies in the financial industry have tried and failed to come up with an agreed to standard. Divulging confidential information of the business hierarchies and their ownership relations is but one issue; having standards bodies that compete with each other now asked to work together to come up with a new standard is another.

Governance—One of the lynchpins of global financial reform is to attract the commitment of sovereign regulators in support of common purpose. This approach has some precedent, the Basel capital accord, the World Trade Organization, the IMF as examples. Another way is for financial institutions to agree to abide by common purpose as demonstrated in precedents of the ANNA federation and the Internet's FIXML messaging conveyance of financial transactions. Realistically, without sovereign regulators relinquishing their sovereignty to a global regulator, or to a central but “too-big-to-fail” utility, the best practice way to implement the LEI is through a federated operating model. Such a model has precedents in the financial industry and elsewhere. It can be fostered through global consensus, administered by sovereign regulators in partnership with financial market participants, and implemented in a parallel way over the Internet, itself a federated model. The arrival recently of the FSB as the central figure in forming global consensus around financial reform makes a global implementation around this model feasible.

Sovereign regulator administration—the process begins through the allocation of a batch of numbers (one of the two parts of the LEI to be further discussed below) to sovereign or regional regulators, each within their own jurisdictions, done once at initiation of the LEI system. This global allocation assures the global uniqueness of the numbers so that there is no possibility of duplicates and the number of financial market participants in each jurisdiction would be known. A global standards body, or global trade association or other trusted institution under contract with one of a number of global institutions (i.e. BIS, IOSCO, the FSB) would centralize and administer the allocation and distribution of the core numbers, what we refer to as the Registration Identifier or RID or outsource it in trust with an established registrar, such registrars are banks or trust companies, others are audit/accounting firms.

Self-registration—the financial market participant identifies itself, a logical approach as it is they who cause the articles of incorporation to be drafted, or apply for a broker/dealer license or a bank charter. They or their agents would be best able to register these details accurately. However, it is proposed that there be two components to self-registration to enable a control mechanism against false registration and to assure global uniqueness. The first component is the registration of a unique identifier (RID). The RID is to be assigned by sovereign regulators themselves and/or through their designated Registration Authorities (RAs) where such institutions already exist (i.e. the UK's Companies House, the European Commission's European Business Register, etc.). Where acceptable, RA status can be assigned by regulators to others, perhaps in a meaningful partnership with those who have a global view and a local presence, for example, the members of the World Federation of Exchanges, or IOSCO or ANNA members or the Big 4 accounting firms, all globally accepted organizations each with local presence in a federated membership model. These organizations are, importantly, already at the front end of the initiation process of establishing and reporting on business formation.

As more sovereign regulators are accommodated in the global LEI initiative the public-private partnership will evolve in various forms. The choice of a local, regional or global RA entity for assigning the RID and for locating a secure facility where the RID and its Registry will be stored such as, in an embodiment on a Domain Name Server on the Internet, will depend on the maturity of each financial market and the sovereign government's own financial regulatory regime. Following the RID registration, the second part of the number is self-assigned by the market participant or its designated Registration Authority and certified as below.

Certification—(assurance) of the identity of the market participant is required. We advocate for auditors and/or designated certifying agents. Certifying designation can be bestowed on existing market center operators, or standards bodies, or business registry operators or financial market utility operators. Auditors and exchanges are already at the front end of observing the creation of legal entities and may be preferred as they would tend to minimize information leakage.

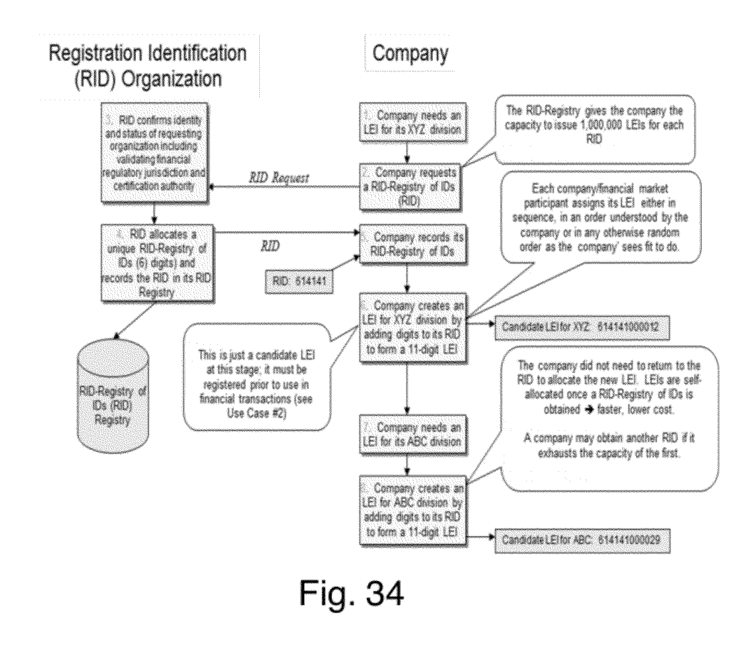

No intelligence—the number itself should have no intelligence in it—no country or issuing agency code, no ability to parse the number to determine meaning. All intelligence is to be contained in the associated reference data. Changes will occur with the reference data, not the number. This allows the number to persist indefinitl providing a meaningful audit trail for any and all changes that occurred. (see FIG. 34 for an illustration of this attribute of non-intelligence).

Confidentiality—not necessarily of the number itself, but more importantly the parent/child relations and eventually the reporting of percent ownerships, are thought of by companies and countries to be confidential information, especially those countries that have government owned businesses, have established non-taxable trade zones, have regulated secrecy of business ownership, etc. Sovereign regulators and exchanges (and their auditors) are already privileged observers of this information and would be best positioned, we believe, to protect confidentiality provisions of globally agreed to and locally regulated LEI confidentiality rules.

Legacy System Consistency—the manifestation of the LEI in computer data bases for use as search and storage keys, and for use in communication networks, should be backward compatible with best practices proprietary standards that exist today. The consensus of such existing standards is that the common standard in the financial industry should consist of no greater than 11 characters although in applying this invention in other industries it can be different. A structure for the LEI's unique, unambiguous and universal identification system for the financial industry is offered below and hypothetically tested for use in the LEI as well as for financial products and financial event identification.

The present identifier system will now be described.

Start-up—A first time, an at-initiation request from the central system's operator and/or administrator or its designee is made to each designated Registration Authority (RA). The request is made to identify the number of current and projected entities in its jurisdiction requiring LEIs. The request is to be accompanied by a policy document describing the global LEI initiative, authored by the global governing body for the LEI (perhaps the FSB). Allocation of the range of RID numbers (the first set of characters, 6 in one embodiment of the 11 digit number) is made based upon the responses. These numbers are communicated to the RID Registry as allocated, similar to a Registrar keeping count of the shares outstanding vs. those authorized.

Initiation of the RID—When an RA has issued a RID, it communicates that RID through an XBRL automated template, noting its information such as name, address, number assigned, etc. through a communication device into the computer storage device (the RID Registry or the RID Domain Name Server) of the invention.

Initiation of the LEI—When an RID-identified entity is prepared to register and have certified its specific LEI, it fills out its XBRL Template, provides the minimum data attributes and communicates it via a communication device to a computer storage device. A computer program operates on the communicated XBRL tagged messages, parses the information by accessing the specific tags noted in the XBRL Template's taxonomy, then matches the RID portion of the embedded LEI to the RID Registry to validate the RID, and then stores the LEI—the RID plus the remaining characters, into the computer storage device of the RID/LEI Registry or, in an alternate configuration the RID/LEI Domain Name Server.

RID/LEI Data Utility—Thereafter, the updated data is communicated to the local and or regional stores of reference data as indicated by the preference of which Registration Authority is designated to store such data.

Reference Data Registration Authority (RDRA) Utility—More complete reference data extending beyond the minimal data attributes required by regulators is presented to the local registration authorities by data vendors and others and certified as a Reference Data Registration Authority (RDRA). Each such addition is noted and made available to all participants RAs. The RID/LEI Registry and the RDRA data bases/servers are available to users through subscription profiles in the routers of the communication network as described in the parent patent referred to earlier, accessible from financial institutions and regulators. It is also accessible via inquiry requests and responses from the same.

Proposed Best Practice—In stark contrast to this invention, the SIFMA-led recommended solution presents a radically different approach where multiple sources of LEI information is mapped together, de-duplicated and normalized at the end of the process. In this invention the LEI data is normalized at the front-end through XBRL templates and entered directly into the network. There it will reside on servers/server clusters and accessed via query/response and publish/subscribe methods using the intelligence imbedded into the overlay applications on the Internet as described earlier.

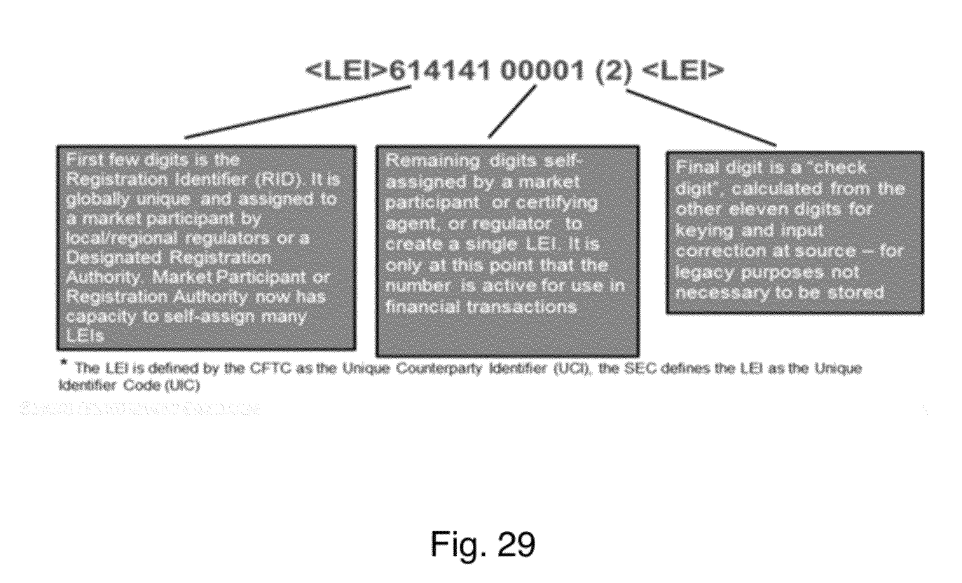

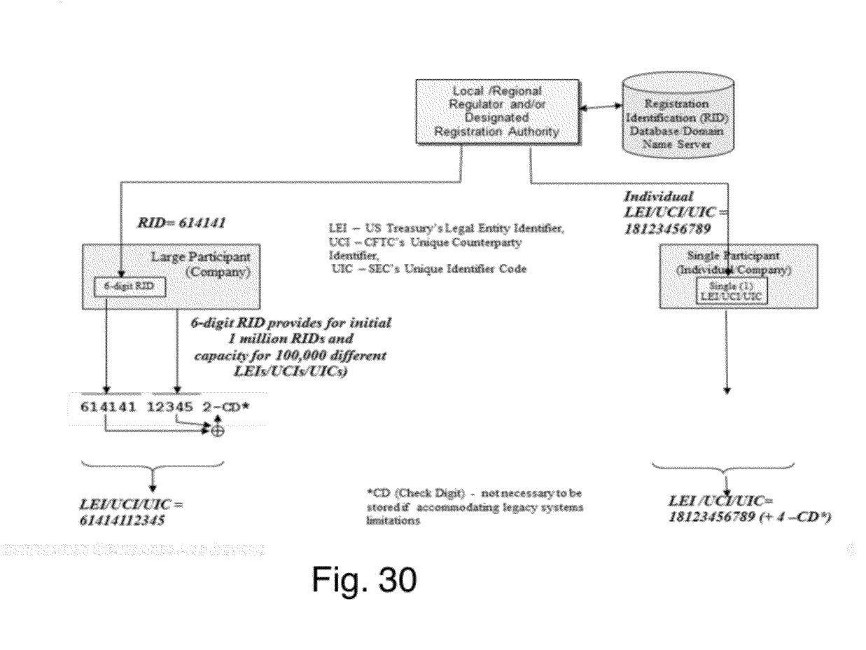

FIG. 29 shows an embodiment of the U3 identification system having a fixed length of 11 characters; other embodiments have different lengths. In the financial industry, legacy system space considerations dictates the length be no longer than 11 characters. As examples, an 11 character construct fits into the space of SWIFT's BIC code, S&P's Issuer component of its CUSIP and CABRE numbers, ANNA's issuer portion of its ISIN number, DTCC's AVID number, and the LSE's SEDOL number. Even the 150 million Duns numbers can be represented in the 11 charcters described in this invention.

FIG. 30 is a diagram showing assignment of the identification code in its two part assignment and registration. A firm that has many legal identities can organize its own method of assigning the remaining 5 digits of the 11 digit number. In combination with the six digit RID it can register many LEIs). A single RID/LEI combination of a complete set of 11 numbers can also be issued by the RA directly. The allocation of these numbers to sovereign regulators is to be done once at initiation of the identification system. In this way the uniqueness of the numbers would be assured so that there is no possibility of duplicates. When and if the numbers are exhausted in any sovereign jurisdiction it can be restarted by assigning an additional sequence of numbers to expand the available identifiers.

The total number of assignments using first the digits 0-9 and then the western alphabetic (excluding I, L, O, Q, V, and Z), a total of 30 digit/alphabet combinations (see below) is 729 million RIDs and, for each RID 24,300,000 LEI's. Using just digits, which is how we would suggest initiating the assignment process, would result in 1 million RID's and 100,000 LEI's for each RID. See Table 4.

TABLE 4

| 0 | 1 | 2 | 3 | 4 | 5 | 6 | 7 | 8 | 9 |
|---|---|---|---|---|---|---|---|---|---|
| A | B | C | D | E | F | G | H | J | K |
| M | N | P | R | S | T | U | W | X | Y |

A global financial institution standards setting body, like the FSB or IOSCO or BIS, could be the responsible overseer of the numbering system for administering the allocation of the RID numbers. It could outsource the administration to a trusted outsourcer, similar to a public company selecting a bank or accounting firm to be the registrar for its issuance of its securities to assure the amount of outstanding shares are equivalent to what was authorized.

Exchanges, coincidentally, are requiring XBRL financial accounts reporting and they are the one category of financial intermediary most often at the front end of the financial transaction supply chain. They are in an excellent position across the globe to interact with sovereign local regulators in overseeing the RID portion of the registration of LEI's. Exchanges (and their auditors) as well as regulators are already privileged and trusted observers of this information. The minimization of information leakage in this relationship is compelling, more so than having further downstream financial intermediaries—payment network operators (like SWIFT), Central Securities Depositories (like DTCC), Clearing Houses (like Euroclear), and commercial data vendors (Bloomberg et al) oversee, allocate and distribute the top level numbering system batches (the RID) to regulators and/or their designated agents.

The number itself, but more importantly the parent/child relations and eventually the reporting of percent ownerships, are thought of by companies and countries as confidential within varying degrees of regulatory emphasis. It is especially of interest to accommodate those that conduct government run businesses, have specific rules protecting confidentiality of parent ownership of business entities registered within their countries, act as pass-through jurisdictions for international trade, operate as non-tax jurisdictions, etc.

The identification system can be extended beyond the LEI to include other requirements, some of which are currently identified by other US regulators, namely the SEC and the CFTC. Beyond the LEI, the identification issues are just as great with instrument and contracts, especially the OTC derivatives contracts that are now being placed under regulation. Also, noteworthy is the lack of standardized financial event announcements which plays havoc with downstream asset servicing activities and with adjustments to life-cycle events of OTC derivatives requiring enormous loss reserves on banks books for such things as improper recording of a particular dividend payment, the misidentification of rights entitlements, a missed merger vote announcement, or the misidentification of reference identity information when mergers or bankruptcies occur. A standard financial event identifier is a further embodiment of the proposed identification system. Beyond these identifiers are further extensions to include for example symbols that are used by individual trading venues; and individual trader, trading desk and trading department identifiers.

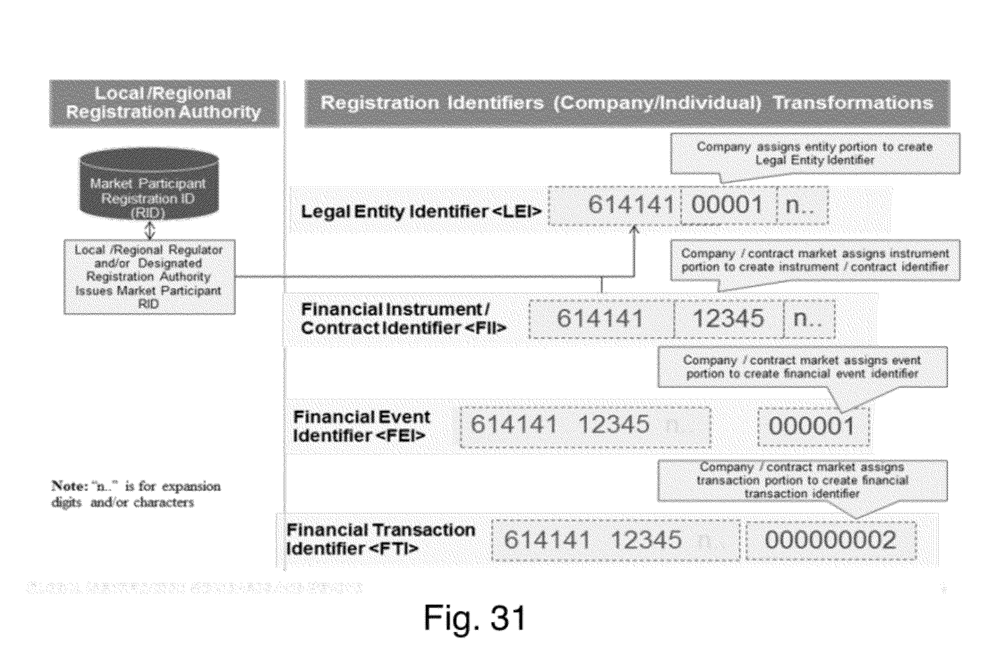

FIG. 31 is a diagram showing the U3 method extended for use with identification of products, events and transactions.

Following the XBRL example we can begin by translating the LEI and its data attributes into standardized XBRL schemas. The source institution would supply this information and after certification it can be imported directly into the Registry of Identifiers (RID) and its complimentary reference data utility.

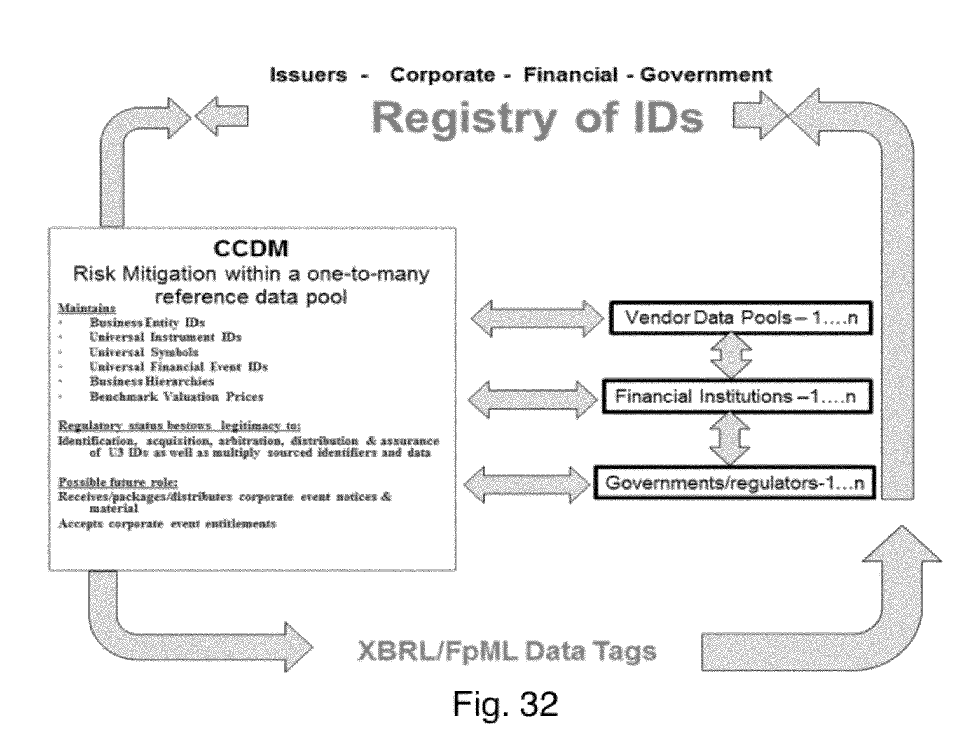

FIG. 32 is a diagram showing an overview of financial intermediaries and financial market participants operating through the U3 Id System to interact with the LEI Registry and the Central Counterparty for Data Management.

The Registry of IDs (LEI/RIDs) would be available to all value-producing vendors, software and technology companies, business registries, financial market utilities, et al and provide for their legacy continuation as commercial enterprises. It should further spur the industry's financial institutions to think of establishing the RID within a unique identity server, similar to how addresses are recorded and their corresponding web pages pointed to in the Name Servers on the Internet. In an embodiment the RID would be integrated as a network systems component of the Central Counterparty for Data Management (CCDM). Over time the LEI and the other identification numbers proposed here will become more complete in respect of all the data attributes necessary to perform the myriad of operational processes necessary to make an identification system useful in a processing system for such as pricing, valuation, performance analytics and risk management.

Here, as more prospectuses, offering memorandum, financial event announcements, etc. get translated through XBRL templates into direct input as reference data, the utility emerges over time as a complete reference data repository, eventually to be thought of as a public good.

Table 5 shows an XBRL taxonomy for the Registry of LEIs, having a set of data attributes currently defined by regulators, industry participants and us. Table 6 provides information about the elements in Table 5.

TABLE 5

```
<LEGALENTITYIDENTIFIER>
  <PUBLIC>
    <LEI>
    <NAME>
    <ADRESSLINE1>
    <ADDRESSLINE2>
    <ADDRESSLINE3>
    <ADDRESSLINE4>
    <CITY>
    <PROVINCESTATE>
    <POSTALCODE>
    <GPSCOORDINATES>
    <COUNTRYCODE>
    <DATEUPDATED>
    <ACTIVE/INACTIVE/PENDINGCODE>
    <PRIVATEINFOAVAILABLECODE>
  <PUBLIC>
  <PRIVATE>
    <PARENTLegalEntityIdentifier>
    <CHILDLegalEntityIdentifier>
    <LASTFinancialEventIdentifier>
  <PRIVATE>
<LEGALENTITYIDENTIFIER>
```

TABLE 6

| # Field Name | Field Description | Sample Value(s) |
|---|---|---|
| 1 LEI | Unique identification assigned through RID/LEI issuer | 86438001000 |
| 2 Exact Legal Name | Entity's name as it appears on any legal documentation | Newco Ltd. |
| 3 Street 1 | Street address | 100 Maple Street |
| 4 Street 2 | Office number or floor | Suite 300 |
| 5 City | City where entity is located | Anytown |
| 6 State/Ward | State where entity is located | NSW |
| 7 Postal Code | Postal code where entity is located | 2000 |
| 8 Country | Country where entity is located | Australia |
| 9 HQ Indicator | Indicates if entity is also a headquarter | N |
| 10 Legal Form | Entity's legal type | Ltd. |
| 11 Ultimate Parent LEI | Identifier for ultimate parent | 87439011000 |
| 12 Ultimate Parent Indicator | Indicates if entity is the ultimate parent | N |
| 13 Immediate Parent LEI | Identifier for immediate parent | 87439011000 |
| 14 Country of Formation | Country where entity was formed | Australia |
| 15 Request For Review | Indicates if the entity has been requested for review | N |
| 16 LEI Status | Indicates registration and certification status of an LEI | Available - Certified |
| 17 Reason Code | Indicates why an LEI has been disabled | Issued in error, Duplicate |
| 18 Successor ID | Indicates which LEI is used due to corporate actions | 86438001000 |
| 19 Other Metadata | Date LEI Issued; Last Updated; Date Disabled | Jan. 21, 2012 |

The LEI Registry will be made available to public and private consumers and regulators though approved password/public-private key access. In the case of public companies, CFOs and/or auditor would provide complimentary codes in order to release private data to regulators on an as needed basis. For non-public companies/other market participants, the certifying agency (i.e. NFA, FINRA, NYSE, DTCC, et al) would control registration and certification through their auditors.

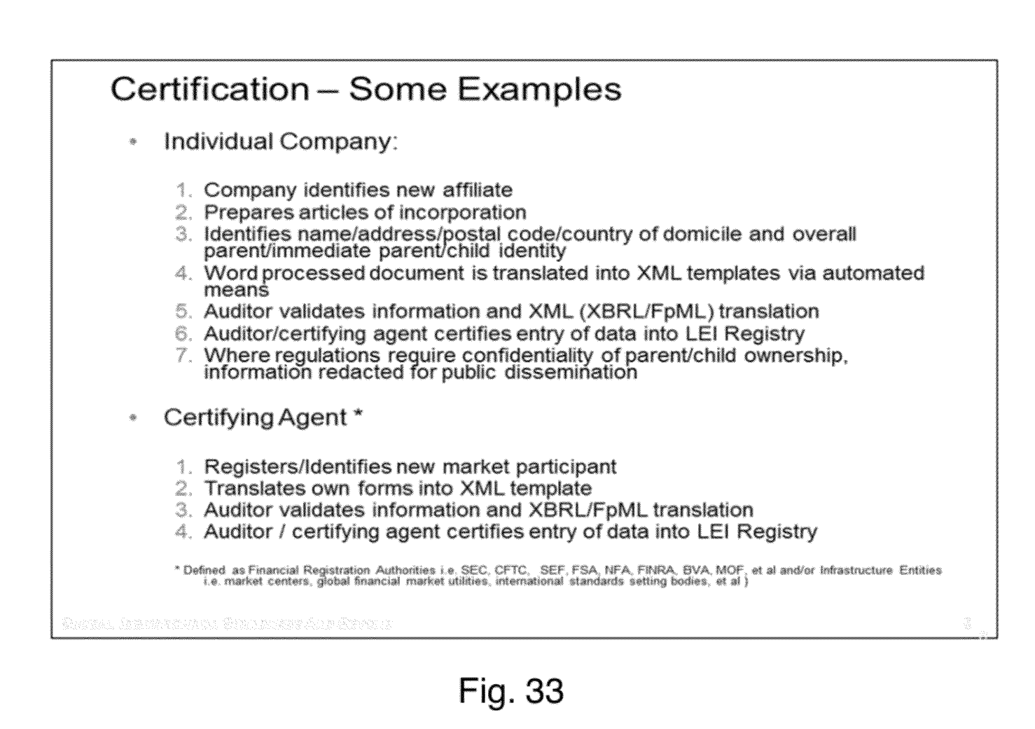

FIG. 33 is a chart showing examples of methods of certification.

The actual LEIs may be redacted through algorithmic random number generators with decoding keys so that the same LEI's (randomly coded) could be found throughout financial institutions. This allows for respecting confidentiality while providing regulators access to identify potentially overexposed institutions or counterparties. This would allow regulators to observe valued position and cash flows for the same company and hierarchy of companies but without knowing who it is until they formally request an inquiry. Thereafter, regulators will be made aware by auditors, or some global advisory board of systemic risk oversight members, of the organization or organizations that appear to be over exposed to risk generally or to a particular type of asset risk; or causing a contagion to appear possible; or have exceeded key risk indicator levels, etc.

An industry owned and globally regulated secure facility or its equivalent reflected in distributed data stores on the Internet would retain standard reference data for use in the computer driven business applications that use the identifiers to locate operational information for such things as paying taxes, valuing positions, determining cash flows, etc. It may also redact non-public hierarchical ownership information. All market participants, vendors and regulators would have access to the identifiers and reference data by simply accessing it through its unique IDs.

Table 7 is a chart showing extended reference data attributes.

TABLE 7

| | |
|---|---|
| Regulatory Agencies | Financial Reporting Agencies |
| Place of Domicile | Web addresses |
| Taxing Jurisdictions | Reporting Jurisdictions |
| Transfer Agent | Contract market |
| Broker-Dealer | Proxy agent |
| Bank | Credit Union |
| Inter-dealer | Custody Agent |
| Futures Commission Merchant | Floor Agent |
| Financial Market Utility | Securities Industry Processor |
| Introducing Broker | Hedge Fund |
| Trading Desk | Give-up Agent |
| Investment Manager | Clearing Agent |
| Trading Adviser | Settling Agent |
| Pool Operator | Escrow agent |
| Fund Operator | Redemption Agent |
| Prime Broker | Place of Trading |
| Settlement Account | Counterparty |
| Collateral Account | Reference Entity |
| Locations of Settlement | Guarantor |
| Delivery Location | Affiliate |
| Standing Settlement Instruction | Subsidiary |
| Swaps Dealer | Swaps Data Repository |
| Major Swaps Participant | Swaps Execution Facility |
| Reference Entity | Child/Parent Percent Ownership |

An embodiment of the U3 Identification System Utilizing the Domain Name System (DNS) principles of the Internet and the LEI numbering convention as an example will now be described.

The Internet's Domain Name System (DNS) was originally created as an “overlay” service on top of the plumbing (the pipes or communication infrastructure) of the Internet to support the need of computers to access “telephone number-like” addresses from human understandable names. The DNS system maps addresses to literal names and is able to resolve either from the other. The resolution ability of DNS relies on the Internet Protocol's address hierarchical structure: network.domain.subdomain.machine (172.16.1.162, for example) to determine the authoritative physical address of the DNS server that registered the address. The system implements a distributed database of addresses and domain names across a network of DNS servers. The service enables the operation of Internet applications such as e-mail, the World Wide Web, the Handle System and the Direct Object Identifier (DOI) system.

The DNS system “points to” other servers by passing a requesters query to an IP address that, for example, starts with 172 in the above example. In DNS, if the queried name server isn't authoritative for the data requested, the query will be passed on to interrogate other name servers to find and resolve the address. The system can either send a recursive query to those name servers, thereby obliging each in turn to resolve the query and return the addresses. Or it could send iterative queries and possibly refer to other name servers “closer” to the domain name it's looking for.

The closest known name servers are the servers authoritative for the zone closest to the domain name being looked up. If, for example, the server receives a query for “research.XYZ.com.br” it will first check whether it “knows” (has its address stored in its server) the name servers for “research.XYZ.com.br”. If it does, it will send a query to one of them. If it doesn't it will check whether it knows the name servers for “xyz.com.br” and after that “com.br” and finally “br”. The default, that is at what server the query is guaranteed to stop at, is at the root name server zone since every name server knows the domain names and addresses of the root name servers.

An embodiment of a LEI implementation uses the DNS principles to resolve LEI numbers to its registrant, where each DNS or cluster of DNSs is administered by the Registration Authority that assigns the RID portion of the LEI to companies in its jurisdiction.

In implementing the LEI on the Internet each company would have a domain name maintained on each Registration Authorities' DNS that has authority over the LEI. The DNS would point to one or more Reference Data servers that contains, first the RID/LEI and its minimum data attributes, and then the more robust reference data supported by the RDRAs for further defining the data attributes of the company This later set of data attributes are useful from an operational and valuation perspective. Such reference data as tax identification numbers, indicators of tax exemptions by country, multiple mailing addresses, dates and rates associated with dividend payments and other corporate life cycle events, etc. are kept in one or more of these RDRA servers

In DNS, each domain can be administered by a different organization. Each organization can then break its domain into a number of sub-domains and delegate responsibility for those sub-domains to other organizations. This should allow the implementation of a sovereign country or regional Registration Authority (RA) administrator to be the authoritative registrar of the RID.

As with the DNS, the webpage servers in the world wide web application, we refer to them as Domain Identity Servers (DISs), are organized as distributed databases. Business entity identifiers (RID's and LEIs) are used as key indexes into the DIS databases. A query about a LEI to the DIS's distributed database service will prompt, for example, a Reference Data Registration Authorities' (RDRA's) Domain Identity Server (i.e. operated by such as Bloomberg, Thomson-Reuters, DTCC/Avox, Kingland, the CCDM, et al) to respond.

Other service functions will now be discussed.

DNS already supports many services that can also support a LEI implementation. For example the DNS service called “whois” could in the LEI context allow users to issue a command like “% whois 0614141123452” and the service will return the minimum LEI data attributes required by regulators. A custom approach, for example, of defining a “−f XBRL” flag and placing it in a query, could activate a response formatted through the XBRL LEI Taxonomy definition. For example, the information provided could be as shown in Table 8.

TABLE 8

| | |
|---|---|
| Legal Entity: | XYZ Corp |
| Entity Name: | XYZ Germany, GmBH |
| Parent LEI: | 0614141112111 |
| Address: | 14 Blutstrasse, Frankfurt |

Using a different service request a flag such as “−d 0614141123452” to the “whois” command can be created that will respond with the detailed data elements through a secure authentication challenge. When the query authenticates the requestor it could then reply with the data elements appropriate for that type of data consumer.

Another DNS service is called Name Server lookup, or “nslookup”. In the context of the LEI implementation this service could provide the address of the Registrar for a particular LEI. The requested service would be described as “% nslookup 0614141123452”. This query would return the IP address of a registered domain server (sovereign country Registration Authority) that may be able to resolve the particular LEI.

The Internet, by design, has been built as a resilient network with multiple points of failure easily reconciled through rerouting messaging dynamically around any such individual or multiple node failures. The Internet is designed to keep the whole of the infrastructure continually accessible. It is a remarkably agile federated network and data storage mechanism for a robust implementation of the LEI system and beyond.

Since the Internet's public debut its ability to keep up with the number of addresses assigned, throughput rates and transaction capacity has been challenged and its architects have risen to the occasion. Server farms are scaled on a dynamic basis to accommodate increases and declines in capacity and throughput rates. When throughput and access rates increase around a particular activity and/or in a specific region, neighboring Domain Name Servers become populated with directly resolved domain addresses decreasing the time to access the root servers. In mission-critical applications where Quality of Service provisioning is to be maintained as part of a Service Level Agreement, capacity provision, intelligent caching and server replication are used.

Address naming conventions in the Internet have been expanded to increase capacity, leaving existing names compatible with this expanded and longer numbering convention.

Internet Authentication Service Providers can be included in the DNS, creating a public/private Internet overlay service that can include either a two-factor authentication or Public Key Infrastructure (PKI) authentication. The authentication service allows access control over the “enhanced” or private layer of data attributes for the LEI so that they can be made available to certain organizations based on authenticated LEIs. In this way when an entity does a lookup on another entity, there is a public view and when both parties can be authenticated there is a private view that contains the rest of the LEI data attributes. These are registered either via the Registration Authorities Domain Name Servers or its Domain Identity Server. The deeper extended data attributes are administered through the RDRAs' web page server equivalent, the Domain Identity Servers.

When further confidentiality is required new Internet features, such as creating “hashing” algorithms for redaction of data, can be deployed. This could, for example, allow LEI hierarchical ownership structures to be aggregated without divulging the identities of ownership. Later, when a systemic trigger is evoked and it indicates a redacted entity may be the cause, the reverse key of the algorithm can be provided to the regulator within the jurisdiction of the entities domicile. That regulator can then be enabled to observe the entities identity and conduct on site surveillance and due diligence.

Much the same way that DNS enabled expanded applications to be developed on top of the Internet infrastructure, a LEI DNS/DIS will enable transformational financial information services applications. An embodiment is a “recommendation service” powered by search engine technology where expressed interest in a specific LEI or characteristic of a LEI could trigger others with similar characteristics.

In another embodiment a user could create the profile of an entity of interest and a semantic search engine capable of supporting descriptive searches over the distributed reference metadata will return entities that match the profiles not only based on instrument-legal entity reference data but also relationships between entities. In another embodiment of an application of fusing data, as when entity and instrument data can be associated with valued position and cash flow data and aggregated to provide regulators with systemic information for an industry, a region, a counterparty, a financial institution, an asset class, etc. and for a multitude of systemic risk triggers and stress scenarios.

The method of the U3 Identification System described here along with its Registry of Identifiers (RID/LEI, RID/FII, et al) and associated industry owned-government regulated reference data utilities would allow the transformation of the industry from high operating costs and built in operational risk to leaner, less costly, less error prone more streamlined Straight-Thru-Processing.

It is well understood that faulty data creates huge operational risk as transactions cannot be processed in any comprehensive or timely automated manner. This failure is compensated for by requiring human interaction and reconciliation procedures across all the business silos that comprise a global financial institution. The improper interaction of human and automated process on data causes risk. Streamlining the processes, automating the interactions, and reducing the incidence of faulty data will allow the industry to eliminate operational risk from this source, or at least minimize it.

The necessary steps in this process, described above, to give regulators an ability to see that which they are mandated to oversee will also accrue tangible benefits to the industry as cost benefit trade-offs are realized. There exist huge duplicate expenditures for each firm supporting their own sourcing, cleansing and maintenance of the many reference data bases that exist within the business silos that collectively make up global financial institutions. We estimated this cost using the last available data in 2005 to be $¼ to $1¼ billion per firm annually. It's probably larger than that now given the combinations of the biggest firms that ensued since the financial crisis.

We conclude that the industry, represented by the largest financial institutions now defined as systemically important financial institutions (SIFIs) be the sponsors of reference data utilities, ones that are owned by industry members in keeping with other self-regulated public-private sector initiatives, and that supports a one-to-many Registry of Identifiers, core set of reference data and standardized data tags. With it one can envision the day when legacy systems are decommissioned and financial institutions will build value-added business applications and interface to the industry utilities. This will unburden them from the error prone and costly duplication of the reference data infrastructure that each firm builds and maintains at a huge cost and with an inherent risk resulting from misidentified, multiply sourced and faulty data. And, of course, regulators will finally be able to have the transparency they require to see into financial transactions and understand risk exposures as they build up.

It is left again to a partnership between industry and government to resolve this current crisis, through wise improvements in capital standards as in Basel III and beyond, and in far reaching data standards reform across the global financial system. Without such reform, neither regulators nor our financial institutions will be able to observe the coming of the next financial crisis.

FIG. 34 is a chart for a use case in which a company wants to create new LEIs/UCIs (UCI—CFTC's Unique Counterparty Identifier) for two operating divisions.

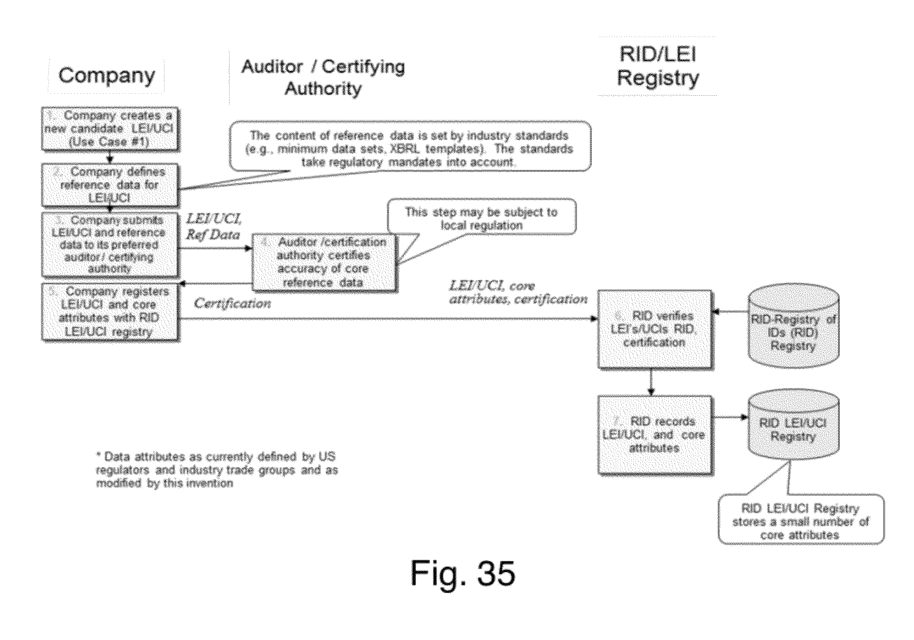

FIG. 35 is a chart for a use case in which a company wants to register an LEI's/UCI's core regulatory data attributes.

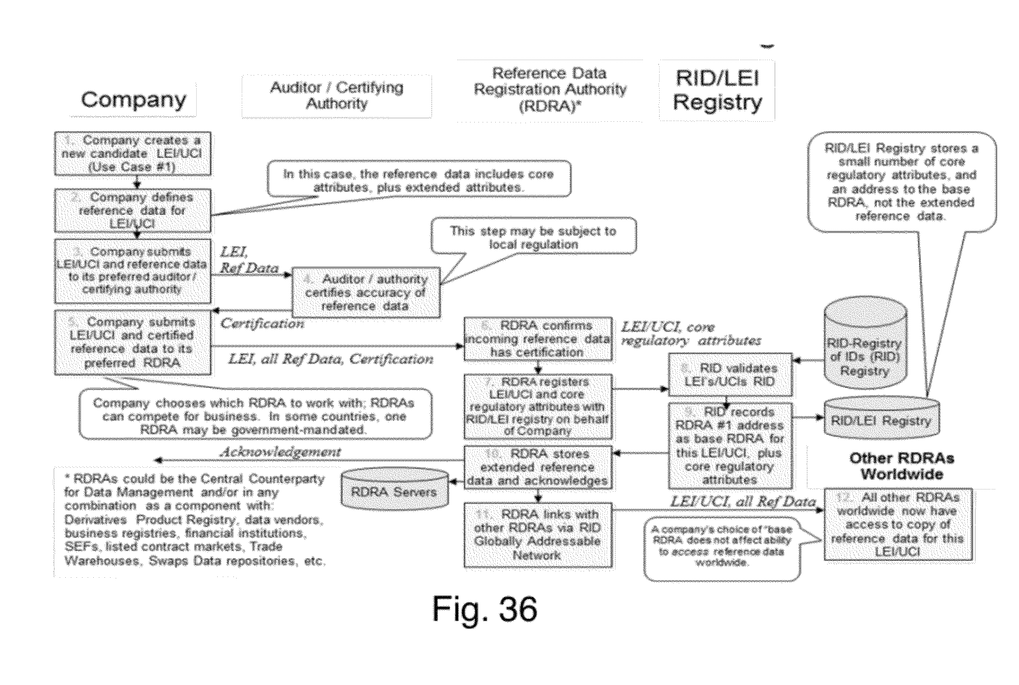

FIG. 36 is a chart for a use case in which a company wants to register an LEI's/UCI's extended attributes.

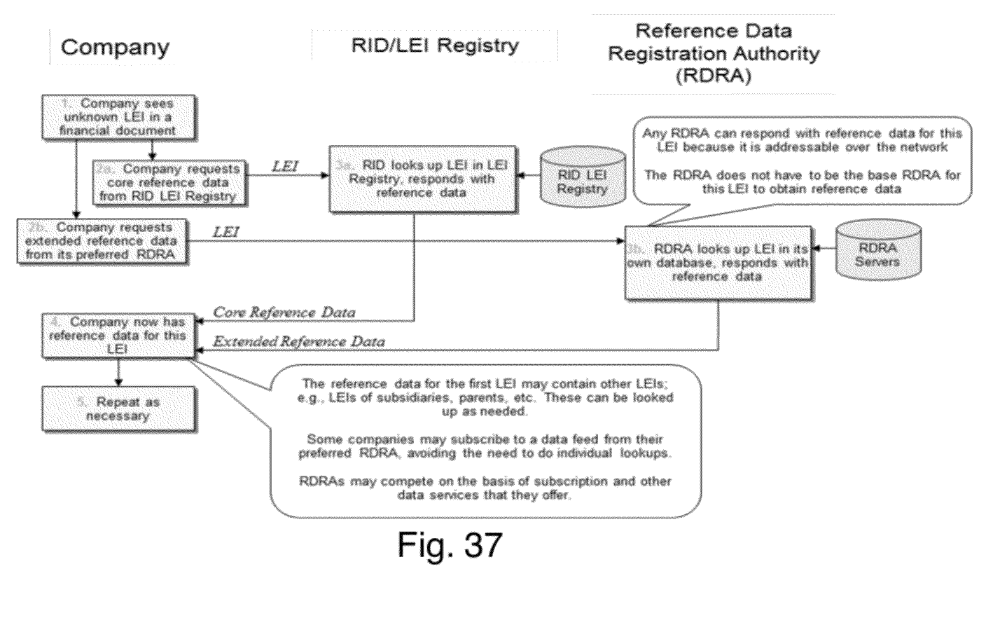

FIG. 37 is a chart for a use case in which a company wants to obtain reference data regarding an LEI observed in a financial document.

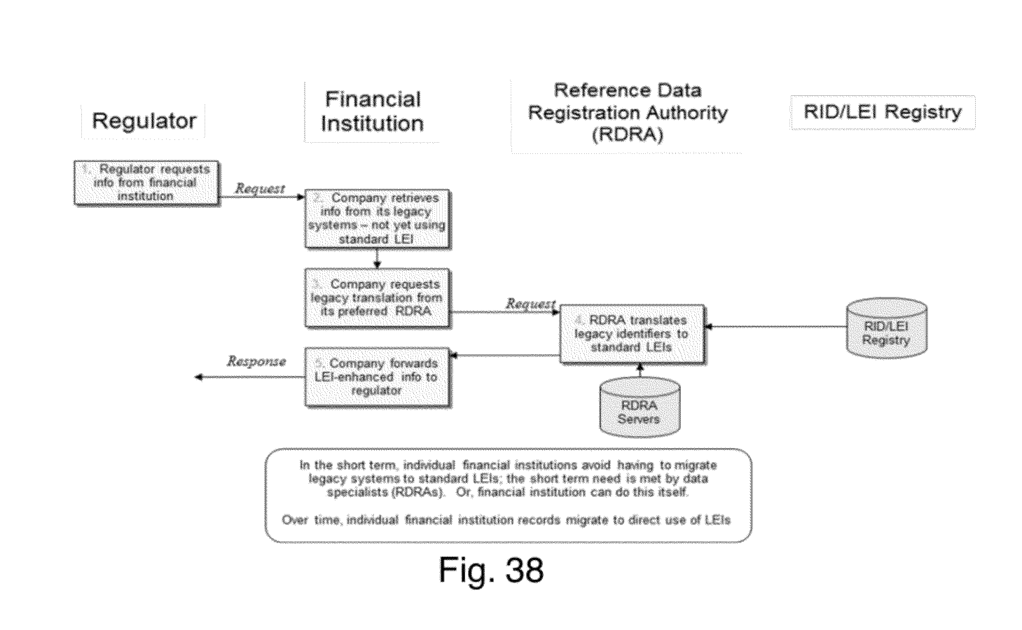

FIG. 38 is a chart for a use case in which a data provider assists in enhancing a financial institution's legacy data with LEIs, in the context of a regulatory request for information.

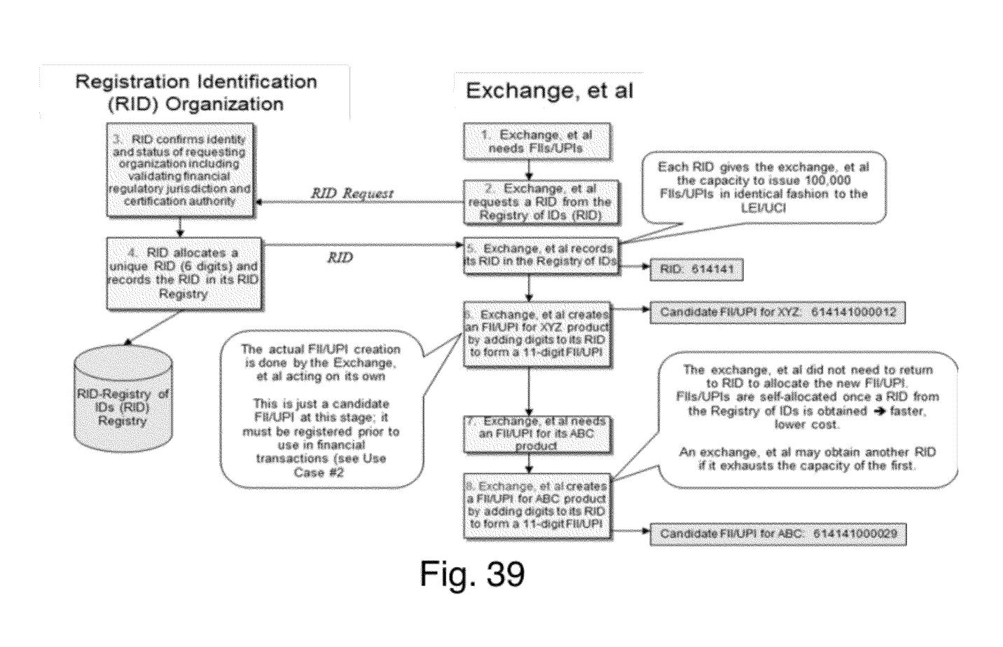

FIG. 39 is a chart for a use case in which an exchange wants to create new FIIs (Financial Instrument Identifiers)/UPIs (CFTC's Unique Product Identifier) for two new derivative products.

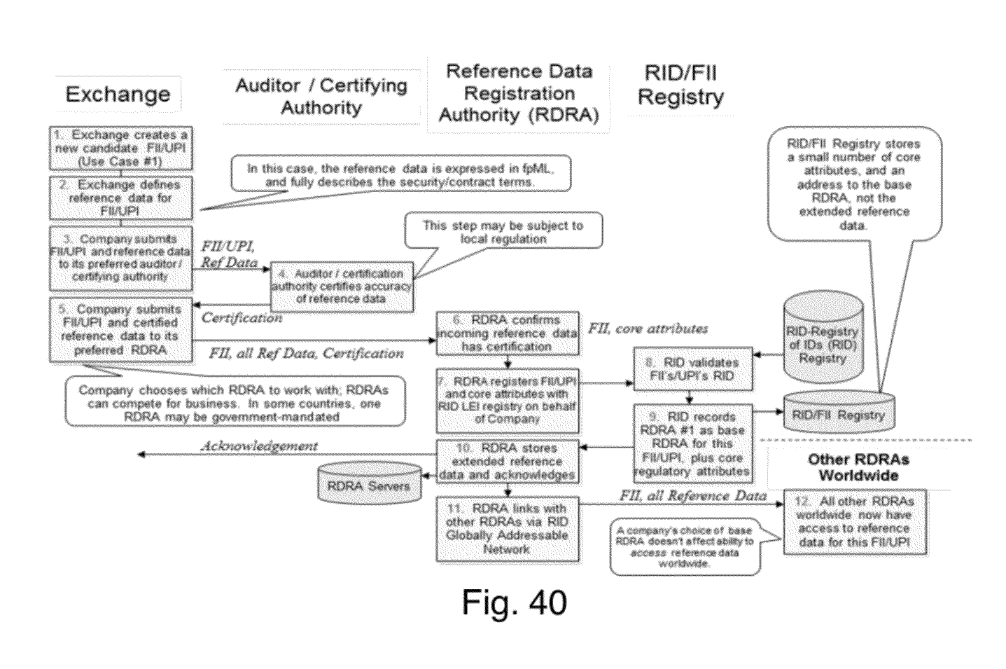

FIG. 40 is a chart for a use case in which an exchange wants to register an FII/UPI for use in financial markets.

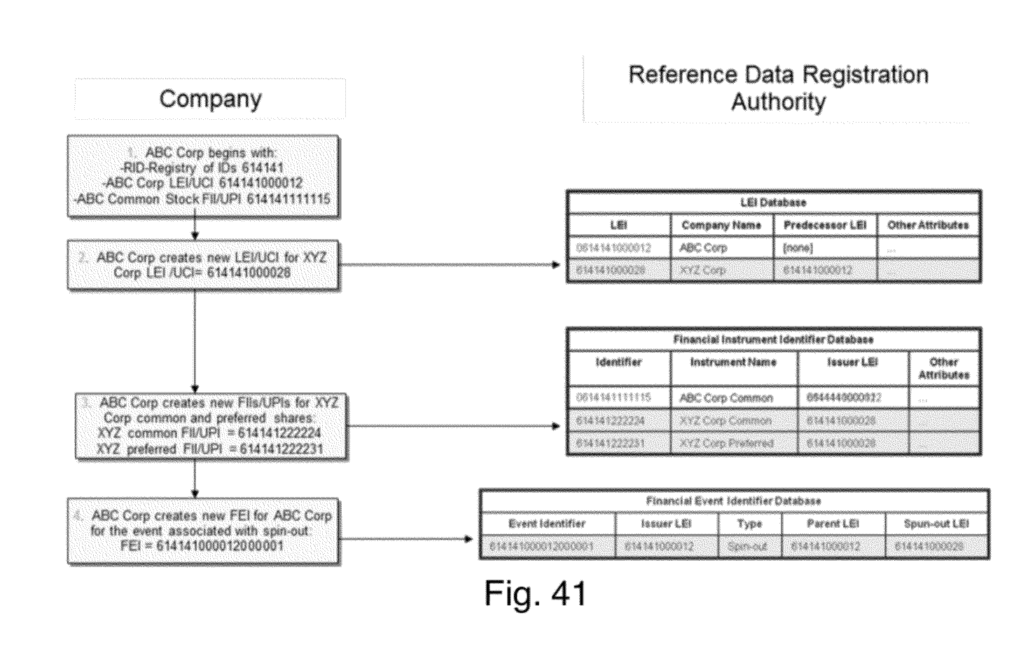

FIG. 41 is a chart for a use case in which a company announces the spinoff of new securities using the Financial Event Identifier (FEI).

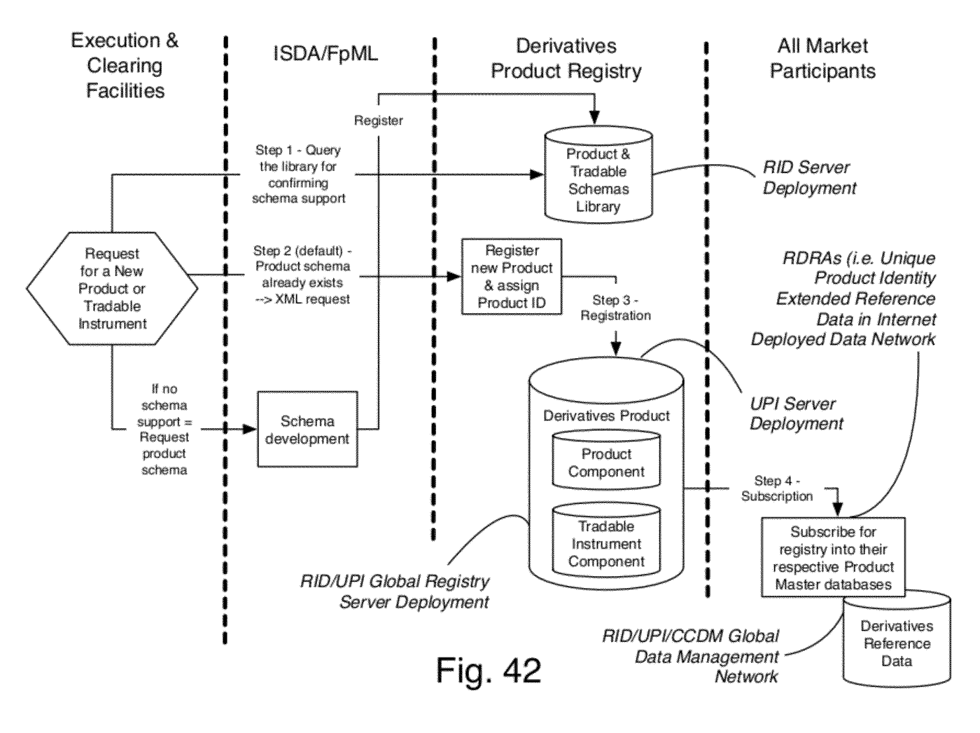

FIG. 42 is a chart for a use case in which the UPI is contained in the OTC derivatives product registry.

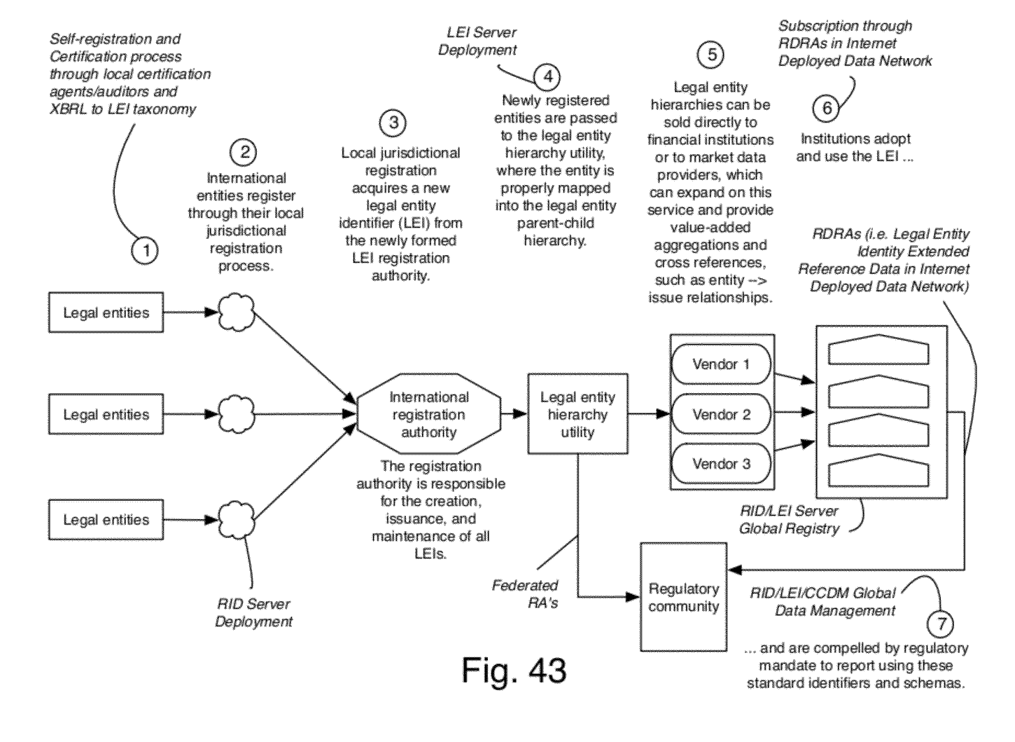

FIG. 43 is a chart for a use case in which the LEI is incorporated into the LEI utility.

Although the invention is described with regard to financial services, the invention may be used in other areas such as medical products and services, pharmaceutical products and services, and so on. For example sovereign drug and medical device regulators in their own sovereign jurisdictions can, in similar fashion as sovereign financial regulators, be allocated batches of numbers/characters. They in turn can assign these numbers to medical device manufacturers, pharmaceutical companies, hospitals, clinics, et al. These health care market participants, like financial market participants, would in turn assign their own remaining digits/characters and self register the details of their numbering convention and clarifying data attributes, i.e. name of company, product name, etc. for identifying legal entities, and health related products. Further reference data would clarify the type of organization registered, its license number, etc.; and the details of ingredients of drugs, the parts of a medical device, etc.

Although illustrative embodiments of the present invention, and various modifications thereof, have been described in detail herein with reference to the accompanying drawings, it is to be understood that the invention is not limited to this precise embodiment and the described modifications, and that various changes and further modifications may be effected therein by one skilled in the art without departing from the scope or spirit of the invention as defined in the appended claims.

1-2. (canceled)

3. A method for processing a financial transaction, comprising:
providing, by a computer at a central source operating according to a computer program, initial reference data for the financial transaction to a first party for storage in a first data repository and to a second party for storage in a second data repository, the first data repository being different from the second data repository,
receiving, by the central source computer, a first order from the first party, the first order created from the initial reference data by the first party,
generating, by the central source computer, a first unique tag based on the first order,
associating, by the central source computer, the first unique tag with the first order to create a validated first order,
storing the validated first order at the central source computer,
sending, by the central source computer, the validated first order to the first party,
receiving, by the central source computer, a second order from the second party, the second order created from the initial reference data by the second party,
generating, by the central source computer, a second unique tag based on the second order,
associating, by the central source computer, the second unique tag with the second order to create a validated second order,
storing the validated second order at the central source computer,
sending, by the central source computer, the validated second order to the second party,
receiving, by the central source computer, an execution notice from a market that created an executed trade based on the first order and the second order,
generating, by the central source computer, an execution unique tag based on the execution notice,
associating, by the central source computer, an execution unique tag with the execution notice to create a validated execution,
storing the validated execution at the central source computer,
sending, by the central source computer, the validated execution to the first party and the second party,
receiving, by the central source computer, a clearance confirmation based on the executed trade,
generating, by the central source computer, a clearance unique tag based on the clearance confirmation,
associating, by the central source computer, the clearance unique tag with the clearance confirmation to create a validated clearance confirmation,
storing the validated clearance confirmation at the central source computer, and
sending, by the central source computer, the validated clearance confirmation to the first party and the second party,
receiving, by the central source computer, additional reference data for the validated execution from one of the first party and the second party,
generating, by the central source computer, an augmented unique tag based on the validated execution and the additional reference data,
associating, by the central source computer, the augmented unique tag with the validated execution and the additional reference data to create a validated augmented execution,
storing the validated augmented execution at the central source computer,
sending, by the central source computer, the validated augmented execution to the one of the first party and the second party that sent the additional reference data to the central source computer,
wherein the central source, the market, the first party and the second party are different entities.

4. The method of claim 3, wherein the initial reference data identifies at least two of: a security, a market where the security is traded, a currency, a price, a rate, an expiry date, a maturity date, a reset date, and a financial market participant.

5. The method of claim 4, wherein the security is a contract or a product.

6. The method of claim 4, wherein the financial market participant is a counterparty.

7. The method of claim 3, wherein the additional reference data identifies at least one of: a financial market participant, an account traded for, regulatory fees, taxes, a trade date, a settlement date, a settlement account, a collateral account, a settlement location, a depository and a delivery location.

8. The method of claim 7, wherein the financial market participant is one of: a counterparty, a broker, a dealer, an inter-dealer, an agent, a trading desk, an investment manager, a trading advisor, a pool, a fund, a custody agent, a clearing agent, a settling agent, and a prime broker.

9. The method of claim 3, further comprising indemnifying, by the central source computer, the first party from a loss due to faulty reference data.

10. A method for processing a financial transaction, comprising:
providing, by a computer at a central source operating according to a computer program, initial reference data for the financial transaction to a first party for storage in a first data repository and to a second party for storage in a second data repository, the first data repository being different from the second data repository,
receiving, by the central source computer, a first order from the first party, the first order created from the initial reference data by the first party,
generating, by the central source computer, a first unique tag based on the first order,
associating, by the central source computer, the first unique tag with the first order to create a validated first order,
storing the validated first order at the central source computer,
sending, by the central source computer, the validated first order to the first party,
receiving, by the central source computer, a second order from the second party, the second order created from the initial reference data by the second party,
generating, by the central source computer, a second unique tag based on the second order,
associating, by the central source computer, the second unique tag with the second order to create a validated second order,
storing the validated second order at the central source computer,
sending, by the central source computer, the validated second order to the second party,
receiving, by the central source computer, an execution notice from a market that created an executed trade based on the first order and the second order,
generating, by the central source computer, an execution unique tag based on the execution notice,
associating, by the central source computer, the execution unique tag with the execution notice to create a validated execution,
storing the validated execution at the central source computer,
sending, by the central source computer, the validated execution to the first party and the second party,
wherein the central source, the market, the first party and the second party are different entities.

11. The method of claim 10, wherein the initial reference data identifies at least two of: a security, a market where the security is traded, a currency, a price, a rate, an expiry date, a maturity date, a reset date, and a financial market participant.

12. The method of claim 11, wherein the security is a contract or a product.

13. The method of claim 11, wherein the financial market participant is a counterparty.

14. The method of claim 10, further comprising
receiving, by the central source computer, new reference data from a data-providing entity,
determining, by the central source computer, that the new reference data is acceptable when the new reference data meets an acceptance threshold, to generate accepted reference data, and
storing the accepted reference data at the central source.

15. The method of claim 14, further comprising
associating, by the central source computer, syntax data with the accepted reference data, to generate structured reference data, and
storing the structured reference data at the central source computer.

16. The method of claim 14, further comprising sending, by the central source computer, the accepted reference data to the first party for storage in the first data repository.

17. The method of claim 14, further comprising
receiving, by the central source computer, a profile from the first party,
storing, by the central source computer, the profile in a router that is part of the central source computer,
providing, by the central source computer, the accepted reference data to the router,
comparing, by the router, the stored profile to the accepted reference data to determine whether the accepted reference data should be sent to the first party, and
sending, by the router, the accepted reference data to the first party when the router determines that the accepted reference data should be sent to the first party.

18. The method of claim 10, further comprising
determining, by the central source computer, that a trigger event has occurred,
generating, by the central source computer, triggered reference data, and
storing the triggered reference data at the central source computer.

19. The method of claim 18, further comprising sending, by the central source computer, the triggered reference data to the first party for storage in the first data repository.

20. The method of claim 19, further comprising
receiving, by the central source computer, a profile from the first party,
storing, by the central source computer, the profile in a router that is part of the central source computer,
providing, by the central source computer, the triggered reference data to the router,
comparing, by the router, the stored profile to the accepted reference data to determine whether the triggered reference data should be sent to the first firm, and
sending, by the router, the triggered reference data to the first party when the router determines that the triggered reference data should be sent to the first firm.

21. The method of claim 10, further comprising indemnifying, by the central source computer, the first party from a loss due to faulty reference data.

22. A method for processing a financial transaction, comprising:
providing, by a computer at a central source operating according to a computer program, initial reference data for the financial transaction to a first party for storage in a first data repository and to a second party for storage in a second data repository, the first data repository being different from the second data repository,
receiving, by the central source computer, an execution notice from a market that created an executed trade based on the first order and the second order, the first order created from the initial reference data by the first party, the second order created from the initial reference data by the second party,
generating, by the central source computer, a first unique tag based on the execution notice,
associating, by the central source computer, the first unique tag with the execution notice to create a validated execution,
storing the validated execution at the central source computer,
sending, by the central source computer, the validated execution to the first party and the second party,
receiving, by the central source computer, a clearance confirmation based on the executed trade,
generating, by the central source computer, a second unique tag based on the clearance confirmation,
associating, by the central source computer, the second unique tag with the clearance confirmation to create a validated clearance confirmation,
storing the validated clearance confirmation at the central source computer, and
sending, by the central source computer, the validated clearance confirmation to the first party and the second party,
wherein the central source, the market, the first party and the second party are different entities.

23. The method of claim 22, wherein the initial reference data identifies at least two of: a security, a market where the security is traded, a currency, a price, a rate, an expiry date, a maturity date, a reset date, and a financial market participant.

24. The method of claim 23, wherein the security is a contract or a product.

25. The method of claim 23, wherein the financial market participant is a counterparty.

26. The method of claim 22, further comprising
receiving, by the central source computer, new reference data from a data-providing entity,
determining, by the central source computer, that the new reference data is acceptable when the new reference data meets an acceptance threshold, to generate accepted reference data, and
storing the accepted reference data at the central source.

27. The method of claim 26, further comprising
associating, by the central source computer, syntax data with the accepted reference data, to generate structured reference data, and
storing the structured reference data at the central source computer.

28. The method of claim 26, further comprising sending, by the central source computer, the accepted reference data to the first party for storage in the first data repository.

29. The method of claim 26, further comprising
receiving, by the central source computer, a profile from the first party,
storing, by the central source computer, the profile in a router that is part of the central source computer,
providing, by the central source computer, the accepted reference data to the router,
comparing, by the router, the stored profile to the accepted reference data to determine whether the accepted reference data should be sent to the first party, and
sending, by the router, the accepted reference data to the first party when the router determines that the accepted reference data should be sent to the first party.

30. The method of claim 22, further comprising
determining, by the central source computer, that a trigger event has occurred,
generating, by the central source computer, triggered reference data, and
storing the triggered reference data at the central source computer.

31. The method of claim 30, further comprising sending, by the central source computer, the triggered reference data to the first party for storage in the first data repository.

32. The method of claim 31, further comprising
receiving, by the central source computer, a profile from the first party,
storing, by the central source computer, the profile in a router that is part of the central source computer,
providing, by the central source computer, the triggered reference data to the router,
comparing, by the router, the stored profile to the accepted reference data to determine whether the triggered reference data should be sent to the first firm, and
sending, by the router, the triggered reference data to the first party when the router determines that the triggered reference data should be sent to the first firm.

33. The method of claim 22, further comprising indemnifying, by the central source computer, the first party from a loss due to faulty reference data.

34. A method for processing a financial transaction, comprising:
providing, by a computer at a central source operating according to a computer program, initial reference data for the financial transaction to a first party for storage in a first data repository and to a second party for storage in a second data repository, the first data repository being different from the second data repository,
receiving, by the central source computer, an execution notice from a market that created an executed trade based on the first order and the second order, the first order created from the initial reference data by the first party, the second order created from the initial reference data by the second party,
generating, by the central source computer, an execution unique tag based on the execution notice,
associating, by the central source computer, the execution unique tag with the execution notice to create a validated execution,
storing the validated execution at the central source computer,
sending, by the central source computer, the validated execution to the first party and the second party,
receiving, by the central source computer, additional reference data for the validated execution from one of the first party and the second party,
generating, by the central source computer, an addition unique tag based on the validated execution and the additional reference data,
associating, by the central source computer, the additional unique tag with the validated execution and the additional reference data to create a validated augmented execution,
storing the validated augmented execution at the central source computer,
sending, by the central source computer, the validated augmented execution to the one of the first party and the second party that sent the additional reference data to the central source computer,
wherein the central source, the market, the first party and the second party are different entities.

35. The method of claim 34, wherein the initial reference data identifies at least two of: a security, a market where the security is traded, a currency, a price, a rate, an expiry date, a maturity date, a reset date, and a financial market participant.

36. The method of claim 35, wherein the security is a contract or a product.

37. The method of claim 35, wherein the financial market participant is a counterparty.

38. The method of claim 34, wherein the additional reference data identifies at least one of: a financial market participant, an account traded for, regulatory fees, taxes, a trade date, a settlement date, a settlement account, a collateral account, a settlement location, a depository and a delivery location.

39. The method of claim 38, wherein the financial market participant is one of: a counterparty, a broker, a dealer, an inter-dealer, an agent, a trading desk, an investment manager, a trading advisor, a pool, a fund, a custody agent, a clearing agent, a settling agent, and a prime broker.

40. The method of claim 34, further comprising
receiving, by the central source computer, new reference data from a data-providing entity,
determining, by the central source computer, that the new reference data is acceptable when the new reference data meets an acceptance threshold, to generate accepted reference data, and
storing the accepted reference data at the central source.

41. The method of claim 40, further comprising
associating, by the central source computer, syntax data with the accepted reference data, to generate structured reference data, and
storing the structured reference data at the central source computer.

42. The method of claim 40, further comprising sending, by the central source computer, the accepted reference data to the first party for storage in the first data repository.

43. The method of claim 40, further comprising
receiving, by the central source computer, a profile from the first party,
storing, by the central source computer, the profile in a router that is part of the central source computer,
providing, by the central source computer, the accepted reference data to the router,
comparing, by the router, the stored profile to the accepted reference data to determine whether the accepted reference data should be sent to the first party, and
sending, by the router, the accepted reference data to the first party when the router determines that the accepted reference data should be sent to the first party.

44. The method of claim 34, further comprising
determining, by the central source computer, that a trigger event has occurred,
generating, by the central source computer, triggered reference data, and
storing the triggered reference data at the central source computer.

45. The method of claim 44, further comprising sending, by the central source computer, the triggered reference data to the first party for storage in the first data repository.

46. The method of claim 45, further comprising
receiving, by the central source computer, a profile from the first party,
storing, by the central source computer, the profile in a router that is part of the central source computer,
providing, by the central source computer, the triggered reference data to the router,
comparing, by the router, the stored profile to the accepted reference data to determine whether the triggered reference data should be sent to the first firm, and
sending, by the router, the triggered reference data to the first party when the router determines that the triggered reference data should be sent to the first firm.

47. The method of claim 34, further comprising indemnifying, by the central source computer, the first party from a loss due to faulty reference data.
